(19) United States
(12) Patent Application Publication
(10) Pub. No.: US 2004/0024483 A1
(43) Pub. Date: Feb. 5, 2004

(54) Controlling utility consumption

(76) Inventor: Bradford L. Holcombe, Odessa, FL (US)

Correspondence Address: OPPENHEIMER WOLFF & DONNELLY, P. O. BOX 10356, PALO ALTO, CA, 94303, US

(21) Appl. No.: 10/423,252

(22) Filed: Apr. 24, 2003

Related U.S. Application Data
(63) Continuation of application No. 09/472,717, filed on Dec. 23, 1999, now abandoned.

(51) Int. Cl. G06F 19/00

(52) U.S. Cl. 700/122

(57) ABSTRACT

A system, method and article of manufacture are provided for monitoring and optimizing utility usage in an entity. Utility usage is collected for one or more utility resources in an entity. The utility usage for the entity is then aggregated. Utility utilization in the entity is monitored and utility usage of the one or more devices is selectively limited to optimize utility usage.

The present application is a continuation of, claims the benefit of, and incorporates by reference U.S. patent application Ser. No. 09/472,717 entitled “UTILITY CONSUMPTION CONTROL MECHANISM” filed Dec. 23, 1999.

### FIELD OF THE INVENTION

The present invention relates to utilities and energy supplies and more particularly to controlling use of both a primary and an alternative energy source in a structure.

### BACKGROUND OF THE INVENTION

A resource can be considered as a good, service, and/or commodity which is purchased by a customer and sold by a resource provider. Oftentimes a customer will purchase many different types of resources from numerous providers under differing pricing structures, and desire to account for, or otherwise track its resource consumption. This can be for various reasons which include a desire to budget for resource purchasing, track current and past usage and expenditures, and to predict future usage and expenditures.

One type of resource is a utility resource. Utility resources typically include electricity, gas (natural or petroleum-based), water, and sewer service, to name just a few. Electricity is an essential part of our lives. If we took a moment to think of the services that would not exist if electricity were not available, we would be amazed. Almost every aspect of our modern lives involves electric power, from light bulbs and television sets to hospitals and automobile industries. Although we are used to having power whenever we need it, the processes and systems involved in delivering electricity require careful planning and sophisticated mathematical and forecasting models.

Lately, due to rising costs of energy and discrepancies in its price among different regions of the country, the legal framework surrounding the electric-power industry has changed. This change has opened the door for utilities to compete with each other and against independent suppliers regardless of their geographic location. Although this change will benefit the consumer, utilities are going to face a highly unpredictable market and will need to make tough decisions regarding power generation and delivery.

The power industry is going through deregulation. The current picture of a single utility controlling the market in a specific region will soon disappear. Instead, there will be power producers who sell their product to a power pool; and power suppliers who will buy power from this pool and in turn sell it to their customers. Although the full picture of the power industry after deregulation is not yet known, it is clear that utilities need to prepare themselves for an open market in which buying and selling power are to be considered when scheduling their generating units.

The main reason behind deregulation is to reduce the high price of electric energy. Initial steps towards deregulation were taken in 1978 with the passage of the Public Utilities Regulatory Policy Act (PURPA). This act encouraged nonutility generation and required utilities to buy power from independent generators. The Energy Policy Act of 1992 took deregulation a step further by mandating open access to the transmission system for wholesalers. Currently, electricity is sold as a service that is delivered to specified points. For example, each one of us expects to receive electric power via a meter outside the house. We pay for this service regardless of its producer or which power lines it followed. That is, an electricity bill indicates the total usage of electricity in kilowatt hours (KWH) and the service price per KWH without incorporating any other details into the pricing scheme. Deregulation is changing this picture by unbundling the electric power into generation and transmission. In the future, one will pay a production cost and a transmission fee. There will be several power suppliers from whom electric power may be purchased. Suppliers may have different pricing mechanisms. For instance, there might be a discount for using power off-peak periods or for signing a long-term contract with the supplier. Power producers will compete with each other to minimize their costs so that they can sell their product to more customers and maximize their profit.

The hope is that deregulation will result in cheaper prices and play a part in improving the economy by encouraging investments in electric utilities. The size of the electric industry is expected to grow after deregulation as was the case with the telecommunications industry. The telecommunications industry's revenue shot up from $81 billion to $170 billion within ten years of deregulation.

A pitfall of deregulation is that the load on a utility system is becoming increasingly unpredictable. The reason is that trading transactions can change the load pattern significantly. For example, some utilities may sell more than 30% of their power generation to other utilities on certain days. Demand and supply in the market are functions of volatile electricity prices which in turn depend on highly unpredictable elements such as regional weather conditions and fuel prices.

On top of deregulation, domestic residential demand for electric power is growing at approximately 2% annually. Although utility companies can maintain pace with this growth by constructing more peaking and power plants, this is not necessarily in the best interest of the utility companies and society at large. The factors of cost, fuel availability, and environmental concerns of both the utility company and the public in general have prompted a shift of emphasis from building additional generation capacity for satisfying the increasing demand to developing and employing a method and means of efficiency improvements, production facility optimization, and electrical conservation through demand side management.

### SUMMARY OF THE INVENTION

A system, method and article of manufacture are provided for monitoring and optimizing utility usage in an entity. Utility usage is collected for one or more utility resources in an entity. The utility usage for the entity is then aggregated. Utility utilization in the entity is monitored and utility usage of the one or more devices is selectively limited to optimize utility usage. In an embodiment of the present invention, an internet protocol network may be queried to select an optimal utility provider for the entity. In such an embodiment, information from the entity may also be provided to a utility service provider. Optionally, control of devices may be provided from the internet protocol network.

In a further embodiment of the present invention, devices may be prioritized. In yet another embodiment of the present invention, interfacing to an entity security system may also be performed.

In another embodiment of the present invention, a system, method, and article of manufacture are provided for monitoring use of utility resources to optimize utility resource distribution, including communicating with a utility device to automatically read actual utility usage data from a remote location by specifying a network address for the utility device and issuing continual requests for actual utility usage data from the utility device, wherein the actual utility usage data represents a time period of utility use and an amount of utility use for a customer. The optimal utility usage data representing utility pricing to be offered to the customer is determined, wherein a customer's actual utility usage data is analyzed to determine a price for a unit of utility resources, and wherein the price for a unit of utility resources depends on a customer's time period of utility use and the amount of utility use for a particular time period. The customer is assisted in dynamically selecting an optimal utility resource provider, wherein the optimal utility resource provider may change depending on the customer's actual utility usage data. The utility resources are distributed to the customer based upon the optimal utility usage data, wherein utility resources provided to the customer may be selectively limited based upon the optimal utility usage data. Additional customer services are provided based upon the actual utility usage data and the optimal utility usage data, wherein the additional customer services include automatic initiation and termination of utility resources, quality assurance of utility resources provided to the customer, and security assessment and monitoring for utility resources provided.

### BRIEF DESCRIPTION OF THE DRAWINGS

The invention will be better understood when consideration is given to the following detailed description thereof. Such description makes reference to the annexed drawings wherein:

FIG. 1 is a schematic diagram of a hardware implementation of one embodiment of the present invention;

FIG. 2 is a flowchart that depicts a process for monitoring customer usage of a utility over an internet protocol network;

FIG. 3 is a block diagram overview of an Automatic Meter Reader and Central Station system;

FIG. 4 is a block diagram of the preferred embodiment of an Automatic Meter Reader (AMR) system constructed in accordance with the principles of this invention;

FIG. 5 is a block diagram of an alternate embodiment of an Automatic Meter Reader (AMR) system constructed in accordance with the principles of this invention;

FIG. 6 is a data flow chart for the actions and processing performed by the Data Acquisition and Reporting (DAR) computer in relation to the preferred embodiment;

FIG. 7 is a data flow chart for the actions and processing performed by the Data Acquisition and Reporting (DAR) computer in relation to an alternate embodiment;

FIG. 8 is a flow chart which illustrates the sequential processing of software in the AMR;

FIG. 9 is a flowchart illustrating a process for operating a utility service over an internet protocol network in accordance with one embodiment of the present invention;

FIG. 10 is a schematic illustration of an electric power demand monitoring and control system in accordance with one embodiment of the present invention;

FIG. 11 is a schematic illustration of the home monitoring and control network in the system of FIG. 10;

FIG. 12 functionally illustrates the intelligent utility unit (IUU) in the home network of FIG. 11;

FIG. 13 functionally illustrates bandwidth allocations for the home network in the distribution system;

FIG. 14 illustrates the bi-directional distribution network;

FIG. 15 is a functional block diagram of the digital backbone network which interconnects the utility company host computer and the distribution networks;

FIG. 16 is a flowchart of a process for facilitating a first and a second utility provider for a utility customer according to one embodiment of the present invention;

FIG. 17 is a flowchart depicting a process for allowing time-dependent pricing of a utility from one of a plurality of utility providers;

FIG. 18 is a flowchart of a process for minimizing a cost of the utility utilizing an internet protocol network according to one embodiment of the present invention;

FIG. 19 is a flowchart depicting a process or managing utility use utilizing an internet protocol network in accordance with one embodiment of the present invention;

FIG. 20 is a flowchart illustrating a process for monitoring and optimizing utility usage in an entity in accordance with an embodiment of the present invention;

FIG. 21 illustrates an exemplary computer system which can be used to implement the present invention;

FIG. 22 is a high level organizational diagram illustrating one aspect of the present invention;

FIG. 23 is a high level organizational diagram illustrating one aspect of the present invention;

FIG. 24 is a high level organizational diagram illustrating one aspect of the present invention;

FIG. 25 is a flow diagram illustrating certain methodical aspects of the present invention;

FIG. 26 is a high level organizational diagram illustrating a preferred embodiment of the present invention;

FIG. 27 is a high level organizational diagram illustrating another preferred embodiment of the present invention;

FIG. 28 is a flowchart depicting a process for managing utility use utilizing an internet protocol network;

FIG. 29 is a block diagram illustrating the basic structure of an illustrative embodiment of the invention for analyzing energy supply and providing for the timely movement of energy;

FIG. 30 is a block diagram illustrating the basic structure of the embodiment of FIG. 29 with a temporary memory and a real time data link connected to the processor;

FIG. 31 is a more detailed block diagram illustrating the structure of the embodiment of FIG. 30 with an Administrator function which further increases the efficiency of the system;

FIG. 32 is a flowchart illustrating the transmission of electrical power from an energy provider to an energy buyer;

FIG. 33 is a flowchart illustrating the operations carried out by the invention as it applies to a single energy system user;

FIG. 34 illustrates a process for providing a utility auctioning system utilizing an internet protocol network;

FIG. 35 is a flowchart that illustrates a process for the dynamic flexible computer-implemented auction process according to one embodiment of the present invention; and

FIG. 36 is a flowchart depicting a process for monitoring and optimizing utility usage in an entity.

### DETAILED DESCRIPTION OF THE PREFERRED EMBODIMENTS

While only becoming available to most people today, high-speed communications to the home can be seen in action in many market areas. The chip revolution is happening—everything is becoming “smart”. Further, promising alternative energy sources can be seen.

In the United States it is estimated that 30% of the homes are connected to the Internet. And of course the larger industrial and commercial customers are connected. Growing acceptance of eCommerce as a way of doing business is assumed in this discussion.

Communications—The preferred enabler is a persistent high-speed connection of the home to the Internet resulting in a ubiquitous network. This is being accomplished through Cable Modems and DSL at an increasing rate. Admittedly, this capability is only available in limited areas today, but the Communications companies' competitive battle will force widespread adoption in the next few years as video, voice and data converge. This constant communications link will create vast opportunities for some energy providers and be the killer of others.

Smart Objects—Smart chips are showing up everywhere. Every appliance will be smart. Control of every appliance will be easy. It will be a market of specialized chips complete with embedded operating software-and it will be an open market. Open communications standards will ensure a competitive marketplace. This will change the landscape for energy services.

Alternative Energy Sources—Promising residential solutions can be seen in the final stages of testing today. One can also imagine additional technology breakthroughs. As with most innovation, an evolution/maturity of existing technology can be seen, but it is often a breakthrough technology that wins. In this case either scenario will work. Commercialization of this trend is the furthest away of the three, yet it is the trend that will result in the ultimate reshaping of the industry.

One embodiment of the present invention includes an energy management system in the consumer's structure which aggregates consumption expectations in advance of use by communicating with the smart appliances mentioned above and/or receiving user input. The consumption expectations may then be used to submit a bid for the amount of energy needed, and may even determine at what time it is needed. The energy management system communicates via Internet with a real-time bid/supply/settlement network in place for energy services and submits the bid for the amount of energy needed. The persistent high-speed connection to the Internet mentioned above may be used. The energy management system should also be able to verify receipt of the energy, determine the amount of the energy used via measurement devices, and pay the provider from which the energy was received. Ideally, the measurement devices will be able to be read manually as well as electronically to allow verification of consumption and the billing amount. Alternatively, the measurement devices may be used in addition to more traditional meters/devices which must be read by a human.

More specifically, it is an object of the present invention for providing a home (or business) with intelligent energy consumption devices. These devices communicate power consumption and preferably are able to estimate future demand. This may be accomplished by various means such as allowing a user to input usage data. In the alternative, the forecasted demand may be derived from known operating procedures of the appliance.

Further, the appliance itself may be able to provide an estimate of energy consumption. For example, a dryer may be capable of providing information indicating that it is consuming 1 KW and that it will continue to consume 1 KW for 20 more minutes because that is how long it has left in the drying cycle. If the dryer has been programmed for a later start, it would communicate that at 10:00 it will be consuming 1 KW for 1 hour.

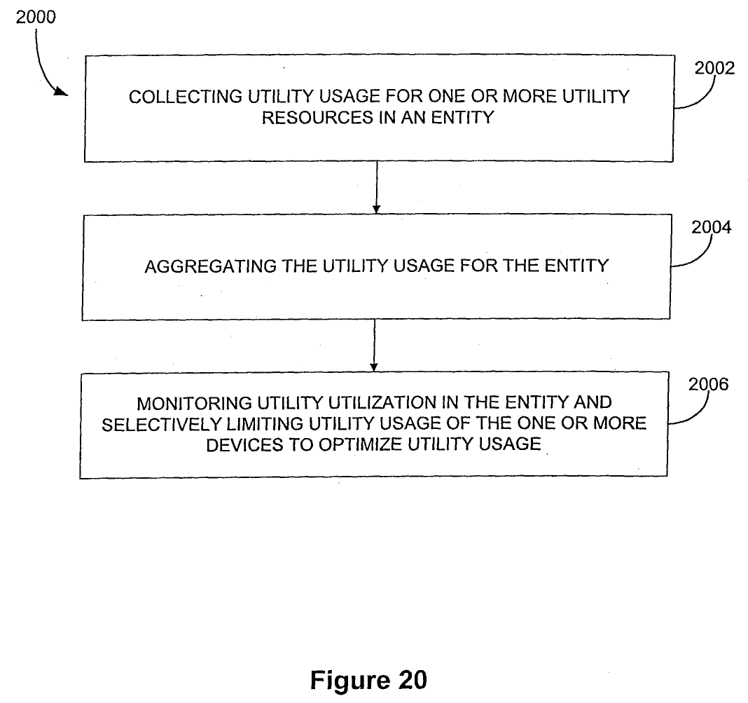

The more devices that have this capability, the more accurate the results will be and the less user intervention will be required to use it. If any of the appliances are not equipped with this ability, interface modules may be coupled between that the appliance and the associated outlet. Such modules are capable of tracking time usage. Based on this information and inputted or estimated rate information, power consumption may be calculated. See the discussion below with respect to FIG. 20 for a discussion of devices for tracking time usage.

The meters of the present invention are devices for continuously monitoring and reporting the usage rate, inter alia, number of hours per week of an electrically operated appliance, for purposes of enabling regulation of the amount of usage of the appliance.

Such devices further comprise a substantial improvement over the prior art in that it is capable of continuously monitoring and reporting the usage rate and thereby obviates the necessity of setting or resetting the timer controls to effect operation. The simplicity of these devices render a cost-effective item of manufacture and improved reliability.

An example of an interface module will now be set forth. According to the invention, there is provided an electric power meter, comprising a body member; prongs on the body member for insertion into an electric wall socket; a socket on the body member for receiving the plug of an electric appliance, said socket being in electrical communication with the prongs for transferring electric power from the prongs to said socket; current measuring means in the body member for measuring electric current flow between said prongs and said socket on the body member; and timing means for measuring the duration of said electric current flow.

Also according to the invention, there is provided an electric wall switch assembly, comprising a wall plate for mounting on a wall; an electric switch on the plate; means for connecting the switch in series with an electric conductor for controlling the flow of electric current through the conductor; current measuring means for measuring electric current flowing across the switch; and timing means for measuring the duration of said electric current flow.

Further according to the invention, there is provided an electric wall plug assembly, comprising a wall plate for mounting on a wall; a socket on the plate for connection to an electric power supply, said socket being adapted to receive the plug of an electric appliance; current measuring means for measuring electric current flow through the socket; and timing means for measuring the duration of electric current flow through the socket.

Also according to the invention, there is provided in an electrical appliance having a body member and an electric power line for connection to an electric power source for supplying an electric current to the appliance, an electric power meter connected in series with the electric power line for the flow of said electric current therethrough, comprising current measuring means for measuring said electric current; and timing means for measuring the duration of said electric current flow.

Further according to the invention, there is provided an electric power meter, comprising current measuring means for measuring electric current flow to an electrical appliance; timing means for measuring the duration of said electric current flow; processing means for receiving data from said current measuring means to calculate electric power consumed by said appliance; and display means for displaying the electric power consumed and the time period over which said electric power has been consumed.

Control Unit

The foregoing metering devices may be, in turn, coupled to a central control unit. Instead of having merely time control capabilities which are mainly employed for convenience, the central control unit of the present invention is adapted to monitor all appliances coupled thereto and their projected usage using the techniques set forth hereinabove.

The instant central control unit is thus capable of monitoring consumption patterns of all the appliances in the house by accumulating data on a daily, weekly or other interval basis. Various averaging techniques may be employed to accomplish this. As an option, the central control unit may interact with the appliances or the interface modules for altering their cycle if needed or turn them on and off at different times.

In one embodiment, a user may alter the consumption patterns manually. For example, a user may indicate whether a current data is a normal workday, or an extraordinary day, such as a weekend. There could also be consumption patterns for certain events, i.e. party for 20, Thanksgiving dinner, etc. Each would have certain appliance configurations. Based on the user input and actual demand, the unit may determine projected energy consumption. Information on actual measurement will be discussed hereinafter in greater detail.

The central control unit may include a standalone unit or a unit attached to a PC for providing a user interface. In addition to learning the consumption patterns by interfacing with the measurement devices, a user may configure typical consumption days and patterns using the PC. Such user interaction may be involved, or simply for verification purposes or configuring only high-level consumption patterns.

If there is a distributed generation device present, then it's generation would be controlled/monitored in the same fashion. This generation capacity could be matched against the consumption patterns.

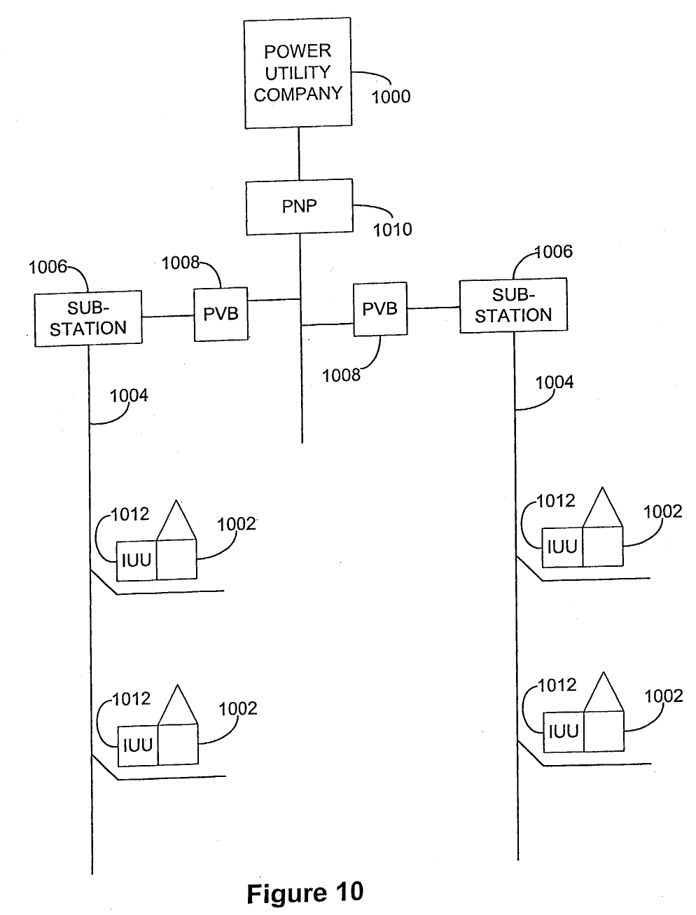

Reference may be made to the discussion of FIGS. 10-15 below which includes a discussion of an electric power demand monitoring and control system.

Measurement

A measurement device is needed to monitor the actual “inflow” of energy (consumption from the Utility). Such measurement devices would be connected to the network (network defined later) so that it can communicate with the control unit discussed above and the outside world. Actual consumption is feed to the control unit for verification and measurement in the aggregate, and for creating control programs in the aggregate (i.e. this is what happens as a result of all activity on Football Sunday). This feedback loop provides intelligence.

There are also some units which monitor energy consumption on the market. But these units merely shut off appliances when overall peak usage is hit.

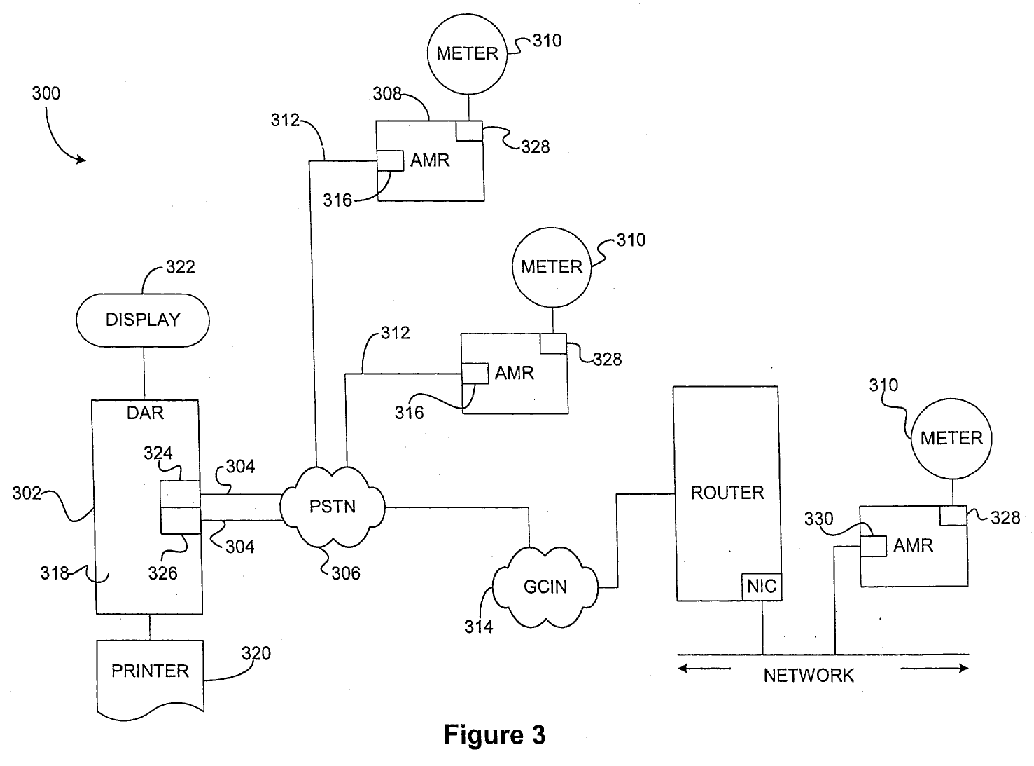

The measurement device should also be connected to the outside world through the Internet. This could be done either by directly connecting the measurement device to the Internet and making it directly addressable or connecting through the control unit. In either event this measurement device must be accessed through a static IP address (or through one) so it can be monitored from outside. See the discussion of the embodiments shown in FIGS. 3-8 for a more detailed description of a measurement devices which may be monitored utilizing the Internet.

To make this work, a persistent Internet connection or other frequent interval connection based on information requirements is required. This is where the communications infrastructure comes in.

Inside the home all of these devices need to communicate. While there may be a variety of network topologies used, one known standard for enabling the intercommunication of appliances and systems within a residence or other occupied space is the Consumer Electronics Bus (CEBus)(registered trademark), which is the home automation standard which has been developed by the Electronics Industries Association. The CEBus system is configured to make use of existing wiring in a residence, that is power line carrier communications (PL). CEBus has since been expanded to include twisted pair (TP) wire, coaxial cable (CX), infrared (IR), and radio frequency (RF). Other automation interappliance communication standards are also known. The interconnection between appliances, using standards such as CEBus, can be accomplished without the use of any controller devices external to the appliances being connected, if so desired.

Whatever automation communication standard is employed, in order to enable a given appliance or home mechanical system to communicate to other components in the automation system, each such appliance or mechanical system must be brought into communication with one another or with an overall system controller (if any), to enable instructions or information to be delivered between the connected appliances or mechanical systems.

Such instructions or information would replace those which the user or operator would have performed directly to the given appliance or apparatus. Most existing appliances and mechanical systems which are electronically controlled are not configured to “talk” to each other, and/or are not configured to the CEBus standard (or other automation standard).

It would be desirable to provide for the connection between various appliances in a home, which would also permit various diagnostic and analysis functions to be conducted, and communicated to a user/operator, so as to be able, for example, to inform the user/operator of an actual or anticipated failure in a component, or to inform the user of past performance or power consumption, and even possibly make projections of expected performance.

The present invention further affords a method and apparatus, for use in connection with home automation systems, which will enable any electronically controlled device in a home, to be brought into communication with the central control unit, with such electronically control devices including but not limited to, home automation systems which rely upon existing home wiring.

Market

Once projected consumption is ascertained via the above technology, energy may be received from the default supplier. For higher consumption, the system may seek bids. As an option, bids may be sought everyday based on daily projections, or any pattern desired by the user.

As mentioned before, there may be a default energy provider that the user would select. They would be committed to provide some level of power. Further, there would be a provider (likely controlled by a distribution company) who would determine or supply power if consumption goes over what one has bid to suppliers.

A comparison to telephone companies may be drawn at this point. Each phone call can be “turned on or off”. Energy consumption, on the other hand, continues whether there was a designated supplier or not. The present invention thus requires a default supplier and the ability to select on a transaction basis.

One or more central Internet based market(s) may be connected to the central control units a plurality of users so that they can submit bids. The bids can be targeted toward a specific market and can include or exclude certain suppliers or supplier classes. For example, a user may exclude company X, prefer company Y to some premium (or class of companies) using the interface of the central control unit.

The marketplace will add value by matching buyers and sellers, but the real value may come from the ability of the marketplace to aggregate and negotiate a better deal than the one person would get, i.e. a real-time buyer's clubs. The users may go to several marketplaces to negotiate the best deal.

At the aggregate level, the user may generate a rule such as indicate that all consumption for a day must be received from company X. The bid may be placed based on projected demand. During operation, consumption is measured by the marketplace through the Internet connection. In one embodiment, consumption could have a periodic basis, i.e. hourly, or could be for specific levels of consumption, i.e. 2 KW from one, 3 KW from another.

As an option, the Internet based market(s) may offer service in “trust”. This measurement could be done by the marketplace (as a value added service) or directly by the supplier. Billing could be done by the marketplace (as a value added service) or bills could be provided by the supplier.

The successful marketplace will provide all these services. The seller gets orders and money from the marketplace. Not risk. The seller only has to deal with one marketplace regardless of consumption patterns—trust.

Advertising is done through the marketplace by how you position the company in hopes that the consumer will select you by company or profile, as well as directly.

As an aside, based on the alternative energy technology that is present today, gas will likely be a preferred source of fuel for distributed generation for at least the next decade. Gas will probably fuel the first commercially available home fuel cells, for example. Gas pipelines will probably be more valuable than electric transmission and distribution lines in the future.

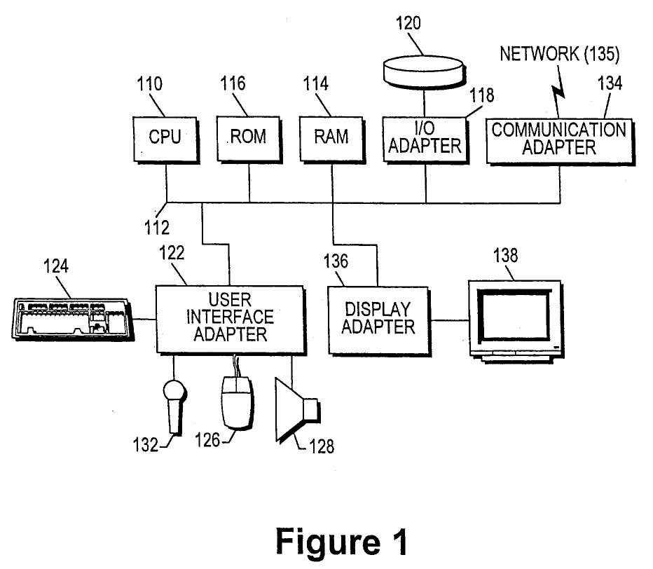

A preferred embodiment of a system in accordance with the present invention is preferably practiced in the context of a personal computer such as an IBM compatible personal computer, Apple Macintosh computer or UNIX based workstation. A representative hardware environment is depicted in FIG. 1, which illustrates a typical hardware configuration of a workstation in accordance with a preferred embodiment having a central processing unit 110, such as a microprocessor, and a number of other units interconnected via a system bus 112. The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network (e.g., a data processing network) and a display adapter 136 for connecting the bus 112 to a display device 138. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

A preferred embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Berners-Lee, D. Connoly, “RFC 1866: Hypertext Markup Language-2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UT) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers.

ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

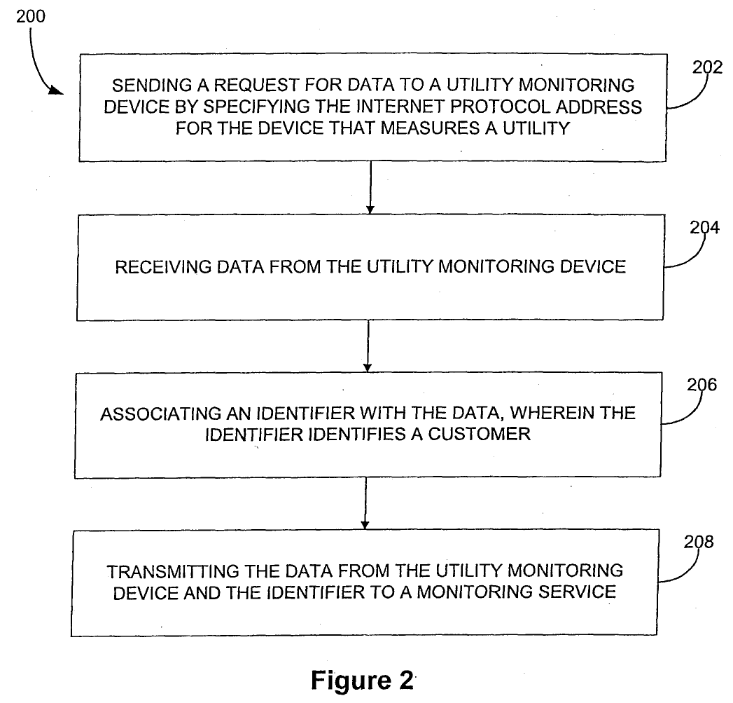

FIG. 2 depicts a process 200 for monitoring of a customer receiving utility services utilizing an internet protocol network. In operation 202, a request for data is sent to a utility monitoring device, such as a meter or a measuring device discussed above, by specifying the internet protocol address for the device that measures a utility. It should be kept in mind, however, that a utility monitoring device may be in addition to an existing meter in case an incumbent utility does not wish to connect to the utility monitoring device and also to allow for visual verification of usage. The request could also be sent to a computer connected to the utility monitoring device, for example. Data is received from the usage monitoring device in operation 204 utilizing the internet protocol network and an identifier is associated with the data in operation 206. This identifier identifies a customer using the utility. The identifier and the data are then transmitted from the utility monitoring device to a monitoring service in operation 208.

Preferably, for this and any of the other embodiments of the present invention found herein, the customer has a persistent connection to the internet protocol network, such as via a cable modem or a direct service line (DSL).

In an embodiment of the present invention, a request is received from the utility provider utilizing the network to allow the utility provider to gather data on demand for such things as billing, taking statistics, troubleshooting, determining an extent of an outage, etc. In another embodiment of the present invention, the data may also include a time (or times) of use of the utility. In such an embodiment, the data may correlate to a price of the utility that is coupled to the time of use. For example, units of electricity or water used during non-peak times would be cheaper than units used during peak times. The same could go for dates as well, such as where the price of a utility is cheaper on a weekend.

In another aspect of the present invention, the transmitting of the data from the utility monitoring device may be performed automatically at predetermined intervals. In a further aspect of the present invention, the utility may comprise electricity, gas, liquid fuel, and/or water.

Most remote meter reading systems have similarities in their designs. Generally, they comprise three major subsystems: (1) some type of encoder device physically attached to a meter and electronically connected to an end device to give an indication of the meter reading, (2) means for storing the meter reading indicated, usually a dedicated microcontroller, and (3) means for transmitting meter data over a communication link to a central station. Various types of communication links can be used to transfer the meter data from the individual end devices to the central station:

Wired via Power Line Carrier

There exist arrangements in which the power lines of the subscriber and the electric utility company are used as the link between the customer's meter and the central station. One such arrangement is described in U.S. Pat. No. 4,135,181, comprising a central station which includes a computer with input-output equipment for the multiplex generation of commands and the multiplex receipt of data over a plurality of communication lines. The system also includes an end device located at each customer residence. Each end device is connected to the power line, and receives commands from and transmits messages to the control unit over the connecting power line. Each end device is capable of selectively communicating with a plurality of utility meter encoders for reading a plurality of meters and for selectively driving a plurality of loads at a customer residence.

Wired via Telephone

Using telephone lines for automatic reporting of meter and status data is well known. In some of these systems, an interrogation signal is sent from a central receiving station to an end device (reporting station) in order to initiate the transmission of a report, the end device being either located at a telephone exchange or being connected through a telephone line thereto. Such systems may involve ringing of the customer's telephone or the installation of special ring-suppression equipment at the customer's facility or, alternatively, special equipment at the telephone exchange.

In another type of system, an end device initiates the transmission of a report. For example, U.S. Pat. No. 3,098,13 (Stonor) discloses a system in which a pulse-dialing operation is automatically performed, followed by the transmission of a message to report the condition at the end device. U.S. Pat. No. 3,357,011 (Diaz) discloses a system in which the call-in time is controlled by a clock at the end device, the clock also being used to periodically trigger transfers of data to a local memory for later transmission to the central station upon command.

Wired via Internet

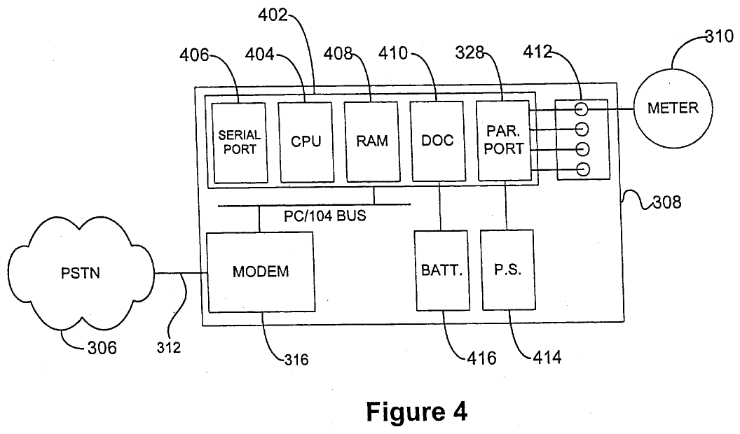

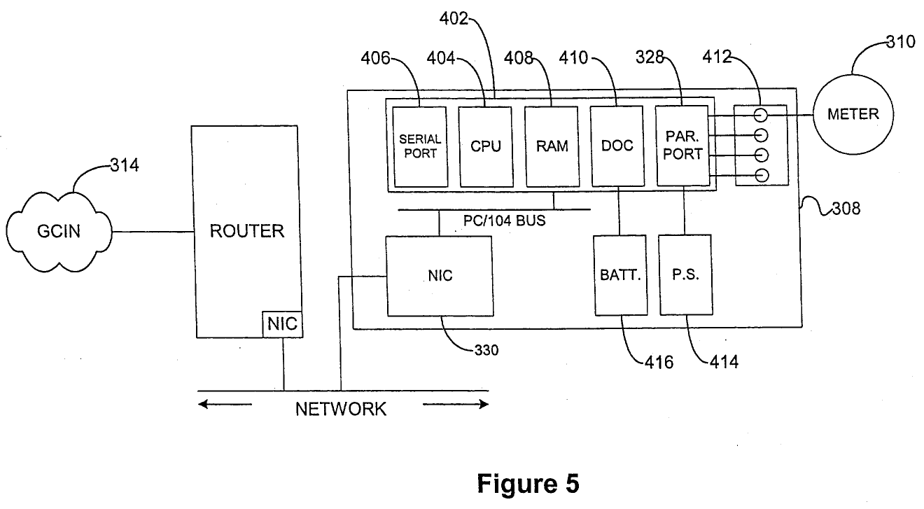

As shown in FIG. 3, an embodiment of the present invention utilizes the Internet to receive usage data from the usage monitoring device. Reference numeral 300 generally designates a Central Station and Automatic Meter Reading system constructed in accordance with the principles of the invention. System 300 comprises a Central Station, or Data Acquisition and Reporting (DAR) personal computer (PC) 302 (shown here with two internal modems 324 and 326), hereinafter referred to as the “DAR”. The DAR is connected through one or more telephone lines 304 to exchange equipment of the Public Switched Telephone Network (PSTN) 306, two lines being shown. System 300 further includes a plurality of automatic meter reader (AMR) units 308 connected to meters 310, which may be water, gas or electric meters at the sites of customers (e.g., commercial and industrial customers). Each unit 308 is referred to herein as an “AMR” and in the embodiment (shown diagrammatically in FIG. 4), is connected to the PSTN through telephone line 312 to its own modem 316. Telephone line 312 must be a line dedicated to the AMR device, i.e., with no other customer telephone connected thereto. However, the line may connect to the customer's Private Branch Exchange (PBX). The operation is described in detail hereinafter, as is the structure and operation of an alternative embodiment (shown diagrammatically in FIG. 5).

System 300 is very efficient at receiving raw meter data in the form of electrical contact closures in proportion to the commodity consumed, developed at meter 310, and in the processing of such data, to develop highly useful output data for use by a corporation, utility or municipality, with provisions for storing data indefinitely. The AMR output data may include, for example, meter readings obtained at predetermined times, time-of-day accumulation (TOD) data, peak rate (PR) data, tamper and outage indications. The mode of the AMR operation is readily changeable or reprogrammable at its installation site, but preferably from the DAR or any other PC that can be connected to the PSTN, and that has the software available as designed to perform this function. The system is designed to facilitate the initial installation of AMR units, and thereafter the tracking of the operational status of all units, the making of analyses of operations, and the rendering of reports that may be printed or transmitted. The DAR PC includes one or more modems, a computer keyboard, a printer and display, and its operation is described in detail hereinafter.

In operation of the illustrated system, each AMR receives and processes raw meter data in the form of pulses, continually developing and updating TOD and PR data as well as accumulated readings. The Schlumberger Model S12(d)S, Form 12S, if equipped with a pulse initiator, is an example of such a meter. In a preferred embodiment, the AMR, at an assigned time, through its integral modem 316, proceeds to dial a telephone number corresponding to a line which is connected to an e-mail provider which is a member of a global computer information network 314. It then sends (uploads) an electronic mail (e-mail) message to an address corresponding to the global computer information network account of the DAR. In another embodiment, the DAR uses the global computer information network's File Transfer Protocol (FTP) to retrieve a file through a pre-existing Router (owned by the customer) from a global computer information network FTP server, which is in fact the AMR. In either case, the AMR transmits its information in a predefined format, and the e-mail message or file contains the processed meter data to be retrieved by the DAR.

At assigned times of its own, the DAR, through one of its available internal modems, proceeds to dial a telephone number corresponding to a line which is connected to the global computer information network (e.g., via a global computer information network service provider). In one mode of operation, the DAR reads (downloads) the e-mail messages that were sent to the address corresponding to its global computer information network account by the plurality of AMRs. In another, it uses the global computer information network standard File Transfer Protocol (FTP) to retrieve the aforementioned AMR files from a designated FTP server, which is, again, a PC that is a host on the global computer information network. This FTP server is the AMR itself, and the file already resides on the logical hard disk of the PC. In any case, the DAR retrieves the formatted information, where each message and/or file constitutes the processed meter data that has been transmitted by the plurality of AMRs.

One of the most important features of the invention relates to the use of the global computer information network data transmission capabilities. Every unit in this system should be able to transmit or receive its data via a “local phone call”, thus enabling a global distribution of AMR units, with no significant increase from the cost to operate a regionalized system (for example, one that is restricted to a specific municipality). Also, there is no time at which any device must necessarily be in a condition to respond to a demand for attention from any other device within this system. That is, within the reliability limitations of the PSTN and the global computer information network, each AMR can always transmit its data at its assigned time(s) which, could be exactly the same local time for all of the plurality of AMRs distributed across a region (for example, at 12:05 a.m. local time). Similarly, the DAR can collect all of its data at any time of the day or night with one phone call, doing the equivalent of “polling the AMRs through the global computer information network” for any new data. This activity can be performed many times per day, with potentially very short time intervals between calls, enabling an extremely fast rate of data collection. Since all phone calls within the system are “local” to the unit making the call, it is not necessary to compensate for long distance calls by calling during lower rate night-time hours.

As described in detail hereinafter, the DAR stores both informational and control data which may include the telephone numbers for each AMR, and data applicable to specific AMR units, including serial number, location, owner, and any informational data as to the time periods at which it is to report. Such control data can be altered from the DAR. However, at the time of call from any DAR to an AMR, any control data in the AMR must be altered manually by an operator at the DAR operator's console.

As described in detail hereinafter, the AMR stores only control data specific to itself, which control data is required for its independent action. These data may include the telephone number for its local global computer information network e-mail provider, and data applicable to specific AMR units, including serial number and any informational data as to the time periods in which it is to report, and configuration data pertaining to the specific meter(s) to which it is connected. These are examples of the types of control data that can be initialized or changed remotely from the DAR.

Although the DAR is equipped to simultaneously transmit and process calls on a plurality of telephone lines, the illustrated DAR is shown as being connected to only two lines, because in normal operation only one phone call is required to collect all of the data from the plurality of AMR units. The second phone line allows, for example, a DAR operator to call to a specific AMR and initialize or alter its configuration parameters, according to the principles described above.

These and other features of the AMR, as well as associated features of the DAR and the interaction of the DAR with the plurality of AMR units, are described in detail hereinafter.

Data Acquisition and Reporting (DAR) 302

DAR 302 is shown diagrammatically in FIG. 3, and it includes PC 318 with a hard disk drive, a diskette drive and an optional tape drive for performing backups of its software and stored AMR data. In the preferred embodiment, the PC is an IBM-compatible computer. The PC is connected to display 322 which may be a super-VGA (SVGA) display. PC 318 is also connected to printer 320, and it is powered through a surge suppressor from an uninterruptible power supply (UPS) (not shown).

Also shown diagrammatically in FIG. 3, the PC interface to the PSTN comprises two internal modems 324 and 326, connected to the PC motherboard. The Central Processing Unit (CPU) may be an Intel.RTM. Pentium.RTM. processor, and it and the Random Access Memory (RAM) are all on a typical PC motherboard. The RAM should have a minimum sixteen megabyte capacity. Each of the modem units 324 and 326 in the illustrated embodiment, is a model “DeskPorte 28.8” (or equivalent) and is manufactured by Microcom of Norwood, Mass. Any compatible modem with speed above 2400 bits/second (bps) would suffice.

Each modem has a standard RJ-320 telephone connector, for connection to a telephone line, two of which are shown. Control and dialing means are provided for seizing a telephone line and making an outgoing call, as required to collect the AMR data, or to alter the configuration of an AMR. A 28,800 bps rate is used in communications between the DAR and the global computer information network, for those data transmission activities.

With a DAR as shown and with programming as hereinafter described, a very large number of AMRs can be accommodated for efficient, accurate and reliable receipt of meter data, and for compilation, printing, storage and transmission of such data to facilitate record-keeping and analyses of operations.

Automatic Meter Reading (AMR) Units 308

FIG. 4 is a block diagram of an AMR. Each AMR unit includes either one network interface or one telephone system interface, one PC battery and a power supply. The AMR's computer comprises one CoreModule/PC 402 (or equivalent) (available from Ampro Computers Inc., of Sunnyvale, Calif.), manufactured in the single-board IEEE Standard 996.300 (called the PC/104) form factor. This unit has one Intel.RTM. 8088 Central Processing Unit (CPU) 404 running at 318 MHz, with one Parallel Port 328 and one Serial Port 406. This CPU can be upgraded to PC/104 units with much higher speed and capacity. Each AMR has a minimum of 256 KBytes of Main Memory (RAM) 408 for storage. This provides approximately 192 KBytes for storage of programs and meter count data.

One serial port is available for direct (on-site) serial asynchronous data communications to the AMR, and for the preferred embodiment one Aprotek MiniModem Model 8100, an internal 2400 bps modem 316 (available from Aprotek, Rogue River, Oreg.), is used for remote serial asynchronous data communications, that is, typically between the AMR and the global computer information network. A1 on-site operator interaction with the AMR is via a directly wired serial communication cable through the serial port, from a user-supplied console, for example a portable PC. Remote access to the AMR is provided via the AMR modem 316 interface through the PSTN. Therefore, data communications can take place via two channels: a serial port 406 addressed as COM1:, and the Aprotek MiniModem 316. This modem 316 is a PC/104 version of a “Hayes Smartmodem”, capable of understanding all of the Hayes “AT” commands, receiving and sending data at 302,400 bps.

One 606-pin DiskOnChip 410 (available from M-Systems Inc., Santa Clara, Calif.) is installed in the 614-pin Socket of the Ampro CoreModule/PC, to provide 720 KBytes of secondary storage as a logical “Drive C:”.

The Ampro CPU's parallel port 328 is configured for “extended mode” operation to enable four digital input signals. This port is used to track the contact closures of the meter pulses. In the preferred embodiment, meter output rates can be as high as 408 pulses per second (i.e., a 50 mSec period), but each pulse must be at least 328 mSec in duration. Other embodiments are envisioned having other sampling rates and different pulse counts and pulse durations.

All components are mounted within one NEMA-1 steel enclosure with a rear-mounted panel. This level of protection is suitable for use only within commercial or industrial buildings. Outdoor installations will require hardier enclosures and additional components.

Additional wiring to a terminal strip 412 provides four terminations that can be used to detect up to four sets of meter pulses, where a pulse is generated by the meter sensor unit as a dry contact closure. The PC/104 boards (CoreModule/PC and modem 316) of the AMR are energized at all times through a power supply 414, connected to a standard 120 Volt AC, 60 Hz power source, such as that typically provided by the local electric company. A 3.6 Volt lithium battery 416 is also provided, to maintain the AMR PC's date-time settings and other configuration values during outages of the site's AC power.

Operation of Data Acquisition and Reporting—DAR

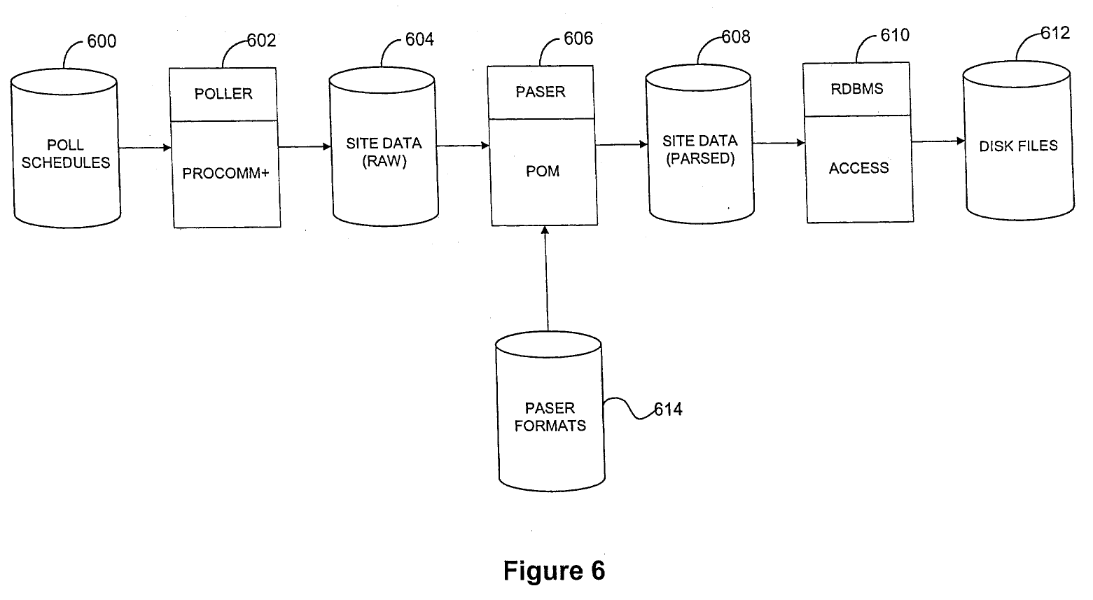

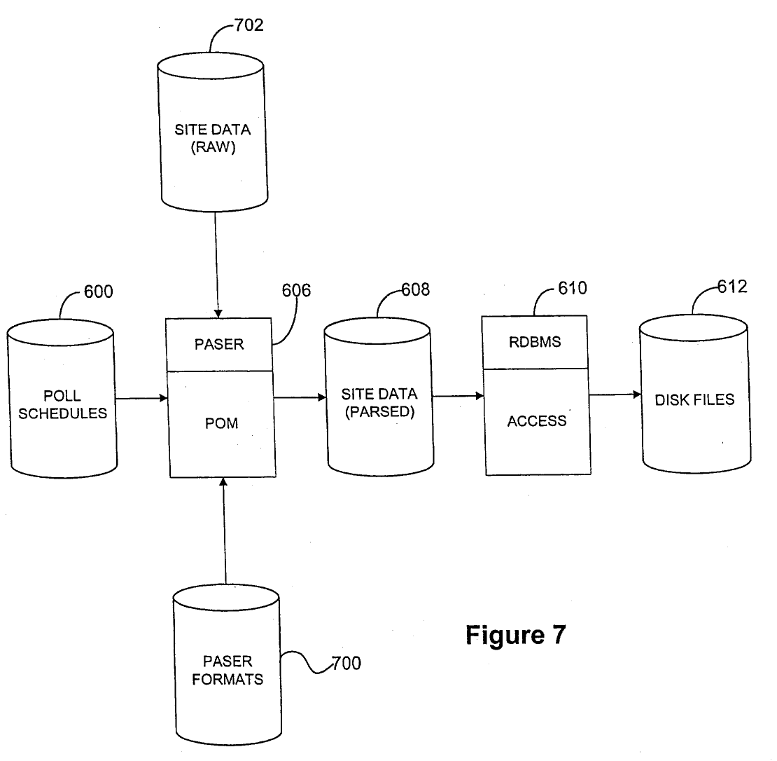

The mode of operation of the DAR is illustrated in the data flow chart of FIG. 6, in which the names of the commercial software programs are set forth for reference. Note that for clarity, commercial software is shown in rectangular boxes while disk files are shown as cylindrical shapes. FIG. 7 illustrates the flow chart of the data for an alternate embodiment, and uses the same shape designators as used in FIG. 6.

The commercial software packages used in the exemplary DAR are: Procomm for Windows 602 from Datastorm Technologies Inc., Columbia, Mo., used for the modem communication functions; Parse-O-Matic (POM) 606 from Pinnacle Software, Montreal, PQ, Canada, used to parse the data messages and files to produce new files that are suitable for import into the database; and Microsoft Access 610, from Microsoft Corp., Redmond, Wash., or any other relational or hierarcial database that contains all of the meter data from the plurality of AMRs, and additionally the reports, forms, queries, etc., that are used to display the data in report and graph formats for customer evaluation.

In the preferred embodiment, a CompuServe.RTM. account was used by the DAR to retrieve the AMR files that were posted on CompuServe.RTM.

Exemplary files, which include the parsing file Cis-mail.Pom and script Cis-mail.Was, are included in the microfiche appendix to this specification. One or more files are required for each commercial software component used for the DAR. The schedule, scripts and dialing directory are for Procomm, the parsing files are for POM, and the macros, reports, forms, etc. are all integrated within a single Access database (MDB) file.

At start-up, the Windows NT Server operating system is loaded from the hard disk into the DAR, and then the Procomm Plus for Windows 602 scheduling application is loaded. Excepting operator initiated calls directly to an AMR to manually modify configuration parameters, the Procomm Scheduler application controls the execution of all of the DAR data acquisition and storage applications through its time-of-day oriented Schedule 600. Any viewing and printing of graphs and reports of the previously collected AMR data is done independently, at the discretion of the system users.

The Schedule 600 (Pwsched.Dat) consists of a command that causes Procomm to load and then execute the script Cis-mail.Wax which performs the following: creates an error log Cedarerr.Log for this session; and performs the actual telephone dialing and data collection. The script performs additional functions, as described below. The other entry in the Schedule causes Microsoft Access 610 to load and execute a macro that imports the newly acquired and processed data, after all other sequences have been completed.

The first scheduled event causes Procomm 602 to load and then execute Cis-mail.Wax, the data collection script. The data are acquired as mail messages received via the Internet, and are stored as raw Message Site Data 604 on the DAR's hard disk. The included Procomm dialing directory and this script will call CompuServe.RTM. in this embodiment, CompuServe.RTM. is used as the Internet service provider (ISP) using a local phone number and a CompuServe.RTM. account that is dedicated to the DAR, and will use CompuServe.RTM.'s Mail function to retrieve the AMR messages posted through the global computer information network. The same script next starts an MS-DOS session, which loads POM 606, the data parser. POM 606 processes the Message Raw Data according to the instructions in the Parsing 614 disk file associated with this sequence. The result is comma-delimited Site Data 608, which is then easily imported into Access 610 by the Access macro that was mentioned above. When Access is closed, the Access Database is saved to the hard disk 612, thus also saving all data, including the newly acquired data, for later examination by the DAR users.

In the alternate embodiment illustrated in FIG. 7, the system uses the customer's existing network and Internet connection, and the DAR employs the TCP/IP and FTP capabilities that are included with the Microsoft Windows NT operating system, upon which the DAR software executes. Specifically, it uses the Microsoft Internet Information Server, included with Windows NT Server v4.0, to temporarily become a “host” node on the global computer information network with FTP client capabilities. The DAR then retrieves the files directly from the plurality of AMRs as direct file transmissions using the File Transfer Protocol.

At this point in the sequence, the raw File Site Data 702 is in approximately the same state as the raw Message Site Data 604 (FIG. 6) that was retrieved from the Internet in the preferred embodiment; both are stored as disk files on the DAR. Thereafter, the Procomm Scheduler 600 regularly processes these data according to a timed schedule, using POM 606 and its Parser disk file instructions 700 to generate comma-delimited Site Data 608, which is imported into the Access database 610 and stored as a DAR disk file 612. As just indicated, once the Site Data files 702 are retrieved, this processing is very similar to that performed by the preferred embodiment.

An important function of the DAR is to facilitate entry of identification AMR data, which can later be edited as required. Under manual control by a DAR operator, control data can be transmitted to the AMRs as an initial installation transaction, and also in subsequent alterations of the AMR configuration. The DAR is also operative to automatically retrieve and store data from a plurality of AMR units through the global computer information network, being also operative to parse these data messages and/or data files, and to place the results into the proper database fields. It is also usable to print data in the form of various reports and graphs employing a printer, or to display these data on a SVGA monitor.

The DAR uses high speed processing circuitry and is very fast and efficient in handling these functions. Its cost is, of course, very much greater than that of an AMR. However, since its cost is, in effect, shared by all of the AMRs (which may run into the thousands), and since the communications costs of each AMR are reduced, there is a very substantial overall reduction in the operating costs to the purchaser of such a system.

A further advantage of the arrangement using the DAR such as disclosed, is that it provides a great deal of flexibility with respect to changing modes of operation if required. The software for the DAR is loaded from the hard disk, and with a surge suppressor and a UPS, a high degree of system reliability is obtained, with assurance against loss of meter data. It should also be noted that in normal operations, the meter data is only briefly stored in the main memory (RAM) of the DAR, with frequent transfers to both the hard disk and the Access database, so the meter data is thus safely stored, with floppy disk or tape back-ups being regularly made, if desired.

Operation of Automatic Meter Reader—AMR

Referring to FIGS. 4 and 5, upon power-up, the DR-DOS operating system is loaded from the DiskOnChip 410 into the AMR's RAM 408, and then the meter reading software is loaded. An example program Mtrrdr.C is contained in the microfiche appendix to this specification, which also includes the makefile Makefile.Mak and the additional required files Report.C and Mtrrdr.H. Each program is formulated for an Intel-type CPU and compiled for the AMR's operating system. This program is composed of functions, with a naming convention that is oriented towards describing the purpose of the function, as indicated therein by program comments.

The commercial software packages used in the exemplary AMR are: DR-DOS v5.0 from Digital Research Inc., Monterey, Calif. used as the AMR operating system; Greenleaf CommLib from Greenleaf Software Inc., Dallas Tex., a “C” library used for the modem communication functions in the preferred embodiment; and Microsoft's “C” Compiler for DOS, from Microsoft Corp., Redmond, Wash., which is the compiler that is used to create the executable programs that comprises the AMR software.

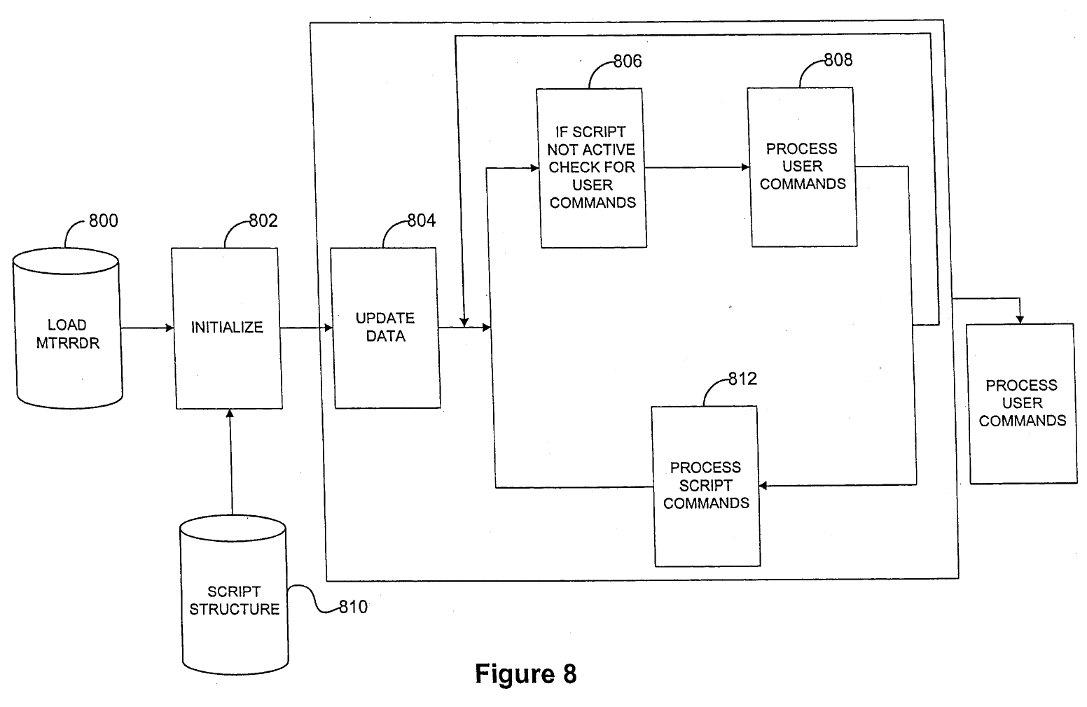

The mode of operation of the AMR is illustrated in the processing flow chart in FIG. 8, which depicts the sequential processing of the software. After power is applied to the AMR, the AMR software 800 (i.e. the program Mtrrdr.Exe) is loaded by the operating system, through a standard DOS Autoexec.Bat file. The AMR program consists of a number of functions; the function named “main” controls all processing sequences performed by the AMR. The “main” function first performs a number of steps that Initialize 802 various values to their initial conditions. These actions include using function “get.sub.—conf” to read the AMR's Configuration EEPROM, and retrieve some of the initialization parameters that are stored there in non-volatile memory. The communications port is initialized by function “init.sub.—port” and its buffers are cleared. The function “get.sub.—port” initializes the parallel port for data collection. The “main” function zeroes out the history data buffer, and its data indexes are set to initial values. The “main” function also gets the vector to the existing DR-DOS timer interrupt service routine and then chains to it after it finishes processing the Initialization 802 steps, substituting the address of its reader routine into the vector table. This enables the function “read.sub.—inputs” to poll the parallel port to determine if any meter pulses have been generated. The polling is thus synchronized to the AMR's timer pulse, at a standard PC polling rate of 18.2 times per second. The Script File 810 is read from the logical hard disk (the DiskOnChip) into a program structure named “script.sub.—table”, so that all site-specific data and processing instructions are incorporated into this instance of the program. The structure “script.sub.—table” is defined in the file Scripts.H, which is included in the microfiche appendix to this specification. The script file is generated by an off-line program, as described below, and then is copied onto the AMR's DiskOnChip, either when the AMR unit is assembled, or through a transmission from a remote PC, for use at the meter site.

After the above startup sequence has run to completion, the “main” function starts the primary processing loop, which can be exited only by the removal of power to the unit, or by the receipt of an abort command through the user interface. The support for Receipt of User Commands 806 and the Processing of User Commands 808 is built into the program to support the DAR's capability for on-demand transmission of commands and retrieval of the data values in the AMR. Processing of these commands is performed by the function “cmd.sub.—parser”, and the documentation for the protocol of the User Commands is available from Jenney Systems Assoc., Ltd.

While in the primary processing loop, other functions are called by the “main” function as required, causing them to execute, but always returning control of software processing to the “main” function. Note that it is a principle of the “C” programming language that while it is executing, any function can itself cause additional functions to execute.

In normal operation the first step in the primary processing loop is to Update Data 804 by calling the function “update.sub.—indexes”, which updates the pointers and the data in the history buffer. Next, if there is no script that is active during this processing loop, the Check for User Commands 806 is performed. The command buffer is checked for any contents by the function “poll.sub.—command”, and any commands are processed and then the command buffer is cleared. However, in normal operation, the next step will be to check the Script Schedule to determine whether to Process Script Commands 812, performing the actions that are specified in the Script File 810. The contents of the Script File 810 will generate a schedule, that is developed when the script is read in during the Initialize 802 phase. The timed processing of this schedule is set by the script parameters Period, Hours and Minute. The Period determines how often the script is to be executed, e.g., if Period equals 416, then it will run once every 416 hours. The Hours and Minutes taken together specify the start time for script execution.

The script itself determines the actions to take when the Script Schedule indicates that it is time to Process Script Commands 812.

Examples of scripted actions include SEND, which transmits a string to the AMR's modem, for example to dial a specific phone number. The REPORT action generates and then transmits (through the AMR modem) one of the AMR's reports. The RESPONSE action pauses the script processing until a particular string is received by the modem (e.g. “OK”). The optional TIMEOUT action sets a timeout, most often for the Response action, to prevent the script processing from waiting forever for a response to be received when transmission error conditions have developed. As is evident from the above, site-specific scripts can easily be developed to transmit reports to the DAR, in the form of e-mail messages, at any of a wide variety of intervals. The source code for the script processor, which converts the text file of script commands into the file that is the structure imported into the AMR software, is included in the microfiche Appendix to this specification, as Scripts.C. An example source script is included in the microfiche appendix to this specification as Scripts.Scr.

For direct communication between the AMR and an e-mail service connected to the global computer information network through the AMR's modem, the communications system operates at 2400 bps, with 312 Data bits, even Parity, and one Stop bit, to match those of the e-mail service provider used in the exemplary software.

The AMR software also performs data processing operations on its raw (meter pulse count) data to generate reports, through the function “prep.sub.—report”. These reports become the responses to some of the user requests in the Process User Commands 808 step. Some of the reports also become the contents of the e-mail messages and files that are transmitted across the global computer information network to the DAR. These e-mail messages are developed by functions such as “summary.sub.—report” and “detail.sub.—report”, which format the data from the history buffer in a relatively comprehensible and compressed format, thus additionally minimizing the duration of transmissions to the DAR. Reports can be generated for any of the maximum of four meters, or for a summation of all of the meters that are being polled by this AMR.

As described earlier, FIG. 5 generally designates an alternate embodiment of an automatic meter reader or “AMR” constructed in accordance with the principles of the invention. The hardware for all components of the system is identical, excepting that the system must have a larger quantity of installed RAM 408 to support the use of the FTP functions, and a Network Interface Card 330 replaces the AMR's Modem 316. This configuration also presumes the presence of a customer-owned LAN with a Router attached continuously to the global computer information network, allowing a permanent global computer information network connection for any PC on the LAN. The software components for the AMR's initialization, pulse counting and the formatting of data for transmission are identical to the preferred embodiment. This embodiment only differs in that the software logs the data to the logical disk (the DiskOnChip 410) as a disk file, and the global computer information network's FTP support is added to the AMR software, to enable this file to be transmitted through the global computer information network. That is, instead of using the e-mail messaging technique, data files are retrieved by the DAR from the AMR, which is acting as an FTP Server, the AMR being a permanent node on the global computer information network itself. The advantages of using the FTP approach include the fact that one distinct connection is established between the two communicating computers, which lasts only for the duration of the data transfer (nominally a few seconds); also, individual connections are logged to disk for subsequent diagnosis if needed, unlike e-mail, where no such diagnostic data is available for the cases in which a message might be lost in transmission.

For the alternate embodiment that uses the FTP file transfer protocol, the AMR uses the TCP/IP and FTP capabilities that are included in the package freely available from the National Center for Supercomputer Applications (NCSA). It is generically referred to as NCSA Telnet, and version 2.3.03 was used to develop this embodiment. NCSA Telnet includes FTP access from an IBM-compatible PC to Telnet hosts on TCP/IP networks. This software was available from the Internet site ncsa.uiuc.edu at the time that this version was assembled and provided to the public by NCSA. To support the TCP/IP communications protocol that is required for global computer information network FTP activities, a Network Interface Card 330 (NIC) is required to be mounted in the AMR, with a network connection to the customer's existing global computer information network Gateway or Router. For this embodiment, the NIC is a MiniModule/ETH-II from Ampro Computers Inc., of Sunnyvale, Calif.

The NCSA source code has been modified to incorporate its capabilities into the software that exists for the preferred embodiment. As requested by NCSA, the expression “Portions developed at the National Center for Supercomputing Applications at the University of Illinois at Urbana-Champaign” is included in each code module that was used for AMR development. This modified source code is available from Jenney Systems Associates, Limited.

Specifications of the Automatic Meter Reader (AMR)

The exemplary AMR units contain custom software that performs the following functions (refer to FIGS. 3, 4 and 5):

Polling: up to four digital input signals, in the form of dry contact closures at Terminal Strip 412, from up to four Meters 310, are polled to collect counts. Each input is filtered, i.e. subsequent pulses are gated off for 40 mSecs, to eliminate contact bounce. Counts are placed into program variables in the RAM of the AMR; peak power and its time are similarly saved in variables, as defined by the Demand Interval, nominally 328 minutes.

Reporting: a communications protocol is applied to format the data, allowing a minimized transfer time for these data, whether it is in the form of e-mail messages through global computer information network or files transferred through FTP. Additional features of this system include remote modification capability for most operating parameters.

For each Demand Interval, the following are stored: DATE: 306 Bytes; TIME (as Minutes-after-Midnight): a 330-bit Integer; and ENERGY: a 330-bit integer count of Consumption pulses. This makes a total of 314 Bytes per Demand Interval per meter.

Each day, a Summary is also calculated and stored: DATE: 306 Bytes, DD, MM,YYYY in Binary Coded Decimal (BCD); ENERGY: 306 Bytes; PEAK.sub.—POWER: 302 Bytes; TIME.sub.—OF.sub.—PEAK: 302 Bytes; for a total of 322 Bytes per day per meter.

Directions for Components of the System The following sections provide instructions for installing a working DAR (Data Acquisition and Reporting system) as described as the preferred embodiment in the patent specification. Besides the commercial software described in the specification and referenced below, at least one CompuServe.RTM. e-mail account must be acquired and used for this embodiment. For demonstration purposes, this account could be used by both a single AMR and the DAR, to exchange meter data. For multiple AMRs, each should have either an “in-house” e-mail account or its own Compuserve e-mail account, and the DAR should have a dedicated account also.

Directions for Components of the Access Database

The Microsoft Access database installation package contains a number of database functions. Some of these, including Queries, Forms, Reports and Access Basic code modules, are used arbitrarily to implement a DAR according to the customer's needs for data display and reporting. This section describes the minimum necessary steps to prepare a database for DAR functions. All detailed instructions to perform these steps are included in the Microsoft Access manuals. The first step is to create an Access database, arbitrarily named Meterrdr. Then develop the contents as described below, again using arbitrary names for the Tables (“MeterData” and “Sites”) and the Macro (“DAR”). See also “Directions for Components of Procomm for Windows” below.

Tables

Two Tables are needed to implement the DAR. One Table stores the site data, and the other holds the meter data as they are acquired.

TABLE 1
The structure of MeterData Table is as follows:

| Identifier | Data Type |
|---|---|
| Site Code | Number - Integer |
| Collection Date | Date/Time |
| Data Date | Date/Time |
| Data Time | Date/Time |
| Meter Number/Name | Text - 8 characters |
| Demand | Number - Long Integer |
| Data Number | Counter - *Index* |

Note: this Table can initially be empty.

TABLE 2
The structure of Sites Table is as follows:

| Identifier | Data Type |
|---|---|
| Site | Text - 20 characters |
| Site Code | Integer - *Index* |
| Owner | Text - 15 characters |
| Local Engineer | Text - 5 characters |
| Site Engineer | Text - 25 characters |
| Local Manager | Text - 25 characters |
| Configuration | Text - 1 character |
| Notes | Text - 50 characters |
| Address | Text - 30 characters |
| City | Text - 20 characters |
| State | Text - 2 characters |
| Zip Code | Text - 5 to 9 characters |
| Area Code | Text - 3 characters |
| Telephone (Voice) | Text - 8 characters |
| Telephone (Fax) | Text - 8 characters |
| Telephone (AMR) | Text - 8 characters |
| Meter Factor | Number - Single |
| Serial Number | Number - Long Integer |
| Spare Text | Text - 25 characters |
| Spare Number | Number - Long Integer |

Note: Table 2 must contain at least one entry in order for the Access Macro to execute without error. One dummy entry must be created, with a Site Code of 901. This Site Code is also used as the default in the POM script, which is included in the microfiche appendix to this specification (see also the next section, Directions for POM Processing).

Relationships

Using the Relationship function in Access, create the following Table Relationship: make a Join of Site Code in the MeterData Table, to Site Code in the Sites Table. The type of Join must “Include only rows where the joined Fields from both Tables are equal”.

Macros

Using the Macro function in Access, create a macro named DAR to perform two processing steps. The first step imports the AMR data into the database. The Action uses the Access function “Transfer Text”, and the Transfer Type is “Import Delimited”. The table name must match the name for the meter data Table, i.e. MeterData. The file name must match the name of the output file from POM Processing, i.e. Cis-Mail.Txt (see later sections of this document). The specification name is blank, and the Has Field Names entry should be set to “No”. The second step in the macro closes Access after the import of the newly acquired data. Set the Action to “Quit”, and the Options to “Save All”.

Directions for POM Processing

In the POM script Cis-Mail.Pom, which is included in the microfiche appendix to this specification, the following section must be modified to accommodate any arbitrarily chosen site names and codes:

```
;Determine SITE-ID; use the “From:” field in the capture file
SET FROM = $FLINE> 1 5!
SET SENDER = $FLINE>314 13!
BEGIN FROM = “From:”
  SET SITE-ID = “901”
  IF SENDER = “Site1 ” THEN SITE-ID = “1”
  IF SENDER = “Site2 ” THEN SITE-ID = “2”
  ;et cetera
END
```

Duplicate any additional SENDER (Site) and SITE-ID (Site Code) entries within the BEGIN-END section, and insert the Site Names and Site Codes respectively into the quotes for each line. The Site Names for this script are actually (as a minimum) the first five letters of the user names for the Compuserve accounts being used for the system. Be sure to create a corresponding entry in the Site Table of the Access database (see Directions for Components of the Access Database, above), so that the SITE-ID matches the corresponding entry (Site Code).

Directions for Components of Procomm for Windows

The Procomm for Windows communications package contains a variety of functions, including for example support for faxing, and a wide variety of configuration tools used to optimize use of the package. For the DAR, the only relevant components are the Procomm Scheduler and Procomm Plus, which is used to perform the actual communications. All detailed instructions to configure both the Scheduler and Procomm Plus are included in the Procomm for Windows manuals.

Procomm Plus

At least one dialing directory must be created for DAR use. Any name can be chosen for it, but that name must be used in the command for the Procomm Scheduler (see below). Once a dialing directory has been created, at least one Data entry must be added, to define the phone number and password for the Compuserve account to be used by the DAR, and also to specify the script and capture file filenames used in DAR processing.

The following values for the DAR entry in the dialing directory are or can have arbitrary values: Entry Name, Port Settings, and most of the Basic Options. That is, many of these depend on the hardware platform being used for the DAR. For Entry Info, click on the Logon Info button, and then enter the Compuserve User ID and Password for the account that is to be used by the DAR. For Port Settings, configure for Compuserve by using Even Parity, 312 Data Bits and 300 Stop Bit. Under Basic Options: the script must be Cis-mail.Was, which is included in the microfiche appendix to the patent specification. Under Setup for the script, check that it will “Start script after connection is made”. The capture file must be named Cis-Mm.Cap if the provided script is used, and under Setup it must be set to “Write text as it appears on the screen” and “Overwrite existing capture file”.

Procomm Script

This script requires that Access be stored in the directory C:.backslash.ACCESS and that the POM files are stored in the directory C:.backslash.POM. The file Dummy.txt, referenced in the script, is a simple text file containing dummy entries for all values, with a Site Code of 901, structured as indicated in the script Cis-Mail.Pom. It should be copied into the Procomm directory after Procomm is installed. The only function of this dummy file is to allow unattended processing to continue if the software is unable to contact CompuServe.RTM., or if there are no waiting messages from AMRs. That is, this dummy file is processed and imported when there are no new data available. All of the above names and directory locations can be changed to suit a particular installation, provided that the script is first edited to reflect these changes, and then recompiled.

Procomm Scheduler

Although the DAR can be run manually to acquire the AMR data, using similar methods to those described below, the Procomm Scheduler is normally employed to acquire the same data in an unattended fashion. Two entries must be made into the Schedule: (300) to use Procomm to make the call to CompuServe.RTM. to collect the raw site data, and (302) to start Access and import the parsed data. The execution of Procomm will also cause POM to execute and parse the data.

Start the Scheduler program, and create a Schedule entry to execute Procomm. For Program, enter a full path to the Procomm executable “Pw3.exe”. Use the Procomm Plus button to create an Automatic Connection, with the arbitrarily named directory as the Connection Directory, and ensure that the arbitrarily named Directory Entry is selected from the dropdown list of entry names as the entry to process. Then set this Schedule entry to execute at an arbitrary time and frequency.

Using similar methods, create a Schedule entry to execute Access. For Program, enter a full path to the Access executable “Msaccess.exe”. For Arguments, enter the file name of the arbitrarily named database Meterrdr.Mdb followed by a space, a /X and then the name of the DAR macro—i.e. the full argument would be: “METERRDR.MDB /XDAR”. Then set this Schedule entry to execute at a time just after the time (e.g. 10 minutes later) used for the Procomm entry, with a corresponding frequency.

Directions for Initializing an AMR

The following section provides instructions for initializing a working Automatic Meter Reader after the hardware components have been assembled. Refer to the Ampro documentation for details of how to perform these activities, including the cabling requirements to connect an available PC to the AMR's CoreModule CPU board. As described in the Ampro documentation, the CPU board contains a Configuration EEPROM, and certain values, e.g. the Serial Number and initialization date, must be written to this EEPROM after the AMR has been assembled. The programs that the AMR executes must also be loaded onto the DiskOnChip, according to the procedures described in the Ampro documentation. These programs consist of Ampro's Setup.Com, the AMR program Mtrrdr, the initialization program Initrdr and an Autoexec.Bat file, simply used to start the Mtrrdr program under DR-DOS whenever power is applied to the AMR.

Using the hardware setup and instructions as described in the Ampro documentation, and a communications program such as the DOS shareware version of Procomm, establish communications between the PC and the CPU board. Use Ampro's Setup program to set the date and time to be correct, and verify that the CPU board has a configuration that is correct for the hardware of this AMR, using procedures described in the Ampro documentation. Then execute the program Initrdr, which sets certain EEPROM values for use by the AMR software. The source code Initrdr.C is included in the microfiche appendix to this specification. The command to run this program consists of the program name, followed by any specific configuration parameters. The minimal command, which would set the serial number of this unit to NNNN, and set all other parameters to defaults, would be: “INITRDR S=NNNN P=0”. Details concerning other possible configurations, that are not applicable to this specification, are available from Jenney Systems Associates, Limited upon request.

The arrangements of the invention as illustrated in FIGS. 3, 4 and 5 have the advantage of a substantial reduction of cost and manufacture in large volumes, and greater reliability as a result of minimal circuit interconnections. The use of industry standard hardware and software components makes both the DAR and the plurality of AMRs highly reliable for use in actual application, with easy replacement of the hardware, and the potential to upgrade the software components to newer and more powerful and efficient versions as additional requirements are imposed.

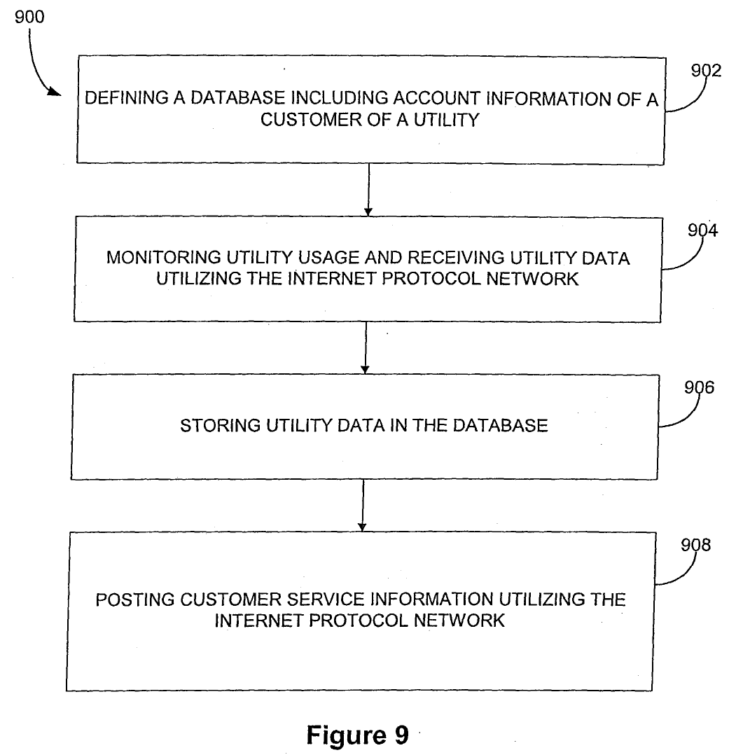

FIG. 9 is a flowchart illustrating a process 900 for operating a utility service utilizing an internet protocol network. In operation 902, a database is defined and includes account information of a customer of a utility. It should be noted that the database may be part of a system having more than one physical storage location. Customer usage of the utility is then monitored in operation 904 utilizing the internet protocol network. Usage data gathered while monitoring the customer usage is stored in the database in operation 906. In operation 908, customer service information is posted utilizing the internet protocol network.

In one embodiment of the present invention, customer service information is received utilizing the internet protocol network. Such customer service information may include customer identity. Preferably, the customer service information includes a type of service. Optionally, the customer service information includes service measurement and/or time interval.

An illustrative embodiment of the present invention is directed to a monitoring and control system in which communication occurs through a fully distributed digital communications switch without a centralized routing and handling facility, including cable modems and DSL services. The distribution network is deployable to large numbers of residential and commercial customers for bi-directional real-time communication. While initially designed for use with an electric power utility, the invention is applicable in monitoring and controlling demand for other utilities such as gas or water, as well as for data services.

Referring now the drawing, FIG. 10 is a functional diagram illustrating a power monitoring and control system in accordance with one embodiment of the invention. Communication in the system is between a mainframe host computer 1000 at the power utility company central offices and the homes 1002 of customers serviced by the utility. The home network for each customer includes electrical control, monitoring, and measurement devices. An intelligent utility unit (IUU) 1012 located at each customer's home allows the host computer 1000 to monitor electrical consumption in real time and help the customer optimize electrical power consumption. The IUU communicates with the host computer 1000 through a bi-directional data distribution network 1004 which is connected at a substation 1006 through a bridge 1008 to the digital backbone network of the utility company, which is in turn connected to a Bridged Gateway interface 1010 of the host computer 1000. The distribution network 1004 comprises a coaxial or optical fiber cable in which there is a plurality of time and/or frequency division multiplexed channels. The digital backbone network may be a combination of copper and high volume fiber optic cables. The digital backbone network runs over high-speed digital lines.

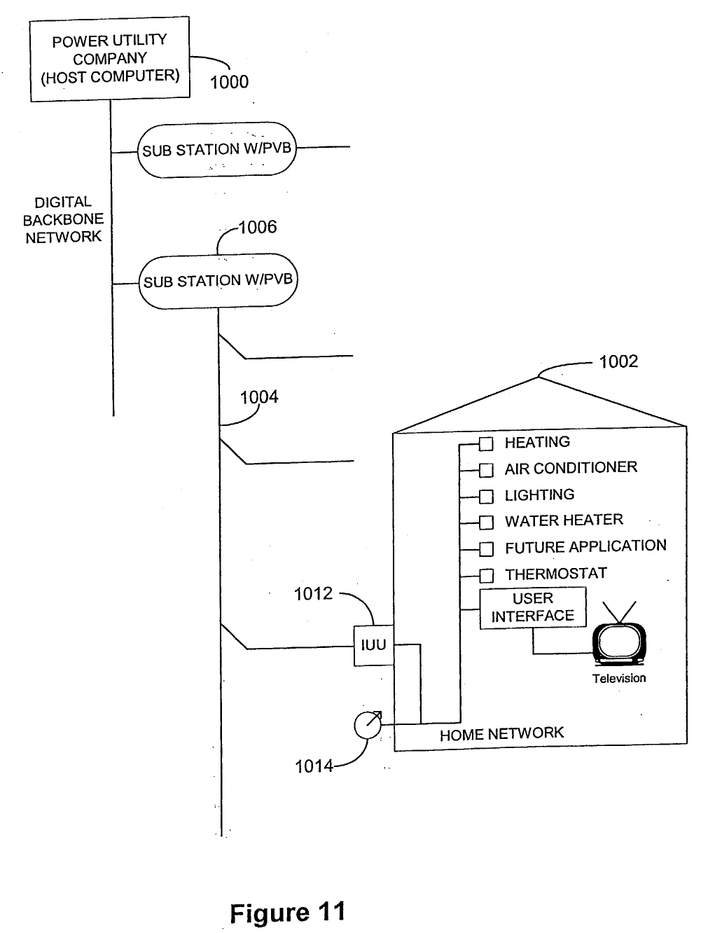

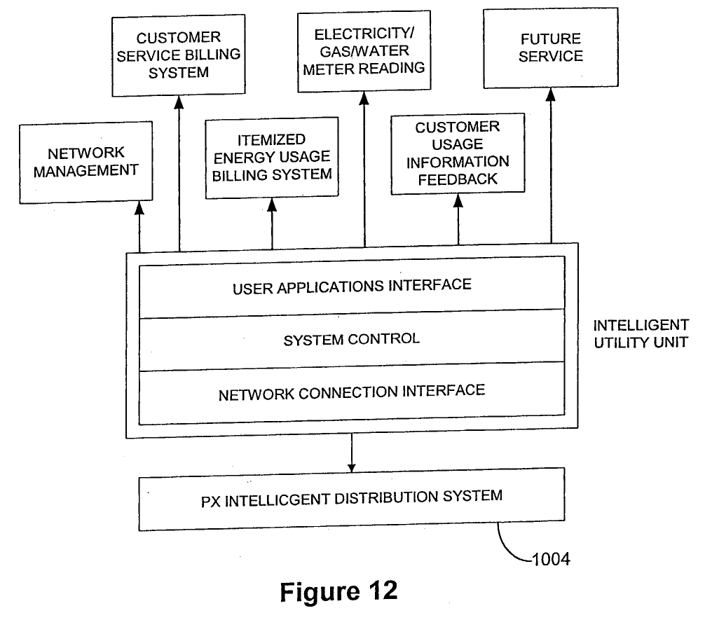

FIG. 11 is an illustrative embodiment of the home network located at each customer's home. The IUU 1012 is the interface between the home network and the distribution network 1004. The home network includes electrical control, monitoring, and measurement devices located and operated within the customer's home. An electronic power meter 1014 allows the reading of total power consumed to date, total power being consumed at present, and the change in power consumed from the last period monitored. Power disconnect and reconnect of the electronic power meter is controlled at the power utility company central office through the host computer 1000. The IUU is further connected to sensors and switches connected to the home heating, air conditioning, lighting, water heater, thermostat, and other internal circuits, as illustrated. Further, an optional user interface is provided with a readout provided by the television set or LCD panel, for example. FIG. 12 is a functional diagram of the IUU in interfacing with the home network and the distribution network 1004.

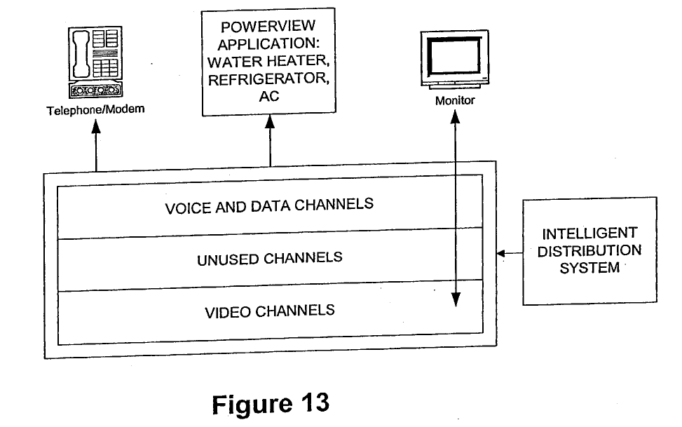

The distribution network allows a wide variety of digital information processing devices plus simultaneous switched voice (telephone), data, and full motion NTSC video services to communicate simultaneously over a single wiring system as illustrated by the bandwidth allocation of FIG. 13. The distribution network comprises a single high-speed digital bus with the channel bandwidth allocated into time slots, signalling bandwidth, and overhead functions. A plurality of 5.018 MBPS data streams are provided with each data stream organized to include 28 full duplex time slots utilizing 3.584 MBPS bandwidth and which can be allocated for voice or data traffic. An out-of-band signalling channel operating at approximately 640 KBPS is shared by all units on the network for configuration and call processing information exchange. Further, bandwidth set aside for overhead functions such as relative system timing, time slot preambles, and time slot and signal bandwidth synchronization is included in each 5.018 MBPS stream. For data applications, a fixed number of time slots, typically between 1 and 8 and up to a maximum of 24 are permanently allocated and configured for data services on the distribution portion of the network. These time slots are shared between all IUUs on the network. In essence, a portion of the network bandwidth is allocated for data LAN services. When a time slot is allocated for data services, either or both the forward and reverse time slots, i.e., both ends of the full duplex time slot, can be allocated and used for data transmission. Under this convention allocation of additional time slots for data services increases the LAN speed by 64 KBPS per time slot.

Since the distribution network is structured like a bus oriented LAN, random access or control contention is required to manage access to the IUUs. Either a carrier sense multiple access (CSMA) or a carrier sense multiple access with collision detection (CSMA/CD) access mechanism is employed. In CSMA, a node listens for network traffic and if nothing is heard, packets are sent to the host computer. Problems can occur when multiple nodes send before activity can be detected. In CSMA/CD, senders listen while transmitting, and back off and retransmit when collisions are detected. Throughput is high, ranging between 80% and 90%. The selection between CSMA and CSMA/CD is based on the tradeoff between enhancement and performance achieved by using a CSMA/CD mechanisms versus the issues of cost and implementation as compared with CSMA. The important consideration for a network access method is that it should be stable under heavy loads, i.e., it should back off for longer periods of time during peak operation. The longer backup times should not affect network operation since time access of most applications are near real time even under heavy load conditions.

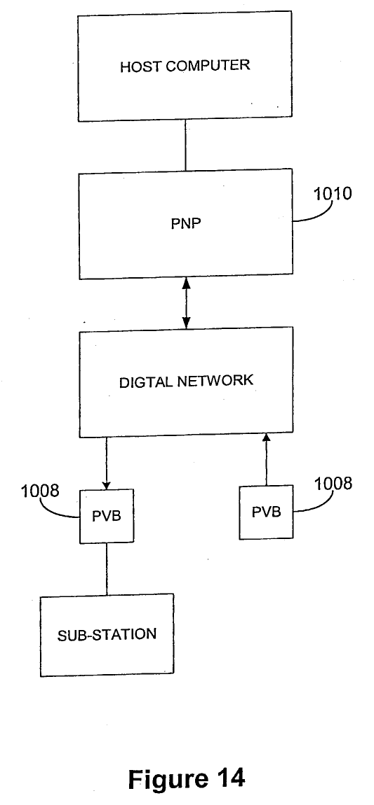

FIG. 14 illustrates the bi-directional full duplex organization of the distribution network. The radio frequency spectrum is typically divided into outbound or downstream from the host computer head end of the cable towards the end user devices and inbound or upstream from the end user devices towards the head end. The RF spectrum on the cable can be organized in one of three ways: sub-split, mid-split, or high-split. These terms refer to the particular segments of the RF spectrum used.

In a sub-split system, the frequencies from 5 to 30 MHz (4 channels) are used to carry signals in the inbound directions and the frequencies from 50 MHz to 1 GHz (80+channels) are used to carry signals in the outbound direction. This is illustrated in Table 3.

In a mid-split system, the frequencies from 5 to 108 MHz (17 channels) are used to carry signal in the inbound direction, and the frequencies from 162 MHz to 1 GHz (50+channels) are used to carry signals in the outbound direction. See Table 4 for a representative mid-split cable spectrum.

In a high-split system, the frequencies from 5 to 175 MHz (30 channels) are used to carry signals in the inbound direction, and the frequencies from 220 MHz to 1 GHz (35+channels) are used to carry signals in the outbound direction. See Table 5 for a representative high-split cable spectrum.

A multi-tiered addressing scheme is employed in the network. Each IUU contains the following address structure:

Physical unit address-six-byte address unique to every unit. The address is written in HEX and coded into each IUU.

Group address-allows addressing of assigned group less than all users.

Broadcast address allows addressing of all system users.

This addressing structure allows the network manager to directly communicate with each individual IUU, a group of IUUs, and all IUUs.

The gateway between the distribution network and the digital backbone interfaced to the host computer is located in the utility company substations. A Power View bridge (PVB) provides the routing function between the distribution network and the backbone network. The bridge processor keeps track of IUU addresses and the network processor address and performs the routing function for all packets between the networks. The bridge also performs a filtering function in passing data only to valid known addresses.

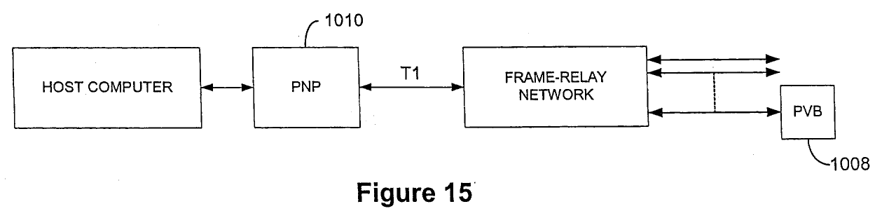

FIG. 15 is a functional block diagram of the digital backbone network which interfaces the host computer with the plurality of distribution networks. The backbone network includes a Frame Relay T1 interface for providing the interface between the gateway and the backbone network. A PowerView Network Processor (PNP) which provides an interface between T1 data streams and the utility host computer which provides the management of the overall network. The backbone network can be organized as a star, ring or bus. The actual topology is not important since circuits will be dedicated from the utility substations to the host computer. The digital circuits terminate at a PNP near the utility company's host computer. The backbone network can operate from T-1 rates upwards and exceeding T-3 rates, depending upon network and utility size. The T1 network distribution media is twisted wire, optical fiber, coaxial cable, or microwave. The T3 networks are either fiber or microwave. Minimum network speed is T-1. Network addressing is a function of the circuits dedicated to the distribution network and a lower level addressing between the IUUs and the utility company's host computer. Alternatively, an ATM interface could provide the interface between the gateway and the backbone network. An ATM interface router would then interface between the backbone network and the host computer.

The application package within the host computer includes the ability to collect information about time of day power consumption, the ability to remotely configure the home network through the IUU, the ability to change the price tier in real time either up or down as a function of power generation and consumption, and the ability to collect and process the customer's utility bill which breaks down power consumption by device, time of day, override conditions, and the like in order to provide an itemized billing statement to the customer.

There has been described a system for utility demand monitoring and control and including a distribution network which facilitates demand side management of utility consumption. While the system has been described with reference to an illustrative electric power utility embodiment, the description is illustrative of the invention and is not to be construed as limiting the invention. The system can be used with other utilities such as gas and water as well as with telephone and cable television networks. Other functions are readily incorporated such as security systems. Thus, various modifications and applications will occur to those skilled in the art without departing from the true spirit and scope of the invention as defined by the appended claims.

TABLE 3
SUB-SPLIT BROADBAND

##STR1##
##STR2##
##STR3##

TABLE 4
MID-SPLIT BROADBAND

##STR4##
##STR5##
##STR6##

TABLE 5
HIGH-SPLIT BROADBAND

##STR7##
##STR8##
##STR9##

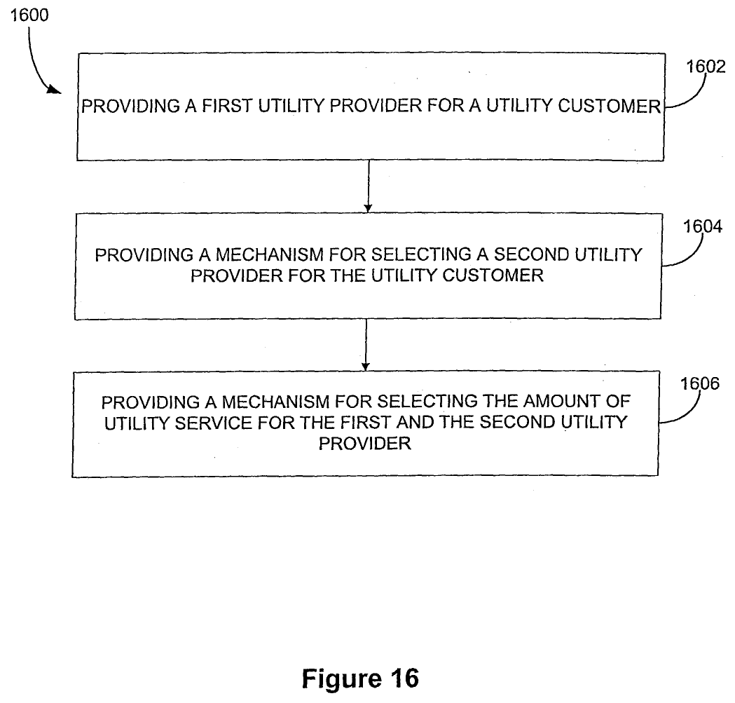

FIG. 16 is a flowchart of a process 1600 for facilitating a selection of a first and a second utility provider for a utility customer. A first utility provider for a utility customer is provided in operation 1602. Provided in operation 1604 is a mechanism for selecting a second utility provider for the utility customer. Further provided, in operation 1606, is a mechanism for selecting the amount of utility service for the first and the second utility provider.

In an aspect of the present invention, the utility services comprise at least one of electricity, gas, liquid fuel and water. In another aspect of the present invention, the customer may be offered preferential pricing because the customer is already a customer, as opposed to someone signing with the company for the first time.

In an embodiment of the present invention, products may be endorsed such as by one of the utility providers or, preferably, by the local service provider who maintains the delivery system of the utility. In another embodiment of the present invention, the customer can select a provider based on a service of the provider or a criteria of the provider.

In an optional embodiment of the present invention a process is provided for encouraging connecting to a source of alternative energy. An existing utility connection to a location of a customer of a utility is maintained. Next, an alternative form of energy is also made available to the customer. Support services related to the alternative form of energy are offered. Such support services may include customer service, installation, maintenance, sales, delivery, etc. Both the existing utility connection and a connection to the alternative form of energy are allowed to coexist at the location of the customer for providing backup service in case one of the utilities has an interruption in service.

In an aspect of the present invention, a utility provider may execute the above procedures. In another aspect of the present invention, the utility may be one of electricity, gas, and/or liquid fuel. In a further aspect of the present invention, the support services may include: connecting the alternative form of energy to the location of the customer, checking a connection of the alternative form of energy to the location of the customer, and/or servicing equipment associated with the alternative form of energy such as heating equipment, connection equipment, gas home fuel cells, etc.

In an embodiment of the present invention, the customer may be offered preferential pricing because the customer is already a customer, as opposed to someone signing with the company for the first time. In another embodiment of the present invention, products may be endorsed that utilize the alternative form of energy.

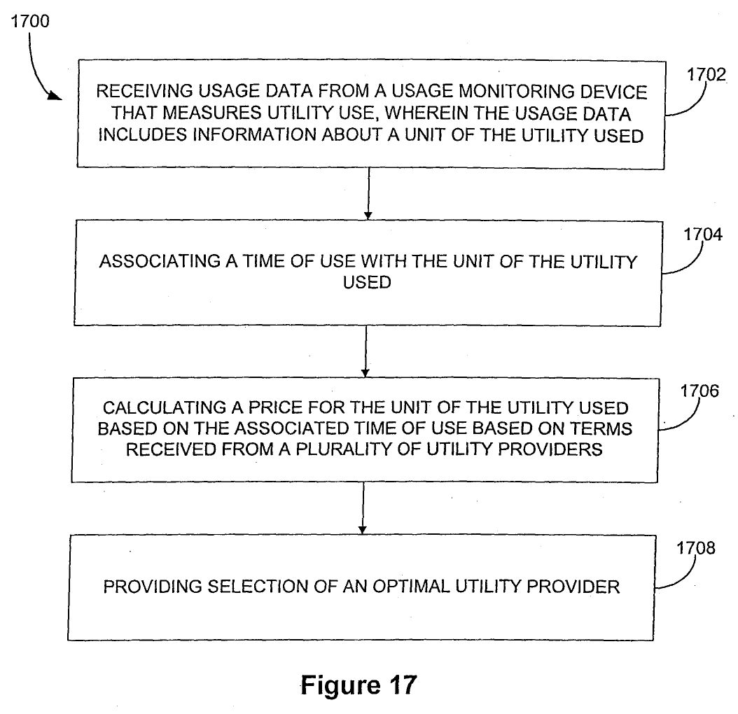

FIG. 17 is a flowchart depicting a process 1700 for allowing time-dependent pricing of a utility from one of a plurality of utility providers. This process may be performed by a computer at the location of the utility customer, such as the control unit set forth above, or may be implemented to request and receive the usage data utilizing the wide area network. In operation 1702, usage data is received from a usage monitoring device that measures or estimates utility use, such as a meter. This usage monitoring device may also form part of the device (i.e., smart appliance) using the utility. The usage data includes information about a unit or units of the utility has been, will be, or is being used. Also, the usage data may be received in real time, or may be received in batches. A time of use is associated with the unit of the utility used in operation 1704. The time of use may be determined at the remote location, or may be included in the usage data received from the usage monitoring device.

A price for the unit of the utility used is calculated in operation 1706 based on the associated time of use and on terms received from a plurality of utility providers. For example, units of electricity or water used during non-peak times would be cheaper than units used during peak times. The same could go for dates as well, such as where the price of a unit is cheaper on a weekend. In operation 1708, an optimal utility provider is selected. An optimal utility provider may be the one charging the lowest price per unit of energy, or may be selected based on reliability.

In an embodiment of the present invention, utility service requirements are accumulated from a plurality of customers. Optimal terms are also provided to service the aggregate customer utility requirements. Preferably, the terms include differential pricing. As an option, the terms may include characteristics of service providers and/or differential billing options. In a further aspect of the present invention, the utility may includes one of electricity, gas, liquid fuel, and/or water.

In an optional embodiment of the present invention, a request for usage data may be sent to the usage monitoring device utilizing the wide area network. In an aspect of the present invention, the price for the unit of the utility used may be determined from pricing information received from the provider of the utility. As an option in such an aspect, use of the utility may be managed based on the pricing information. This could include, for example, running certain hardware and appliances, charging storage cells, etc. at times when the price per unit of the utility is below average or at an optimum low.

In another embodiment of the present invention, a payment may be transmitted electronically to the provider of the utility utilizing the wide area network. In a further aspect of the present invention, the utility may includes one of electricity, gas, liquid fuel, and/or water.

In an embodiment of the present invention designed to allow computerized billing and payment, a host system includes a database in which information associated with a billable entity from which payment is to be received is stored. Billing information is received from a billing entity and is associated with a bill for payment by the billable entity. The billable entity is provided with remote electronic access to the billing information in the host computer and can authorization payment thereof. In one implementation, the billing information is scrutinized in accordance with pre-determined tolerance parameters prior to the billable entity gaining access thereto. In another implementation, a plurality of billing entities provide billing information to the host system, with the billing information being subsequently checked and consolidated into a consolidated amount which can be remotely accessed by the billable entity. In a preferred implementation a plurality of utility providers are incorporated into the system and provide billing information for customers which may have a number of different, geographically-separated sites being serviced by different utilities. The billing information is consolidated and made available electronically through access which is initiated by the customer. Preferably, the systems and methodologies of the invention are implemented in connection with a multi-user computer network such as the Internet.

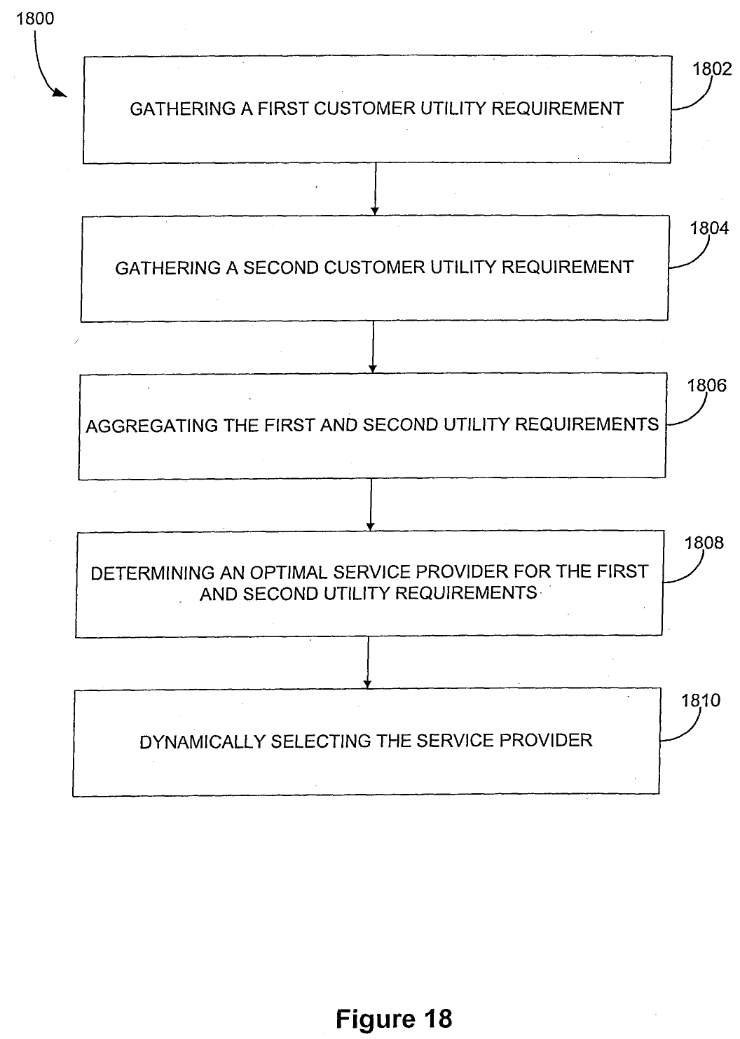

FIG. 18 is a flowchart of a process 1800 for minimizing a cost of the utility utilizing an internet protocol network. Utility requirements of a first and a second customer are gathered in operations 1802 and 1804 and then aggregated in operation 1806. In operation 1808, an optimal service provider for the first and second utility requirements is determined and, in operation 1810, is dynamically selected.

In one aspect of the present invention, a customer utility requirement is based on a customer determined transaction interval. The customer determined transaction interval may be the time period for the price terms or may be the period of time for the utility service. As an option, the customer determined transaction interval is aggregated based on the first and second utility requirements. Specifically, the customer determined transaction interval may be aggregated based on the requirements for electricity, gas, liquid fuel, and/or water.

In an illustrative embodiment of the present invention for minimizing a cost of the utility, a rate of use of a utility is first determining at a customer location for at least one device. Such devices could include hardware, appliances, energy storage cells, heating units, cooling units, etc. The device could also be a water or gas storage tank. A price schedule is received utilizing a wide area network, wherein the price schedule includes a cost per unit of the utility at various times. The price schedule and the rate of use of the utility is analyzed by the device for determining a time to activate the device so that the minimum cost is incurred from the device's use of the utility. The device is then activated at the determined time.

In an aspect of the present invention, the price schedule may be received in real time utilizing the wide area network so that it is continually updated. In another aspect of the present invention, the price schedule may include a cost per unit of the utility from more than one utility provider and further comprising the step of selecting a utility from one of the utility providers. This permits selection of the lowest price provider as well as the lowest-priced time to use the utility.

In a further aspect of the present invention, the device may be a network enabled appliance. In one embodiment of the present invention, a cost of the utility used may be calculated so that a payment may be electronically transmitted to the provider of the utility utilizing the wide area network. In even another aspect of the present invention, the utility may include electricity, gas, liquid fuel, and/or water. Reference should be made to the discussion with respect to FIGS. 10-15, which describes a home network.

In an illustrative embodiment of the present invention, particularly applicable to the embodiments of FIGS. 17, 18, and 19 as well as embodiments concerning market type purchasing and/or auctioning of a utility set forth below, the system of the present invention accumulates data in real time from the control areas by having the different transmission owners, energy providers and energy buyers within the electrical interconnections be connected via a computer network.

The transmission owners are connected through the network to a data review board that ensures that any information about the transmission owner's facilities is accurate and uniform. The information that is sent to the data base by the transmission owners includes energy transportation network data, such as the physical and electrical characteristics of the transmission owner's facilities including, but not limited to, the voltage, rating, impedance and length of each and every segment of the transmission lines. Upon the review by the data review board, the information from the transmission owners is combined and sent to a processor for storage in a data base. The transmission owners, energy providers and energy buyers (collectively hereinafter referred to as “energy system users”) are connected to the processor through the computer network for accessing the information stored in the data base. The energy system users each have a computer terminal that is also connected via the computer network to an Administrator, who acts as an agent for the energy system users.

The energy system users, through the use of their computer terminals, can simultaneously review the stored data and make informed decisions about the availability and cost for the use of the energy transportation network. The Administrator has a computer terminal to maintain a current storing and recording of the incremental data in the data base, as well as for communicating with the energy system users through the computer network.

The system of the present invention thus provides the energy system users with the ability to use the computer network to negotiate on a timely basis for the efficient and reliable movement of energy between the parties, which is hereinafter referred to as the “incremental market.” The transmission owners, providers and buyers can each be or become a user of energy or of the energy transportation network. Upon the completion of a negotiation for the movement of energy, the respective user sends a confirmation of the negotiated movement of energy to the Administrator via the network. The Administrator upon receipt of such confirmation, updates the data base with the proposed transaction, thereby ensuring that the data base maintains an accurate representation of the energy transportation system. Simultaneously, the Administrator sends the information about the proposed transaction to a temporary memory connected to the processor for future billings and payments for the movement of energy. The temporary memory accumulates the transactions that occur over a period of time and allows the Administrator to send composite invoices for the total costs of energy transactions which occurred during such period of time.

The Administrator would provide software to the energy system users that would be necessary to process the data base maintained by the processor to determine the availability and allocation of transportation needed for the movement of energy (referred to as “system allocation”). By identifying the facilities actually used, the transmission owners could be compensated for—and users can be charged for—only the facilities that are actually used to move the energy.

The data gathering operation of the present invention is carried out by a processor. The processor has a temporary memory, which provides the processor with the means of storing real time facility on-site data and energy requests and transmitting this information to the data base for purposes of updating the data base.

In accordance with the present invention, an energy system user analyses on its terminal a desired transaction for the movement of energy, such as the transmission of a requested amount of electrical power. If the required facilities are available and the price is acceptable to the user he notifies the Administrator. The user's request is received by the processor. The processor temporarily stores the proposed transaction in the temporary memory and prompts the user to send any additional information concerning its use of the energy transportation network to the Administrator, if not already stored in the temporary memory. The processor upon receipt of the prompted information processes the information and identifies the user, the user's respective facilities and the available transportation means for the transfer of energy. The user's information and the processed data is transmitted to the data base for updating the data base. The Administrator can then communicate with the user using the stored data that can be displayed on the Administrator's computer terminal.

If there is no capacity available for a desired transaction the potential user may request bids from those able to free up the needed capacity. The Administrator may assist in this task by supplying to the potential user a list of transactions that may satisfy the requested requirement. The potential user could seek bids via the computer network from other users who may be able to free up capacity on the constrained energy transportation network. The supplying user could then charge the potential user with the opportunity cost for having to give up or forego a current use or a previous commitment to use the energy system. The opportunity cost, if accepted, would be in addition to the transportation cost.

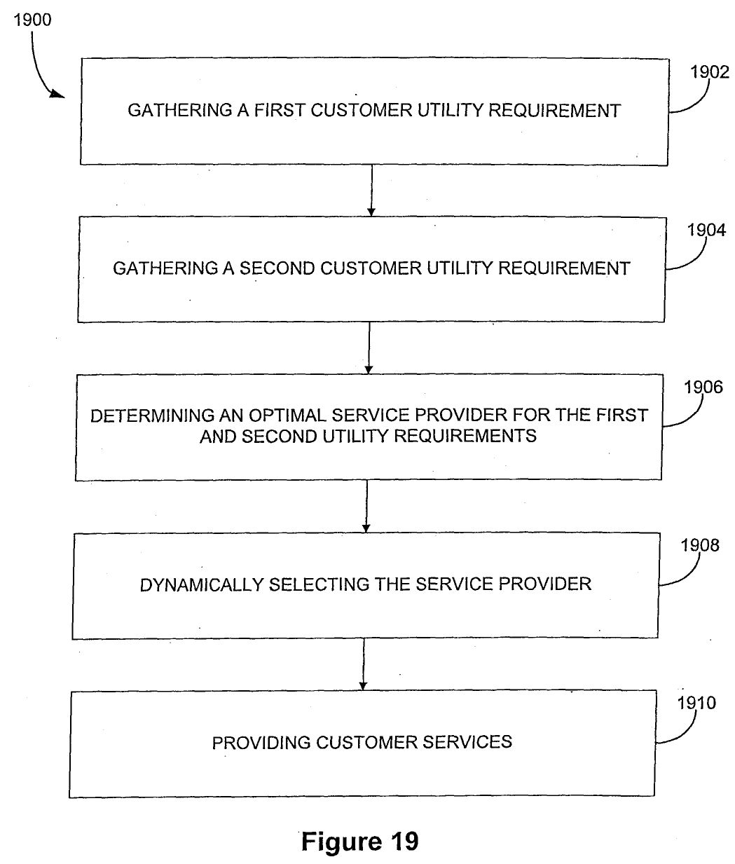

FIG. 19 is a flowchart depicting a process 1900 for managing utility use utilizing an internet protocol network. In operations 1902 and 1904, a first customer utility requirement and a second customer utility requirement are gathered. An optimal service provider for the first and second utility requirements is determined in operation 1906. The service provider is then dynamically selected in operation 1908 and customer service is provided in operation 1910.

In an aspect of the present invention, the customer services may include initiation of service. In another aspect of the present invention, the customer service may include servicing of a trouble call. In a further aspect of the present invention, the customer services may include providing characteristics of providers.

In yet another aspect of the present invention, the customer services may include the updating of customer services. In even a further aspect of the present invention, the customer services may include billing a customer for services.

In an illustrative process for selecting a utility provider in accordance with an embodiment of the present invention, a price schedule is received utilizing a wide area network. This price schedule includes a cost per unit of the utility from more than one utility provider. It should be noted that the price schedule may include both already-batched information as well as information received from each of the providers independently. The price schedule may also provide information in real time or can give a preset price schedule. The price schedule is analyzed for determining a utility provider charging the lowest price per unit of the utility. Based on this analysis, the utility provider charging the lowest price per unit of the utility or other user criteria such as preferred provider is selected. Then, use of the utility from the selected utility provider is enabled and an amount of use of the utility from the selected utility provider is determined.

In one aspect of the present invention, the price schedule may be received in real time utilizing the wide area network. In another aspect of the present invention, a customer may select the utility providers that are included in the price schedule. In a further aspect of the present invention, the utility may be one of electricity, gas, liquid fuel, and/or water.

In an embodiment of the present invention, a rate of consumption of the utility may be controlled by a device. In another embodiment of the present invention, a cost of the utility used may be calculated so that a payment may be transmitted electronically to the provider of the utility utilizing the wide area network.

FIG. 20 is a flowchart illustrating a process 2000 for monitoring and optimizing utility usage in an entity. In operation 2002, utility usage is collected for one or more utility resources in an entity. The utility usage for the entity is then aggregated in operation 2004. In operation 2006, utility utilization in the entity is monitored and utility usage of the one or more devices is selectively limited to optimize utility usage.

In an embodiment of the present invention, an internet protocol network may be queried to select an optimal utility provider for the entity. In such an embodiment, information from the entity may also be provided to a utility service provider. Optionally, control of devices may be provided from the internet protocol network.

In a further embodiment of the present invention, devices may be prioritized. In yet another embodiment of the present invention, interfacing to an entity security system may also be performed.

Intelligent energy consumption devices communicate power consumption and preferably are able to estimate future demand. This may be accomplished by various means such as allowing a user to input usage data. In the alternative, the forecasted demand may be derived from known operating procedures of the appliance.

For example, a dryer may be capable of providing information indicating that it is consuming 1 KW and that it will continue to consume 1 KW for 20 more minutes because that is how long it has left in the drying cycle. If the dryer has been programmed for a later start, it would communicate that at 10:00 it will be consuming 1 KW for 1 hour.

The more devices that have this capability, the more accurate the results will be and the less user intervention will be required to use it. If any of the appliances are not equipped with this ability, interface modules may be coupled between that the appliance and the associated outlet. Such modules are capable of tracking time usage. Based on this information and inputted or estimated rate information, power consumption may be calculated.

A variety of electromechanical and electronic devices have been described which automatically monitor and record the total elapsed operating time of mechanical or electrical equipment, thus eliminating the requirement to manually record start and stop times and calculate accumulated time of use.

A number of such devices measure and record the accumulated operating time of particular classes of industrial equipment, such as large electrical motors, as described in Johnson, et al, U.S. Pat. No. 1,475,831; trolley cars, as described in Arthur, U.S. Pat. No. 1,458,509; and automatic data processing equipment, as described in Mackay, et al, U.S. Pat. No. 3,221,489. Other devices, such as that described in Wilder, U.S. Pat. No. 464,540, and numerous variations thereof, have broader application, being capable of measuring and recording the accumulated operating time of virtually any electrically operated equipment or household appliance.

A number of devices have been proposed, especially to regulate the operating time of appliances, and more specifically, televisions. These devices limit the total available use time or restrict the specific hours of permissible use, or both. Noiles, U.S. Pat. No. 3,581,029 describes a TV On Time Control, based on a countdown timer which is set using a control contained within a lockable case. Once set, the timer deducts time from the set amount whenever the television is operating. Leone, U.S. Pat. No. 3,833,779 describes a Television Timer to Regulate Television Viewing Time, which includes a countdown timer similar to that described by Noiles, but which deducts time whether or not the television is operating. Pressman, U.S. Pat. No. 4,246,495 describes a Television Monitor and Control, a timer similar to that described by Noiles, but which also restricts television viewing to certain pre-selectable times of the day. Maclay, U.S. Pat. No. 4,588,901 describes a Timer Control for Television, a timer similar to that described by Leone, but which also displays the amount of remaining available operating time and which includes a key operated switch to disable the subtraction of time when the parents are watching alone. Each of these devices uses a case with lock and key to restrict access to the setting and resetting controls. Each device also includes a means of retaining the television's power cord within the locked case and a means to control the supply of electrical power to the television. When the respective viewing limits are exceeded, the power to the television is switched off by the device, thereby disabling the television until the controls are reset. The only information displayed by these devices is the remaining available operating time, which, in the case of the devices described by Pressman and Leone, is visible only when the case is unlocked. Another embodiment of the present invention may be used for controlling energy sources. In such an embodiment, a price schedule is received utilizing a wide area network. This price schedule includes a cost of a primary source of energy, such as electricity, and a cost of an alternative source of energy, such as gas. The cost of the primary source of energy is compared with the cost of an estimated equivalent amount of the alternative source of energy for determining which of the sources of energy has the lower cost. The source of energy determined to have the lowest cost is selected and use of the selected source of energy is then enabled.

In an embodiment of the present invention, an amount of use of the source of energy may also be determined. In an additional embodiment of the present invention, a cost of the source of energy used may be calculated and a payment electronically transmitted to the provider of the source of energy utilizing the wide area network.

In an aspect of the present invention, the price schedule may be received in real time utilizing the wide area network. In another aspect of the present invention, the price schedule may also include a cost of more than two primary and/or alternative sources of energy from different energy providers. In a further aspect of the present invention, the source of energy may includes one or more of electricity, gas, and/or liquid fuel.

With reference to the various systems and methodologies of the present invention, as described above and below, aspects of the present invention provide a comprehensive, multi-faceted, multi-user based resource accounting feature which, in a preferred implementation, provides a dynamic, real-time utility resource management tool. In accordance with these implementations, a utility resource tracking system is provided which is prepared to handle the increased complexities of utility resource billing, such as electric and gas billing, due to deregulation.

Significant cost savings are achieved through the identification of opportunities made possible by detailed utility resource tracking aspects which will become apparent below. Access to important pertinent resource consumption and pricing information is immediate and comprehensive, and permits an individual or company to access, among other things, utility resource costs and usage figures to assist in the decision making process. In other aspects of the invention which are discussed in much more detail below, one is given the opportunity to compare resource consumption among various multiple sites for purposes which include identifying sites having desirable and undesirable resource usage or cost characteristics.

In a preferred implementation, a central database is developed and contains information pertaining to different corporate and/or individual facilities. Information such as billing history for utility resource usage, structure information (such as square footage and structure characteristics), servicing utility resource provider and/or utility resource providers, and utility resource account information can be, and preferably is incorporated into the database. Other types of information can be incorporated, as will become apparent below.

Through the normal course of the database development process, a verification can be utilized to ensure that all sites are on the most advantageous utility resource rate. Accordingly, comprehensive utility resource tracking, analysis, and reporting is made possible through the various systems and methodologies of the invention. Billing information, such as cost and usage information can be entered into or received into a host system or computer and normalized daily. The information can be normalized furthermore for variances in degree-days and/or site-specific primary and secondary production units. Through monthly tracking and monitoring of utility resource cost and consumption, various facilities can be identified with high and/or abnormal energy or resource usage. Through timely detection of such usage anomalies, corrective action can be undertaken immediately, rather than months after the fact.

In accordance with one aspect of the invention, billing information which is received from each resource provider is scrutinized in accordance with a plurality of predefined or pre-determined tolerance parameters. Any information which does not meet with one or more of the tolerance parameters can be flagged for remedial processing. In accordance with a preferred aspect of the invention, scrutinization is performed by the host computer in accordance with a variety of algorithmic checks which are implemented in software. The tolerance parameters are preferably calculated through utilization of the billing information for each resource provider.

In accordance with one aspect of the invention, utility resource usage-based information is provided and can be accessed by a customer through an exclusive password-protected system. In this way, a flexible and paperless reporting environment meets the demands of real-time information needs of various customers. In other aspects, customers can remotely view utility resource usage data, via computer, in a number of different formats. For example, usage data can be viewed for individual facilities, all facilities, or in accordance with various defined reporting formats, e.g. BTUs/square feet, facility versus facility, facilities within a region, yearly, monthly or daily aggregate for a single or a group of facilities. Such various reporting formats are discussed in much more detail below. In other aspects of the invention, information can be downloaded from the host system, via a computer link established with a remote computer at a customer location. Such permits a customer to conduct their own analysis at their own location. In a preferred implementation, the download function is accessed through a drop down menu which permits selection of a time period, service codes, and locations. Once a request for downloading information is complete, a file is sent containing the bill date, bill identifier, site identifier, service code, consumption amount and unit of measurement, dollar amount, tax, and various miscellaneous charges. The information can be, and preferably is in a so-called fixed column flat file format.

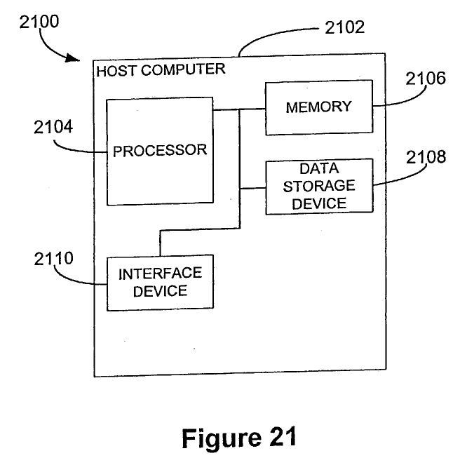

Although a variety of different computer systems can be used with the present invention, such as the system set forth above with reference to FIG. 1, for simplicity an exemplary computer system is shown generally at 2100 in FIG. 21.

Computer System Overview

Computer system 2100 includes a host computer 2102 having a processor 2104, memory 2106, data storage device 2108, and an interface device 2110. The exemplary components 2104-2110 of host computer 2102 are operably connected via an address/data bus which is not specifically designated. Memory 2106 can, and preferably does include a volatile memory (e.g. random access memory) which is coupled with the data bus for storing information and instructions for processor 2104, and a non-volatile memory (e.g. read only memory) coupled with the data bus for storing static information and instructions for processor 2104. Data storage device 2108 can comprise a mass storage device. Host computer 2102 constitutes a hardware platform which executes instructions to implement the application program(s) described just below. It will be understood that system 2100, as set forth in FIG. 21, is a schematic representation only. Accordingly, the system as described above and below can be implemented as an integral stand alone system as suggested by FIG. 21, or can include separate component parts which are interconnected and operable for implementing the invention described below.

Interface device 2110 preferably comprises a multi-user network interface (e.g. an Internet interface) which couples computer system 2100 to a multi-user system (e.g. the Internet in one embodiment of the present invention). Interface 2110 is coupled to permit communication with various application programs contained on the hardware platform defined by computer system 2100.

As mentioned above, and in a preferred implementation of the present invention, interface device 2110 comprises an Internet interface. The Internet is a well known connection of world wide computer systems that operate using a well known Internet protocol. The Internet is one type of multi-user computer system. Other Internet applications (e.g. using specific protocols) operate on top of the Internet protocol. One such application is the well known world wide web or “www” Internet application which operates using the hypertext transfer protocol or http. The “www” Internet application is a “demand system” in which a user requests information from a site and the site transfers the information back to the user on-line. Also well known is the email Internet application which operates using the simple mail transport protocol or smtp. The email Internet application is a “present system” in that an information transfer command originates from a sender site and information pursuant to that command is presented to the target email address. Another Internet application is the file transfer Internet application which operates using the file transfer protocol ftp. In one embodiment, the present invention utilizes the www, email, and file transfer Internet applications as well as the Internet protocol. Other embodiments of the present invention can be implemented in other multi-user computer environments. For example, the present invention could be implemented with a dedicated multi-user system.

Computer system 2100 supports a software configuration which operates under control of a conventional operating system. The operating system permits various application processes to be executed. These include, for example, a communications application which permits data transfer with various remote terminals as will become apparent below. The software environment further includes a data management, storage, and retrieval application that is utilized in connection with data storage device 2108. The data management, storage, and retrieval application organizes and stores information which will be described in greater detail below. This information is organized and stored within the environment of the operating system on one or more mass storage devices such as data storage device 2108. Other applications conventionally known may be included in the software environment comprising computer system 2100.

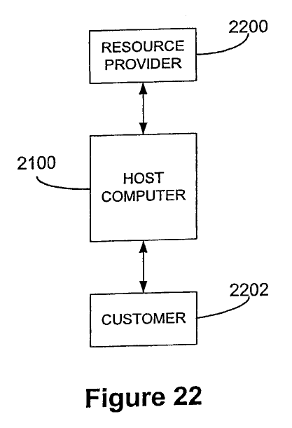

In view of the foregoing computer system description and in accordance with one aspect of the invention, the reader is referred to FIG. 22. There, an exemplary computer system or host system 2100 can be seen to comprise part of a system which includes a resource provider 2200 and a customer 2202. In the context of this document, the term “resource provider” will be understood to include a company or other source from which resources in the form of goods, services and/or commodities originate. In a preferred implementation, such resource provider can comprise one or more utility resource providers, e.g. providers of electricity, water, sewage services, natural gas, propane, alternate energy sources and/or other related goods or services or processes. Similarly, the term “customer” as used in this document will be understood to include an individual, company, companies or sites which consume resources from one or more resource providers. In a preferred implementation, such customers consume one or more utility resources for which it is desired to account.

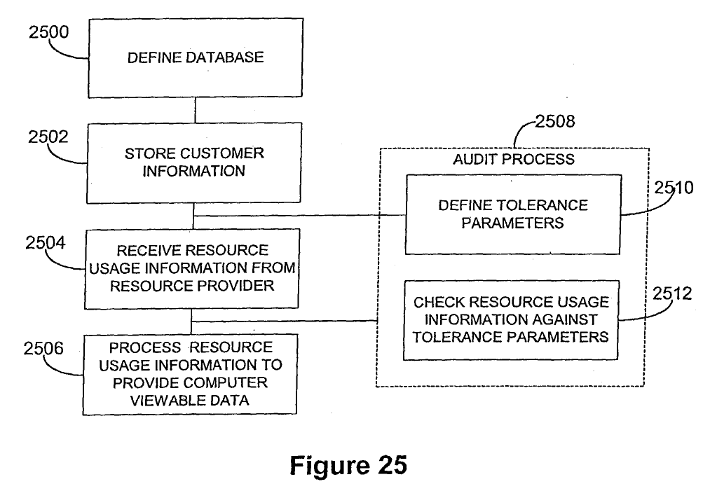

Referring to FIGS. 21, 22, and 25, FIG. 25 presents a high level flow diagram which is or can be implemented with a software program executable on computer system 2100 of the present invention. Such program would typically be stored in memory 2106. A database is first defined at step 2500 (FIG. 25) in host computer 2102. Such database is preferably defined within a data storage device, such as data storage device 2108 (FIG. 21). Information associated with at least one customer, such as customer 2202, is entered and stored at step 2502 in the database. The information can include any type of information which is useful in implementing the present invention. Exemplary information includes the customer's name (whether an individual or a company), mailing address, business phone number, primary accounts payable point of contact, email address, general ledger account number, banking information, and/or site listing. Additionally, information such as site name, site number, site address, square footage, year built, site open date, and billing histories can be stored in the database as well. Exemplary billing history information can include such things as billing date, past due date, billing period begin and end dates, types of service, consumption, commodity charges, tax, and various other information as well.

At step 2504 (FIG. 25) resource usage information from resource provider 2200 is received into host computer 2102. The resource usage information pertains to consumption of at least one resource by the customer. The resource usage information can be introduced into system 2100 in any suitable way. In one embodiment, such information from resource provider 2200 is received electronically, via a suitable data link with host computer 2100, using one or more of the Internet protocols mentioned above. Alternately, resource usage information can be received in hard-copy form and entered into the host computer as by manual data entry. Other methods and systems can, of course, be utilized to permit such information to be received by host computer 2100.

In a preferred implementation, the resource usage information which is received into the host computer pertains to a plurality of different consumption variables of the resource by the consumer. For example, one such consumption variable can be a cost-related consumption variable associated with the cost of a particular resource consumed by a consumer. Another consumption variable is a quantity-related consumption variable which is related to a quantity of a particular resource consumed by a consumer.

Tolerance Parameter Checking

In one aspect of the invention, an audit process is provided at step 2508 (FIG. 25). The audit process is preferably implemented in a suitable software application which is resident upon the hardware platform defined by host computer 2102. Audit process 2508 includes a definition step, at step 2510, wherein at least one, and preferably more pre-determined tolerance parameters are defined. At step 2512, the resource usage information which is received from resource provider 2200 is checked against the pre-determined tolerance parameter(s) for determining whether the information satisfies such parameter(s). If the resource usage information does not satisfy the pre-determined tolerance parameter, then, in accordance with one aspect of the invention, the information from the resource provider is flagged for remedial processing, either manually or electronically, which includes error checking the information.

In one implementation, the pre-determined tolerance parameters are defined through the utilization of historical billing data for customer 2202. In particular, when the above-mentioned information regarding the customer is stored, at step 2502, historical billing data can be entered and cataloged into the database at that time. Additionally, the historical billing data can include currently up-to-date billing information from a previous billing cycle. Processor 2104 (FIG. 21) preferably processes the historical billing data and defines the tolerance parameters.

Two exemplary categories of tolerance parameters are: (1) overall bill tolerance check parameters; and (2) individual line item tolerance check parameters. Of course, other tolerance parameters are possible. Examples of overall bill tolerance check parameters include: (a) current charges cannot exceed one and one half times the average bill; (b) bills cannot overlap with any other system bill with respect to begin and end dates; (c) the bill cannot be duplicated within the system; and, (d) all required information must be present on the entered bill. Examples of individual line item tolerance check parameters include: (a) the number of days of service must fall within 20% either way of the account average; (b) service start date must be the day following the prior period bill end date; (c) service end date must be one day prior to next period begin date; (d) service consumption and dollars must move in the same general direction, e.g. an increase in one should be accompanied by an increase in the other; (e) consumption must fall within a 20% difference of prior or next period consumption; and (f) charges must fall within a 20% difference of prior or next period charges. A bill or billing information failing any of the above parameters is flagged and identified for subsequent remedial processing. As history of a particular customer is accumulated, tolerances can be redefined based upon the actual variances that exist between months and/or billing periods. Accordingly, the pre-defined tolerance parameters are adjustable by the system for each customer. In preferred implementations, and ones which are discussed below, the resource or resources comprise utility resources. Accordingly, the tolerance parameters which are calculated and used to scrutinize the resource usage information can be specifically tailored to such resources. For example, tolerance parameters can be calculated to ensure that each utility bill is arithmetically accurate. Additionally, the resource usage information can be used to effect a comparison between a utility tariff rate to determine whether the bill was priced properly.

Remote Access

At step 2506, the resource usage information, which may or may not have been audit processed as described above, is processed by the host computer to provide usage-based, computer-viewable data associated with a particular customer's consumption of the resource.

Customer 2202 can be subsequently provided with remote electronic access to the viewable data preferably through the interface device 2110 (FIG. 21). Remote access is preferably provided through a remote computer, which is linkable with host computer 2102 through a protocol, such as one suitable for use within an Internet-based system. In particular, and in connection with a preferred implementation, host computer 2102 provides or otherwise defines an Internet website. The various usage information received and processed by host computer 2102 from resource provider 2200 is provided on the Internet site and can be remotely accessed by the customer. Preferably, access to information contained on host computer 2102 is password-protected such that only the intended customer can access its relevant information. In this way, centralized, computer-accessible, resource accounting methods and systems are provided which are “proactive” in the sense that the customer can, on its own time and terms, access its relevant usage-based information. Further, an audit process is provided to scrutinize the resource usage information to ensure that the information utilized to generate the computer-viewable data is within acceptable tolerances levels.

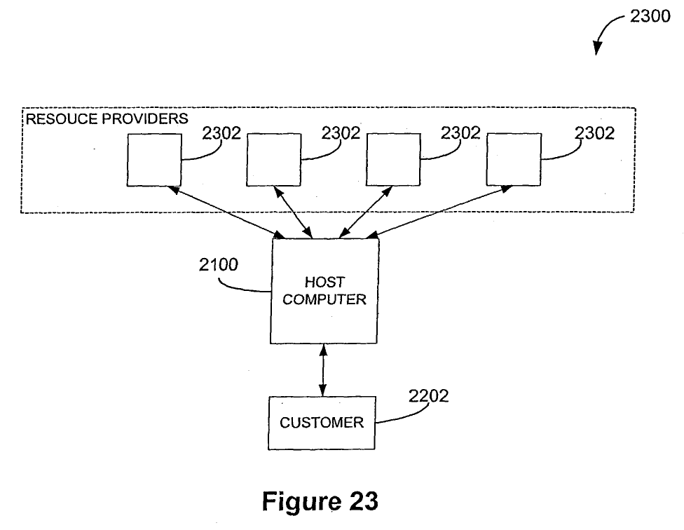

Referring to FIG. 23, an implementation in accordance with another aspect of the invention is set forth generally at 2300. In this implementation, a plurality of resource providers 2302, 2304, 2306, and 2308 provide resource usage information to host computer 2100 such that the host computer can process the information as described immediately above. The resource providers need not be related to one another and can comprise separate companies. Alternately, the resource usage information provided by resource providers 2302-2308 can originate from one resource provider and can constitute a plurality of different resources, e.g. electric power, water, natural gas, sewer services, and the like. Such would be the case, for example, if one resource provider were to provide all of the pertinent resources which are utilized by a particular consumer. Of course, the above-described tolerance parameters which are effectuated through the audit processor function can be, and preferably are implemented for the resource usage information which is received from each of the resource providers.

Through a remote computer terminal, customer 2202 can access host computer 2100 and receive the processed usage-based information in the form of a plurality of different graphical reports which are selectable by a customer and described below in greater detail. Preferably, such access is provided through interface device 2110 (FIG. 21) as discussed above.

Again, centralized, computer-accessible, interactive resource management methods and systems are provided which are “proactive” in the sense that the customer can, on its own time and terms, access its relevant resource usage information. Further, a system is provided which can receive resource usage input from a number of different resource providers. Further still, a system is provided which can tolerance check the resource usage information received from each of the resource providers to ensure accurate reporting thereof to the customer. Accordingly, very streamlined, efficient, and accurate resource management and accounting systems and processes are provided by the various implementations of the invention.

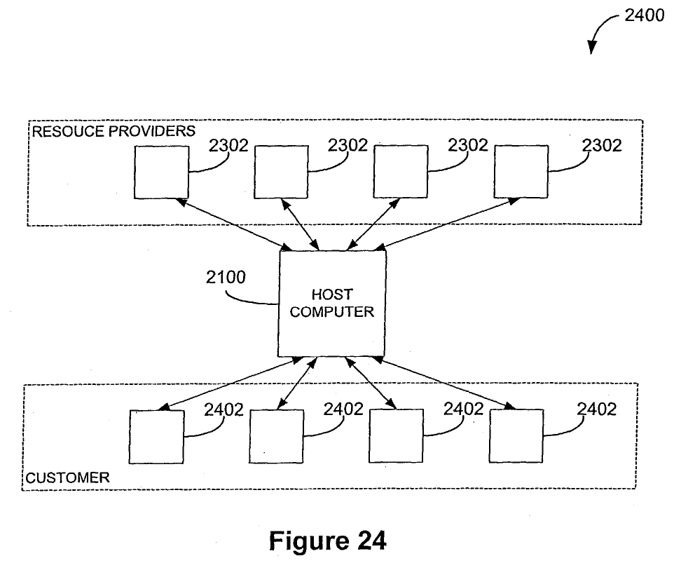

Referring to FIG. 24, another implementation in accordance with the invention is set forth generally at 2400. There, it can be seen that a plurality of resource providers 2302-2308 have access to, or are otherwise capable of providing resource usage information to computer system 2100. A plurality of customers 2402, 2404, 2406, and 2408 preferably have remote electronic access to computer system 2100 in much the way as was described above. It is to be understood that although only four resource providers and four customers are utilized in the illustration, many more of both are contemplated.

In this example, a database within host system 2100 receives and stores information associated with each of customers 2402-2408. Resource usage information is received into host computer 2100 from resource providers 2302-2308. Such information, for each of both the resource providers and the customers, is preferably tolerance checked as described above, to ensure the accuracy of such information. Such information is further preferably processed into computer-viewable, usage-based data associated with each customer's consumption of the resource. In a preferred embodiment, the resource comprises a utility resource. Preferably a plurality of different utility resources are managed and tracked by the inventive systems and methodologies. Such processed information is preferably made available, through remote computer terminal access, to each of the customers.

Again, computer-accessible, interactive resource management methods and systems are provided which are “proactive” in the sense that the consumer can, on its own time and terms, access its relevant resource usage information. Further, a system is provided which receives resource usage information from a number of different resource providers, checks the resource usage information against one or more tolerance parameters, processes such information and makes it available to the customers via electronic link. In this implementation a plurality of different customers are incorporated into the system of the present invention. Accordingly, very streamlined, accurate, and efficient systems and processes are provided by the various implementations of the invention.

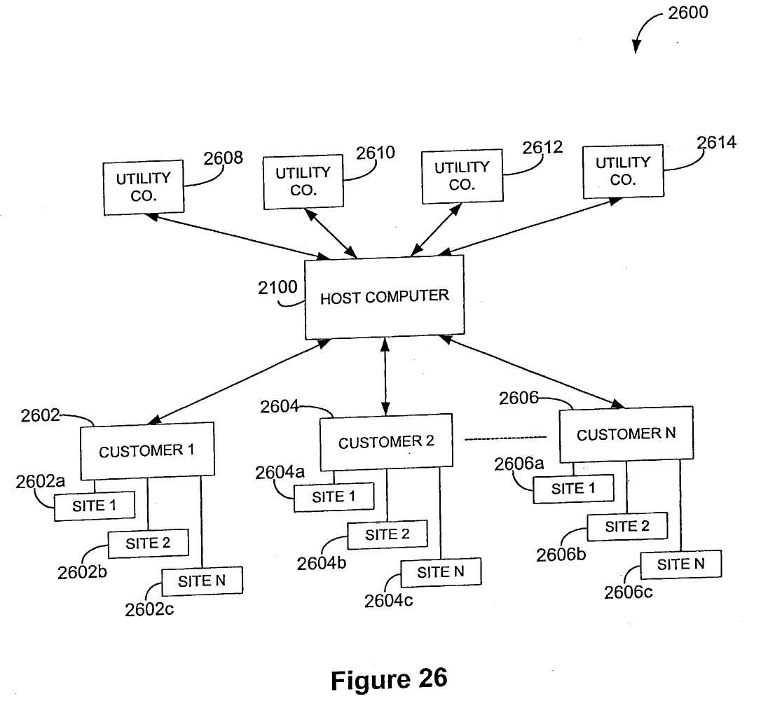

Referring to FIG. 26, a preferred implementation of the invention is set forth generally at 2600. Similar to the above implementation, a computer system 2100 is provided and includes a host computer 2102 as described above. Information for a plurality of customers 2602, 2604, and 2606 is stored in a database as described above. Each customer can, but need not, comprise a plurality of different sites which may or may not be geographically separated. The customers are customers and consumers of utility resources provided by a plurality of different utility resource providers 2608, 2610, 2612, and 2614. Each customer may, however, be a customer of only one utility resource provider. Alternately, each customer may be a customer of more than one utility resource provider. Where a customer has many different geographically-separated sites, utility resources such as electricity, water, gas, and/or other related utility resource services could conceivably be provided by a large number of utility resource companies or providers. Utility resource usage information is received from each utility resource company into host computer 2102 as described above in connection with step 2504 (FIG. 25). The usage information pertains to consumption of utility resources by each site of each customer and includes, as mentioned above, cost-related and quantity-related consumption variables. Such information is preferably tolerance checked in accordance with the above-described audit processor to ensure the accuracy thereof. Preferably, tolerance checking is performed for each of the utility resource providers for each of their relevant customers. Such information is preferably subsequently processed as described and customers 2602-2606 are provided with remote electronic access to computer-viewable data in host computer 2100 through interface device 2110 (FIG. 21) as described above. Such computer-viewable data is preferably in the form of a plurality of different graphical reports which can be selected by the customer for viewing on a computer which is remote from the host computer.

The inventive methodologies and systems described just above are particularly useful in the context of utility resource customers having a number of different, geographically-separated sites (such as nationwide) which are serviced by a plurality of different utility resource providers.

For example, and with reference to FIG. 26, customer 2602 includes sites 2602a, 2602b, and 2602c. Although only three exemplary sites are used, it will be understood that such sites can comprise any number of different sites which may or may not be geographically-separated. Similarly, customer 2604 includes site 2604a, 2604b, and 2604c. Likewise, customer 2606 includes site 2606a, 2606b, and 2606c. For purposes of example only, assume that each geographically-separated site of any of the customers is serviced by a different utility resource provider or company. Each utility resource provider is able to, through the inventive methodologies and systems, provide usage information for each specific geographically-separated site to computer system 2100. Such information is received and processed and provided so that each customer, e.g. customers 2602, 2604, 2606, can access and view graphical reports, including numerical and tabulated reports, for each of its sites. In this embodiment, as was briefly mentioned above, the tolerance parameters can be, and preferably are defined to be utility-specific. This gives the customer access to processed, computer-viewable data which includes a desired degree of utility pricing expertise. Such expertise is comprehensive and vast insofar as a large number of utility resource providers are incorporated into the system for an even larger number of customers. Through the preferred tolerance parameter checking, errors or anomalies can be easily detected for correction. In the context of utility providers, customers whose utility usage information is determined to fail one or more of the tolerance parameters can receive an adjustment from the servicing utility, or alternately, can be placed on a correct rate schedule. Alternatively, and in the event there is no error in the usage information, the customer can be advised to modify utility consumption to qualify for a more favorable price, or, may be advised to seek an alternate supplier whose pricing may be more favorable for the customer's existing consumption pattern.

As was initially discussed above, the systems and methodologies of the present invention are preferably implemented in connection with a multi-user computer environment. A preferred computer environment is the Internet.

Report Overview

In the explanation which follows, certain aspects of the invention are described in the context of fictional company called “ACIS Suites” which maintains a plurality of different, geographically-separated lodging units. It is to be understood, however, that inventive systems and methodologies have application in a wide range of industries, and that the present example is for illustrative purposes only.

A site setup screen may be displayed which enables a customer to enter information into the host computer. In a case where a customer has a plurality of different sites for which accounting for one or more resources is desired, specific information regarding each of a customer's sites can be ascertained through this screen. For example, a plurality of fields can be provided for entry of information, such as a production units field, a climate zone field, and a secondary units field. The production units field can be utilized by a customer to enter information pertaining to the number of units maintained, the variable monthly production units, and the date the site was opened. A production unit can be considered as a fixed daily unit of measurement such as, and in this example, available rooms for a lodging company facility site. The climate zone is used for benchmarking a facility's energy use against a national average adjusted for weather. In the climate zone field, a customer can designate a specific climate zone in which a site is located for purposes of comparison to other similarly-located sites. A state map based on the site address entered into the system can appear and a customer can click on the county and/or state in which the site resides. Climate zone assignment information enables reports to be generated which are discussed in more detail below. Climatic conditions for locations have been placed into five categories (i.e. zones 1-5) based upon the number of annual heating degree days and cooling degree days historically occurring in a given location. Such constitutes but one way of grouping sites in accordance with a predefined grouping variable. In this example, the predefined grouping variable is climate zone.

Resource Accounting

A Resource Accounting screen may be provided and enables a plurality of selectable graphical reports to be selected by a customer. The reports which are selectable by each customer provide computer-viewable data which can be viewed, in a referred implementation, via a remote computer terminal as described above. A report field is provided and permits a customer to choose between a report type (described in more detail below) and/or an area on which to report. Once a particular report and area are selected via a report field, the report can be specifically tailored depending on the needs of the customer. For example, a field can be provided in which a user can exclude sites based upon user-selected criteria or which were not open for a particular reporting period, select from among a number of different resources, i.e., electricity, gas, water, sewer services, and the like, and specify a date range through which such computer-viewable data can be viewed. A select site field is provided and permits a site-to-site comparison to be made between two different sites of the customer. Examples of this are given below in more detail. A customer can opt to select a report to view a total company area average, a single site, or a site-to-site comparison. Once pertinent parameters have been set for a report, a user need simply only click on a “Display” feature to see a display of the relevant computer-viewable data.

A plurality of different reports can be shown in drop-down menu fashion, and include Resource Cost, Resource Use, Energy Cost Index, Energy Use Index, EUI/ECI Analysis, EUI Frequency Overview, 24-Month Trend, and Production Report. By using the drop down menu feature, a user can select from a variety of different reports which are generated based upon the resource usage information which was previously received into the host system. It is to be understood that the reports and formats thereof described below are for illustrative purposes only. Accordingly, other reports and formats could be utilized.

Load Profiling or Real Time Meter Reading

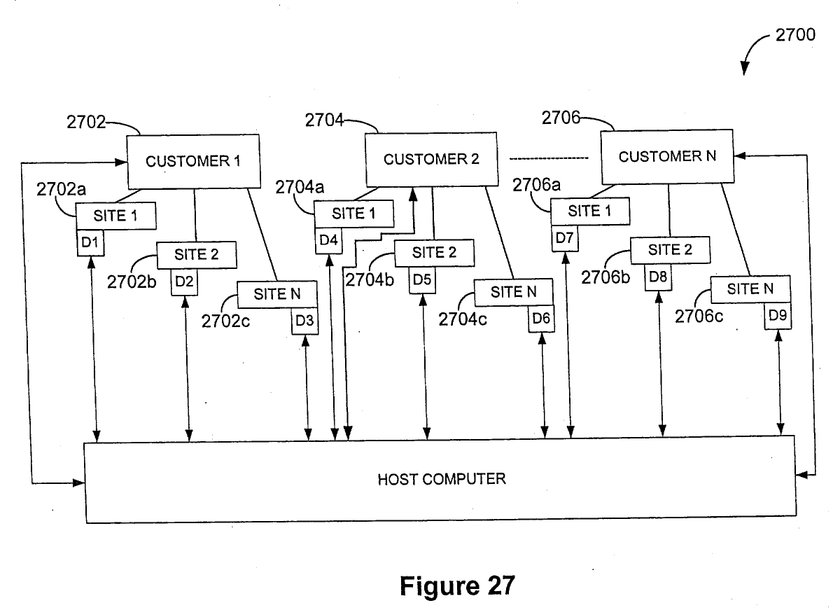

Referring to FIG. 27, a block diagram illustrating a utility-resource-consumption-based tracking system is set forth generally at 2700. In accordance with a preferred implementation, a plurality of customers 2702, 2704 and 2706 have a plurality of respective sites 2702a, 2702b, 2702N, 2704a, 2704b, 2704N, and 2706a, 2706b, 2706N. Each site comprises a facility site which is a consumer of a utility resource for which it is desired to track and account. Each site will typically have a metering device which measures the amount or quantity of a particular resource being consumed by that site. Accordingly, each metering device measures utility resource usage information for its particular site. Exemplary quantities include kilowatts, kilovars or therms to name a few. Typical metering devices commonly convert measured values into pulses. For example, an electric meter for measuring electrical power consumption may be fitted with a device to produce a contact closure or pulse for every kilowatt of electricity used. Data logging devices, such as devices D.sub. 1-D.sub.9, can be coupled with or integrated with each facility metering device and record the pulses or contacts and store them in a memory location. An exemplary data logging device is a GE Type DR87 or Schlumberger DS101. An exemplary metering device having an integrated recorder is a Vectron, manufactured by Schlumberger. Pulses can be collected in intervals of 5, 15, 30 or 60 minutes. Other intervals can be used. Accordingly, data which is associated with utility usage information measured by the metering device(s) is stored. A host computer 2100, such as the one described above, is provided and is preferably linkable, via electronic link, with each data logging device. Data which is stored in the data logging devices is preferably retrieved into the host computer where it is subsequently processed for each facility site. The processing of the retrieved data provides usage-based, computer-viewable data associated with each facility site's usage of a particular utility resource. The retrieval process can be effectuated in any number of ways which are suitable for providing the host computer with the data necessary for its processing. For example, software retrieval programs can interrogate the data logging devices. An exemplary retrieval program is the MV90 which is available through a company called Utility Translation Systems, Inc., located in Raleigh, N.C. Data included in the retrieval process can include the time, interval value, channel identifier, and the number of intervals per hour. A comma delimited flat file can be used to transfer data. Alternately, third party computers or processors can comprise part of the host computer's data link with the data logging devices such that the third party computers or processors can collect or retrieve data and then pass it along to the host computer. For example, one computer or processor might collect data from devices D.sub.1-D.sub.4, while another might collect data from devices D.sub.5-D.sub.9. Subsequently, the data collected by each such third party computer or processor could be passed to the host computer for subsequent processing.

In one aspect of the invention, data which is utilized in the implementation of the load profiling aspect of the present invention is collected from third party data logging devices utilizing third party software retrieval programs. An advantage of this aspect is that data from different third party devices can be collected and processed for display to the customer in a standard, unified format. In some instances, collected data can be output to a flat file and subsequently transferred electronically, as by use of the Internet, to the host system for processing as described above and below.

Computer access to the usage-based, computer-viewable data can be provided to each customer through interface device 2110 (FIG. 21) substantially as described above. Thus, a customer can access and view such data from a computer location which is remote from the host computer. Any of the above-described reports can be utilized. For example, a customer can view a graphical report which describes an individual site, a site-to-site comparison, and/or a data range description. Other formats can, of course, be utilized.

A report may show a so-called load profile for each day during the week. Individual load profiles for each day give an indication of energy consumption throughout the day.

A report may show a load profile for a week. The report can indicate whether “Aggregation” has been selected. “Aggregation” allows load profiles for a particular time period to be added together. Such is discussed in more detail below. Additionally, this report screen enables a customer to display data for one or more sites, with the latter options being displayed in a site-to-site comparison, if desired. If a customer desires a more detailed view of the data, the customer can click on the graph and display data on a daily basis.

The above reports assist the customer in identifying the time, e.g. hours of the day, throughout the relevant time period during which resource consumption takes place, and the amount thereof. Customers can, for example, utilize the above reports to confirm operation of HVAC systems, outdoor lighting controls, after-hour lighting consumption associated with janitorial services, and the like. The sensitivity of the system is advantageous because small load usages can be detected and, if necessary, be formatted into a suitable report for customer viewing in close to, if not real time. Load profile reports, such as the ones enabled by the present invention, are extremely useful for identifying and enabling the reduction of, or, the shifting of peak demand, as well as reducing consumption (i.e. giving an indication that consumption needs to be reduced thereby effectuating remedial customer measures). The timeliness of the provision of the computer-viewable data to the customer greatly assists the customer in making time-saving load profile evaluations for not only one, but for each customer site which is incorporated into the system.

Report Download

A customer at its remote location may be enabled to download, in an ASCI fixed column flat file for example, any of the above described reports. By enabling a customer to download such information, an analysis can be effectuated by the customer at its own location and during its own allotted time. Other schemes of providing information contained in any of the reports can, of course, be utilized.

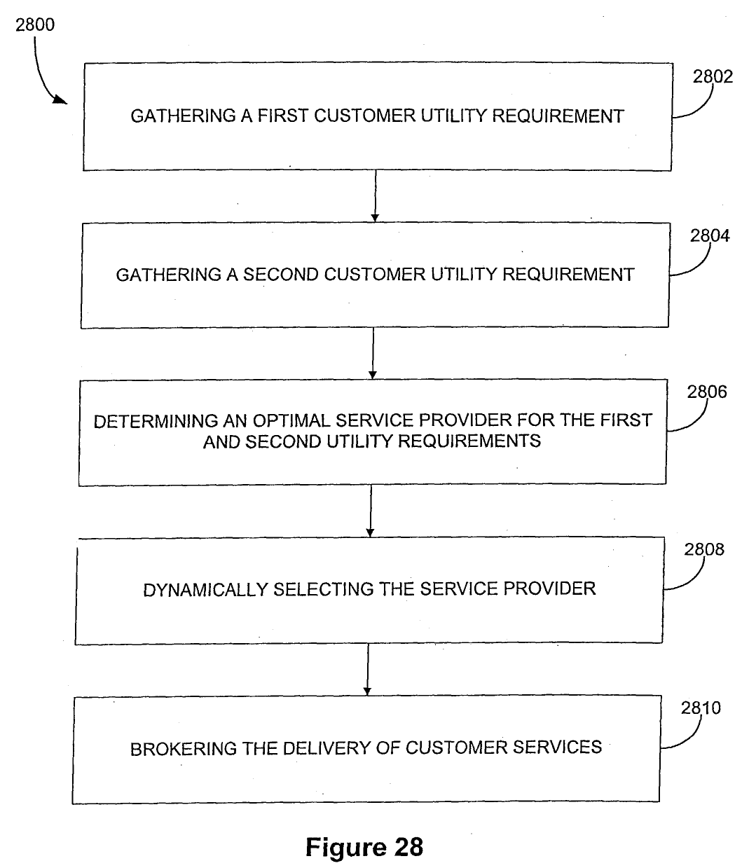

FIG. 28 is a flowchart depicting a process 2800 for managing utility use utilizing an internet protocol network. In operation 2802 and 2804, first and second customer utility requirements are gathered. A determination is made in operation 2806 to determine an optimal service provider for the first and second utility requirements. The service provider is then dynamically selected in operation 2808 and the delivery of customer services is brokered in operation 2810.

In an aspect of the present invention, the customer services may include the initiation of service or the servicing of a trouble call. In another aspect of the present invention, the customer services may include the providing of characteristics of providers.

In a further aspect of the present invention, the customer service may include the updating of customer services. In yet another aspect of the present invention, the customer services may include billing a customer for services.

One embodiment of the present invention provides a utility market. Pricing information for a utility is received from each of a plurality of utility providers. The pricing information is then transmitted to a customer over a wide area network. It should be noted that customer here and throughout this document could include not only the human or company purchasing the utility but can also encompass a computer operating on behalf of the human or company. Usage information from the customer is received. The usage information identifies the utility provider that provided the utility and a time and quantity of use of the utility. Time here can mean both traditional time, i.e., hour and minute, and/or the date of use. A cost of the utility used is calculated based on the usage information and the pricing information. A request for payment to the customer for the calculated cost of the utility is then transmitted utilizing the wide area network. Other operations could include receiving an order for a quantity of the utility from the customer and receiving bids for quantities of the utility.

In an aspect of the present invention, the pricing information may be received from the utility providers and transmitted to the customer in real time so that the customer (or the customer's computer) can instantly switch between providers to obtain the lowest rate or other desireable criteria. In another aspect of the present invention, the usage information may be received from a usage monitoring device that measures or estimates utility use, such as a meter.

In an embodiment of the present invention, a payment may also be received from the customer utilizing the wide area network. In an additional aspect of the present invention, the customer may purchase a predetermined amount of the utility. Also, the utility may be one of electricity, gas, liquid fuel, and/or water.

The first to a market can create opportunity. Others can follow quickly and look the same causing intense competition. In a sense you cannibalize your own business (there are many examples, the most obvious being stock trading). Rapid turnover of ideas is required for sustained margins. But you also cannot just wait to be cannibalized. Are there areas where you can move faster than your competition?

Establish alternative energy source alliance with exclusive territories. This will allow ownership of the future product marketplace.

Expansion of service territory (and use of the current brand in that territory) through merger/acquisition could expand the future potential of the above point.

View the power generation business with a critical short-term (15-20 year) view. This is a short-term view because the useful life of new construction may be much longer. But in this period, there is money to be made by the most efficient producers.

Consider gas company alliances, mergers, and acquisitions, as gas will likely be the fuel of choice for early alternative energy solutions.

In an exemplary embodiment of the present invention, a system accumulates data in real time from the control areas by having the different transmission owners, energy providers and energy buyers within the electrical interconnections be connected via a computer network. The transmission owners are connected through the network to a data review board that ensures that any information about the transmission owner's facilities is accurate and uniform. The information that is sent to the data base by the transmission owners includes energy transportation network data, such as the physical and electrical characteristics of the transmission owner's facilities including, but not limited to, the voltage, rating, impedance and length of each and every segment of the transmission lines. Upon the review by the data review board, the information from the transmission owners is combined and sent to a processor for storage in a data base. The transmission owners, energy providers and energy buyers (collectively hereinafter referred to as “energy system users”) are connected to the processor through the computer network for accessing the information stored in the data base. The energy system users each have a computer terminal that is also connected via the computer network to an Administrator, who acts as an agent for the energy system users.

The energy system users through the use of their computer terminals can simultaneously review the stored data and make informed decisions about the availability and cost for the use of the energy transportation network. The Administrator has a computer terminal to maintain a current storing and recording of the incremental data in the data base, as well as for communicating with the energy system users through the computer network.

The system of the present invention thus provides the energy system users with the ability to use the computer network to negotiate on a timely basis for the efficient and reliable movement of energy between the parties, which is hereinafter referred to as the “incremental market.” The transmission owners, providers and buyers can each be or become a user of energy or of the energy transportation network. Upon the completion of a negotiation for the movement of energy, the respective user sends a confirmation of the negotiated movement of energy to the Administrator via the network. The Administrator upon receipt of such confirmation, updates the data base with the proposed transaction, thereby ensuring that the data base maintains an accurate representation of the energy transportation system. Simultaneously, the Administrator sends the information about the proposed transaction to a temporary memory connected to the processor for future billings and payments for the movement of energy. The temporary memory accumulates the transactions that occur over a period of time and allows the Administrator to send composite invoices for the total costs of energy transactions which occurred during such period of time.

The Administrator would provide software to the energy system users that would be necessary to process the data base maintained by the processor to determine the availability and allocation of transportation needed for the movement of energy (referred to as “system allocation”). By identifying the facilities actually used, the transmission owners could be compensated for—and users can be charged for—only the facilities that are actually used to move the energy.

The data gathering operation of the present invention is carried out by a processor. The processor has a temporary memory, which provides the processor with the means of storing real time facility on-site data and energy requests and transmitting this information to the data base for purposes of updating the data base.

In accordance with the present invention, an energy system user analyses on its terminal a desired transaction for the movement of energy, such as the transmission of a requested amount of electrical power. If the required facilities are available and the price is acceptable to the user he notifies the Administrator. The user's request is received by the processor. The processor temporarily stores the proposed transaction in the temporary memory and prompts the user to send any additional information concerning its use of the energy transportation network to the Administrator, if not already stored in the temporary memory. The processor upon receipt of the prompted information processes the information and identifies the user, the user's respective facilities and the available transportation means for the transfer of energy. The user's information and the processed data is transmitted to the data base for updating the data base. The Administrator can then communicate with the user using the stored data that can be displayed on the Administrator's computer terminal.

If there is no capacity available for a desired transaction the potential user may request bids from those able to free up the needed capacity. The Administrator may assist in this task by supplying to the potential user a list of transactions that may satisfy the requested requirement. The potential user could seek bids via the computer network from other users who may be able to free up capacity on the constrained energy transportation network. The supplying user could then charge the potential user with the opportunity cost for having to give up or forego a current use or a previous commitment to use the energy system. The opportunity cost, if accepted, would be in addition to the transportation cost.

The following paragraphs and associated drawings provide more detail of the illustrative embodiment set forth immediately above.

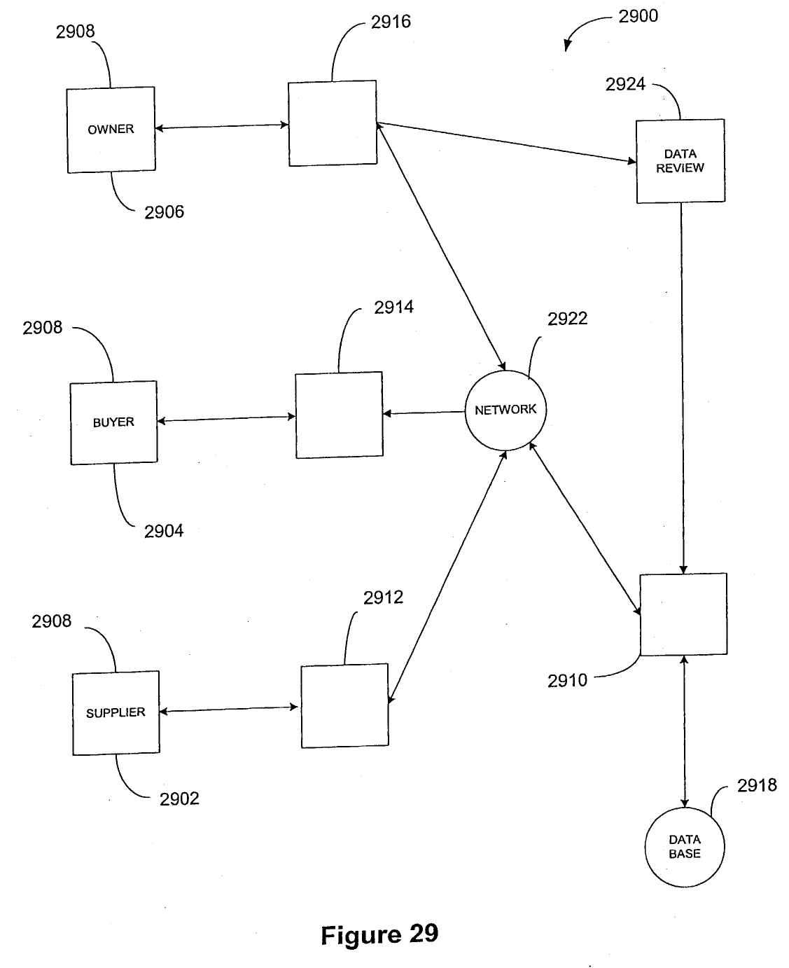

With reference now to FIG. 29 of the drawings, there is illustrated an exemplary system in which the invention may be advantageously practiced. Shown is an energy information and transportation allocation system 2900 that provides for a communication link to an energy provider 2902, a buyer of energy 2904 and a transmission line owner 2906 (each also being referred to as an “energy system user 2908”). The system 2900 allows for energy transportation allocation based on peak conditions for an energy transportation network. The system 2900 includes a processor 2910 that communicates with PC computers 2912, 2914 and 2916 through a network 2922. The PC computers 2912, 2914 and 2916 communicate with their respective energy system user 2908 for receiving and transmitting data and information to the processor 2910 for storing the data and information in a data base 2918, which is connected to the processor 2910. The data and information sent to the processor 2910 includes the electrical and physical characteristics of the energy transportation network and the physical line data 2920 from the transmission line owner 2906. The amount of available electrical power, as well as any requests for purchasing power is also sent to the processor 2910 via the network 2922.

The transmission line owner 2906 sends the physical line data 2920 to the processor 2910 via the PC computer 2916 to a data review board 2924 and ultimately to the processor 2910. The third party review by the data review board 2924 ensures that reliable and accurate transportation information 2920 is being sent to the processor 2910 for storage in the data base 2918. The data base 2918 accumulates the information received in order to provide the energy system users 2908 with accurate and complete information about the energy transportation network.

The energy system users 2908 can simultaneously through the network 2922 communicate with each other and have access to the information stored in the data base 2918 for review thereof. Additionally the energy system users 2908 can use this accessed information for making informed decisions about the use of the energy transportation network during peak conditions. The peak conditions describe the use of the energy transportation network during conditions of maximum loading or transmission of energy.

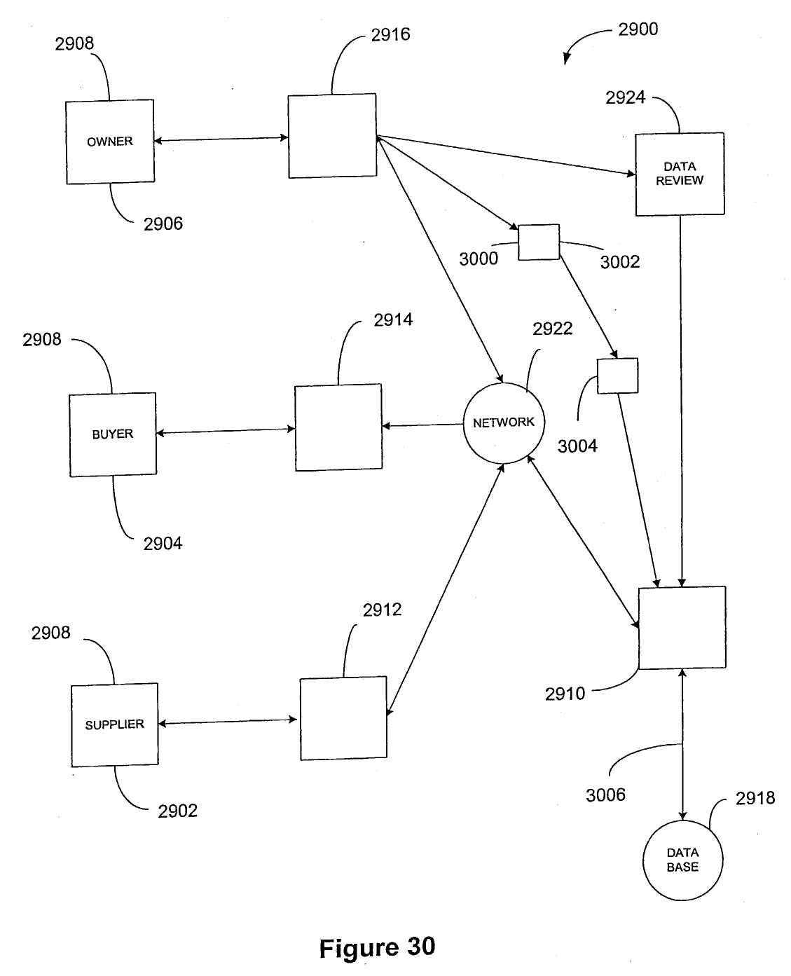

Referring now to FIG. 30, the system 2900 is shown with the addition of a real time data link 3000. The transmission line owners 2906 through its PC computer 2916 can transmit real time transportation information and information concerning the current loading of its facilities (referred to as the “real time information 3002”) through the real time data link 3000 to a temporary memory 3004. The real time information 3002 is combined in the processor 2910 with the transportation information 2920, which includes information during peak conditions, for storing such combined information 3006 in the data base 2918. The combined information 3006 can provide the energy system users 2908 with the ability to make short term informed decisions about the use of the energy transportation network.

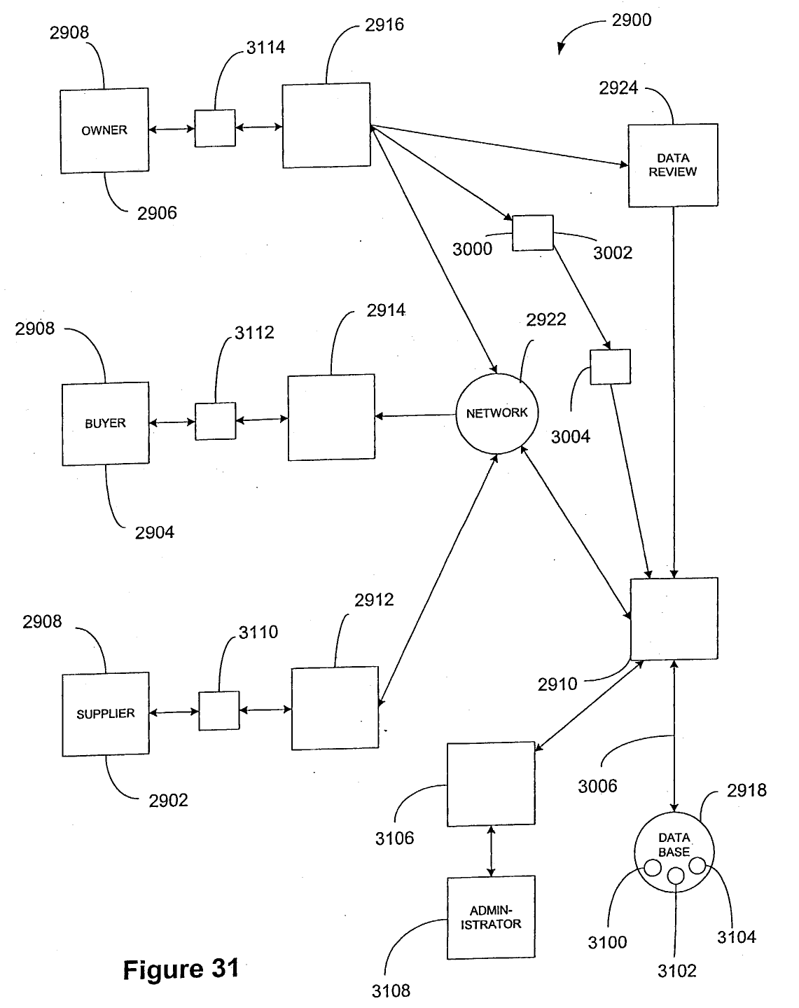

Referring now to FIG. 31, the system 2900 is shown with the data base 2918 having at least three data files 3100, 3102 and 3104. Further, an Administrator 3108, which acts as an agent for the energy system users 2908 is connected to the processor 2910 through a terminal 3106. The Administrator 3108 is able to access any information stored in the data base 2918 by communicating with the processor 2910 through the use of the terminal 3106. The Administrator 3108 can also communicate with the energy system users 2908 through the network 2922 through processor 2910.

The energy system users 2908 can also view any information stored in the data base 2918 through their respective terminals 3110, 3112 and 3114 that are connected to the PC computers 2912, 2914 and 2916, respectively. As shown in FIGS. 29-31, the Energy Information sent by the energy system users 2908 would be received by the processor 2910. The processor 2910 is adapted for receiving and transmitting the data and the information through the network 2922. The processor 2910 can be of the type which may be installed or integrated within a host computer (not shown), such that the computer can operate and perform the functions of the processor 2910. With the processor 2910 being adapted to communicate with the Administrator 3108, it should, therefore, be understood that the system 2900 provides for more efficient communication means between the energy system users 2908. The Administrator 3108 acting as an agent for the energy system users 2908, serves as the clearinghouse for electrical transmission transactions and helps to coordinate the use of the system 2900.

As shown in FIG. 31, the processor 2910 through the use of the temporary memory 3004 is adapted to temporarily store information and communication from the energy system users 2908. One example of such communications from the energy system users 2908 is when the buyer 2904, the provider 2902 and the transmission line owner 2906 agree on an amount of available electrical power, a purchase and a transportation cost, and on the use of the available transportation facilities. This agreement between the parties is then sent to the processor 2910 for incorporation in the appropriate data file 3100, 3102 or 3104 depending on the terms of the agreement between the parties.

The data file 3100 stores information concerning guaranteed or firm transmissions between the respective parties. The data base 3102 stores information concerning standard non-guaranteed or non-firm transmissions that are subject to the guaranteed or firm transmission commitments stored in data file 3100. Therefore, if the buyer 2904, the provider 2902 and the transmission line owner 2906 agree on a transmission of energy that is guaranteed to occur, such transmission of energy would normally be priced at a predetermined or calculated price and would have priority over all non-guaranteed or non-firm proposed transmissions. However, if the parties agree on a transmission of energy that is to occur but will be subject to load conditions, then such transmission of energy would normally be priced at a floating price or at a price that will fluctuate depending on the loading of the energy transportation network. This transmission, being called a standard non-firm transmission, would be subject to energy transportation network availability after all guaranteed or firm transmission commitments have been loaded or scheduled.

The data file 3104 stores information concerning a priority non-firm transmission of energy that is subject to the guaranteed transmission and the load conditions at the time of use. These priority non-firm transmissions have priority over the standard non-firm transmissions and can force the transmission line owner 2906 to curtail the standard non-firm transmission use if the load conditions require such curtailment to occur. Therefore, if an agreement for a transmission of energy is reached between the energy system users 2908, information is stored about the proposed transmission is stored in the appropriate data file in the data base 2918 depending on the terms of the agreement.

The energy system users 2908 can communicate with the Administrator 3108 through the use of the terminals 3110, 3112 and 3114, respectively, that are connected to the PC computers 2912, 2914 and 2916, respectively. The terminals 3110, 3112 and 3114 are also adapted to allow the energy system users 2908 to communicate with each other and with the Administrator 3108 via the network 2922 through the use of a network interface, such as an Internet interface, that is connected to the PC computers 2912, 2914 and 2916, and the processor 2910. The terminals 3110, 3112 and 2916 can be of the type which may be installed or integrated within the PC computers 2912, 2914 and 3114, respectively. The terminal 3106 can also be of the type that may be installed or integrated with the host computer (not shown).

2. The Transmission of Electrical Power

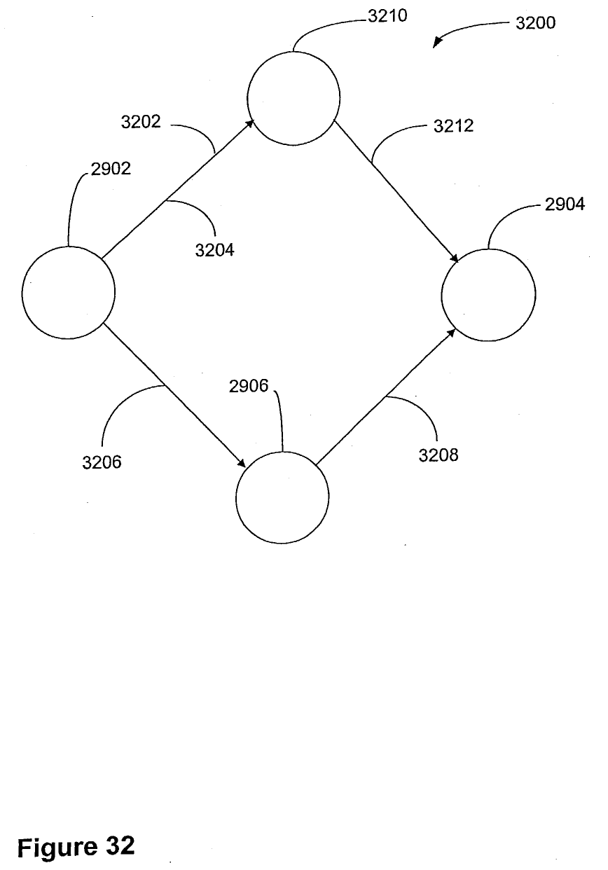

As shown in FIG. 32, the provider 2902 and buyer 2904 are connected to each other through the transmission lines 3202, which are used to transfer electrical power from the provider 2902 to the buyer 2904. The transmission lines 3202 are part of the three interconnections or grids that connect electrical utilities throughout the United States and Canada. Within the grids there are some 145 control areas that consist of systems of transmission lines 3202 that connect generating units to electrical loads or users of the generated electricity. An example of one such control area is shown in FIG. 32 and is identified by reference numeral 3200. In our example, the provider 2902 is the generating unit which wants to transmit electrical power to the buyer 2904 (the user). Due to transmission electrical network characteristics, the transmission of the electrical power may include several routes that when added together, provide the buyer 2904 with the necessary transmission capacity in the energy transportation network to move the requested amount of electrical power.

In this example, the buyer 2904 requests a 100 megawatt (“MW”) transfer between the provider 2902 and the buyer 2904. The provider 2902 transmits 100 MW to the buyer 2904, but the actual transmission occurs over several different transmission routes. The provider 2902 transmits 70 MW along first transmission line 3204 and 30 MW along second transmission line 3206. The transmission line owner 2906 of the third transmission line 3208 then transfers the incoming 30 MW to the buyer 2904. A second transmission line owner 3210 which has the fourth set of transmission lines 3212 then transfers the incoming 70 MW to the buyer 2904. The processor 2910 is adapted to identify the energy provider 2902, the transmission line owners 2906 and 3210, the first, second, third and fourth sets of transmission lines 3204, 3206, 3208 and 3212, respectively, that assisted in transmitting the electrical power from the provider 2902 to the buyer 2904 and passes this Energy Information and any loss of energy transmission which the transmission line owners 2906 and 3210 had to generate to cover for such loss to the Administrator 3108.

More specifically, the processor 2910 upon receipt of the Energy Information identifies the provider 2902, the transmission line owners 2906 and 3210, the first, second, third, and fourth sets of transmission lines 3204, 3206, 3208 and 3212, respectively, that would assist in transmitting the requested electrical power to the buyer 2904. The processor 2910 sends the Energy Information to the data base 2918 for updating the data base 2918 in order to have accurate information concerning the total available transmission capacity for any specific set of points along a transmission path. Further, the processor 2910 transmits the Energy Information to the terminal 3106 for displaying the Energy Information and the identification of the provider 2902, the transmission line owners 2906 and 3210, the first, second, third and fourth sets of transmission lines 3204, 3206, 3208 and 3212, respectively, to the Administrator 3108.

The Administrator 3108 then may send an invoice for the transmitted 3300 MW and for any energy generated to cover for any losses to the buyer 2904 for payment thereof. The Administrator 3108 can request that the buyer 2904 send the appropriate portion of the total payment directly to the provider 2902, and the transmission line owners 2906 and 3210, that assisted in the transmission of the 3300 MW transfer. Or, alternatively, the Administrator 3108 also can receive payment for the 3300 MW directly from the buyer 2904 and then send the appropriate payment to the provider 2902, and to the transmission line owners 2906 and 3210. Thus, the system 2900 is adapted to allow the Administrator 3108 to send an invoice that allows the provider 2902 and the transmission line owners 2906 and 3210, to be compensated for the transmission of the electrical power. The system 2900 is also adapted to indicate when improvements or increases in the number of transmission lines are needed, because the system 2900 identifies when certain facilities are at capacity.

3. Process Description for the Functions Carried Out by the System

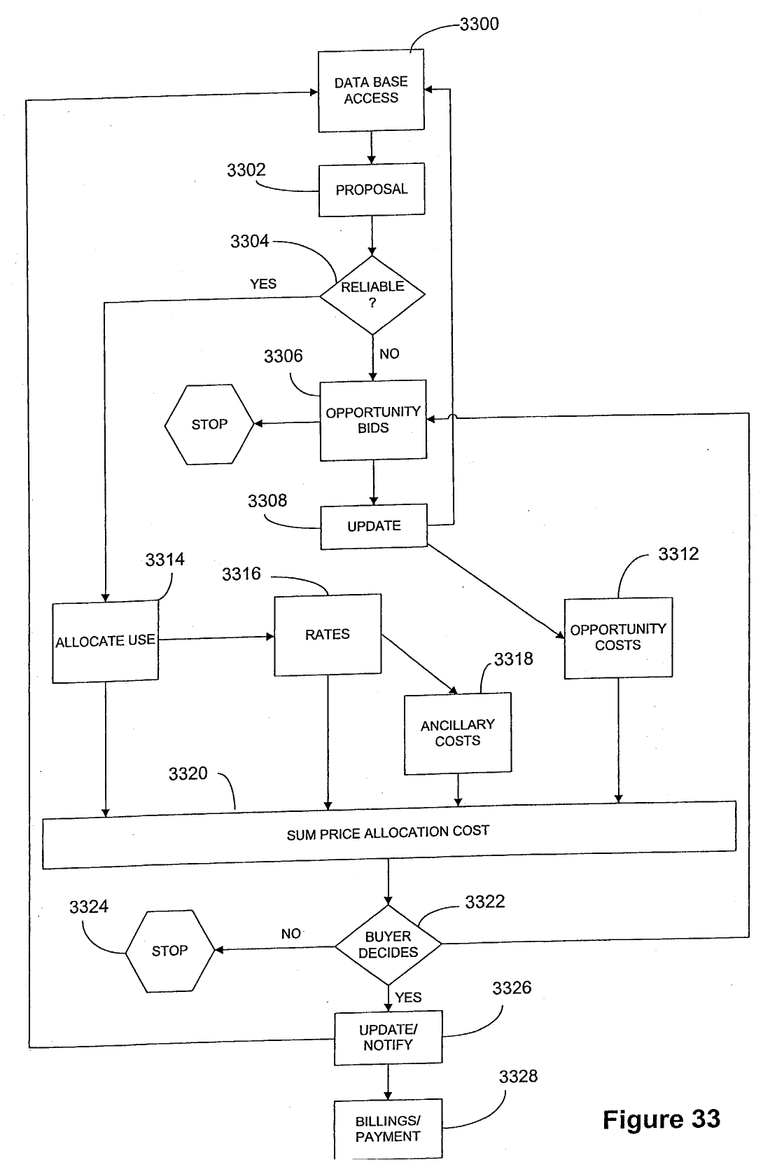

Referring now to FIG. 33, a flow chart illustrating the functions carried out by the system 2900 in coordinating communications and data transmission between the energy system users 2908 and the Administrator 3108. The flow chart depicts the operation functions carried out primarily by the processor 2910 and the PC computers 2912, 2914 and 2916, it being relied that the processor 2910 and the PC computers 2912, 2914 and 2916 are conventionally programmed to carry out their respective, traditional functions. As a result, and in accordance with an important feature of the invention, modification of the processor 2910 and the PC computers 2912, 2914 and 2916 is generally not required, and thus conventional computer equipment can be utilized.

With reference to FIG. 33, the programmed operations of the processor 2910 and the PC computers 2912, 2914 and 2916 start by the detection of a request for data base access from any energy system user 2908 by the processor 2910 or the PC computers 2912, 2914 and 2916, as shown by flow block 3300. The requesting energy system user communicates with its respective PC computer to send to the requesting energy system user via the network 2922 current information from the appropriate data file 3100, 3102 or 3104, depending on the type of energy transmission being requested. The current information would include any energy information and transportation information for the proposed transaction. The requested information is transmitted to and received by the requesting energy system user's computer 2912, 2914 or 2916. The program control then branches to flow block 3302 where the energy system user 2908 proposes a transaction based on the information received from the appropriate data file 3100, 3102 or 3104.

The program control then branches to flow block 3304 where the availability of the current electrical system is checked to ensure that when the proposed transaction is added to the energy transportation network any transmission lines 3202, 3204, 3206, 3208 and 3212 are not loaded above their safe limit. The reliability of a system loaded to its theoretical capacity will be threatened by unplanned, but normal, changes in operations. Also, there must be protection against the loss of a transmission line, which if occurs, the power flows within the affected segment will be redistributed over the surviving system. Therefore, protections in reliability must be considered when proposing a transaction for the transmission of energy.

If there is reliable suppliable electrical power and a user who agrees to have the power transmitted at the reliable service level, then the program control branches to flow block 3314 which identifies the facilities of transmission line owners 2906 that will be used in the transmission of energy for the proposed transaction. The program control then branches to flow block 3316 and allocates the appropriate provider approved rates for the proposed amount of electrical power to be transferred. Additionally, any appropriate ancillary charges are included as noted by flow block 3318.

The program then branches to flow block 3320 which provides a sum price allocation cost per provider (the “total transmission service price”) to the proposed buyer. The program branches to flow block 3322 where the proposed buyer evaluates the proposed cost. If the proposed buyer declines the proposed cost, then the program branches to flow block 3324, which stops the transaction for the transmission of electrical power.

If the proposed buyer agrees to the proposed cost, then the program branches to flow block 3326, which updates the appropriate data file 3100, 3102 or 3104 to indicate the contracted change to the energy transportation network. The updating of the data base 2918 thereby provides for a current updated status of the grids. The program control then branches back to flow block 3300 where the data base 2918 is again available for access by the next user. Simultaneously, the program control branches to flow block 3328 where the Administrator 3108 requests payment from the user and energy purchaser and transfers such payment to the affected energy supplier and transmission line owners.

If at flow block 3304, the determination is made that there is no reliable transmission capacity available for the proposed transfer of electrical power, then the program control transfers to flow block 3306, where bids can be requested on behalf of the proposed user from other transmission users. The bids would be based on savings foregone or additional costs (“opportunity cost”) necessary to make the needed transmission available. The effect of the proposed bid is first evaluated by the system at flow block 3208 by introducing the proposed bid into the existing test data base and a new evaluation is started through flow blocks 3300, 3302 and 3304. If the proposal is effective (at flow block 3304) the bid price is entered at flow block 3312 where the bid is incorporated with the system allocation (3314) rates (3316) and ancillary costs (3318) and presented to the proposed user as the Sum Price Allocation Cost (3320). Additional bids from other users would be evaluated in a similar manner.

If the proposed user decides to proceed, he notifies the Administrator at flow block 3326 and 3328. The accepted proposed transaction is sent via the network 2922 to the processor 2910 where the newly accepted transaction is entered in the data base 2918. If the proposed buyer does not accept the proposed transaction because of the transmission service price, the program control branches to flow block 3324 which stops the evaluation process, or, branches to flow block 3306 to seek additional bids. The evaluation continues as discussed above until either a transaction is accepted or all bids are declined.

4. Other Applications

The system 2900 is adapted to be able to accommodate other types of energy suppliers and users, such as a natural gas utility. The lines of transmission 3202, instead of being electrical transmission lines, would be the natural gas lines that deliver natural gas from the generating or supplying utility to the various users. Further, the system 2900 is adapted to accommodate requests for energy directly from the ultimate energy user and not just from another utility. For example, a manufacturing plant could send its request for a supply of energy to the Administrator 3108 and the system 2900 would operate to provide the manufacturing plant (the energy buyer) with its requested amount of energy. Thus, the system 2900 applies to all energy system users 2908.

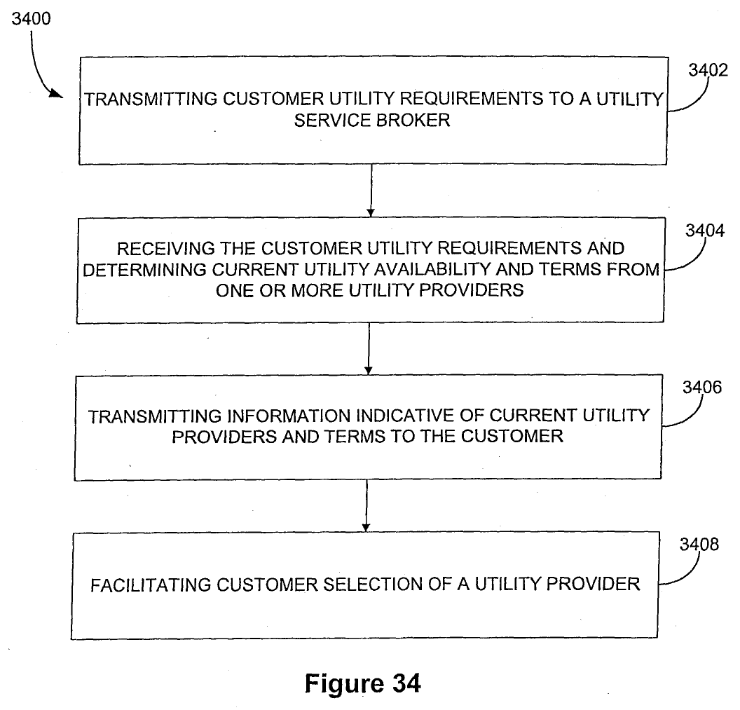

FIG. 34 illustrates a process 3400 for providing a utility auctioning system utilizing an internet protocol network. In operation 3402, customer utility requirements are transmitted to a utility service broker. In operation 3404, the customer utility requirements are received and a current utility availability and terms from one or more utility providers are determined. Information indicative of current utility providers and terms are transmitted to the customer in operation 3406. Also, customer selection of a utility provider is facilitated in operation 3408.

In one aspect of the present invention, the utility service broker maintains a database of utility providers and terms. The utility service broker maintains a database of utility provider characteristics. The service broker may maintain a database of aggregated customer requirements.

As an option, the service broker polls utility service providers to maintain updated utility provider service information. Also optionally, the service broker collects customer billing information.

In an embodiment of the present invention designed for conducting auctions of a utility, a computerized system allows flexible bidding by participants in a dynamic auction, combining some of the advantageous facets of the sealed-bid format with the basic advantages of an ascending-bid format. At any point in the auction, bidders are provided the opportunity to submit not only their current bids, but also to enter future bids (to be more precise, bidding rules which may have the opportunity to become relevant at future times or prices), into the auction system's database. Moreover, participants are continually provided the opportunity to revise their bids associated with all future times or prices which have not already been reached, by entering new bids which have the effect of superseding this bidder's bids currently residing in the auction system's database. Thus, at one extreme, a bidder who wishes to economize on his time may choose to enter his entire set of bidding rules into the computerized system at the start of the auction, effectively treating this as a sealed-bid auction. At the opposite extreme, a bidder who wishes to closely participate in the auction may choose to constantly monitor the auction's progress and to submit all of his bids in real time. Most bidders are likely to select an approach somewhere between these extremes: a bidder may enter a preliminary set of bidding rules at the start of the auction, but then periodically choose to revise his bidding rules as information is generated through the auction process. He can avoid the necessity of spending every minute of his time monitoring the auction, but still avail himself of the opportunity to respond to his competitors' bids. By the same token, the auctioneer can run the auction at a faster pace and using smaller bid increments with the present invention than with a system only permitting contemporaneous bids; no bidder need risk missing a submission deadline and completely losing out on placing desired bids (or being disqualified from the auction), as his bidding rules residing in the auction system database fill in until the bidder chooses to revise them.

In order to obtain the advantages of the invention, each of the bidders uses a dedicated user system and the auction itself is monitored and controlled via an auctioneer's system. The auctioneer's system can communicate messages to each of the user systems. The messages are used to initiate an auction and the message initiating an auction may carry with it information describing the particular auction being initiated. The users may thereafter enter flexible bid information which can include a scalar-value, vector-value or a function. The flexible bid information may be an expression of how many units of object(s) a bidder is willing to purchase at a given price(s), how much money a bidder is willing to pay for the purchase of a given object(s), or any other expression of the willingness-to-pay or value which a bidder places on object(s). Optionally, a bidding rule may also include a limitation (e.g. “I desire up to a quantity of x at a price P, but I do not want any positive quantity at all unless I receive a minimum quantity of y”). Thus, a bidding rule may lo include an unconditional bid or a contingent bid, and may consist of a function from available information to bid quantities (e.g. a function of the previous bid(s) submitted).

The flexible bid information, once input via a user system, is stored in one or more databases, each of which is accessible to the auctioneer's system.

The auction itself includes a number of queries and answers, queries from the auctioneer's system to the database, and answers to the queries from the database. The auctioneer's system is capable of making a decision based on the answers from the database for determining whether an auction should continue. If a decision is reached indicating that the auction should continue, at least one message is generated and communicated to a user system carrying that information. If a decision is reached to terminate or not to continue the auction, then a final message is generated to at least one user system. The final message may include the results of the auction.

Thus in accordance with the invention, a dynamic flexible computer-implemented auction system includes at least two intelligent systems including an auctioneer's and at least one user system. The auctioneer's system is communicatively coupled to each user system. Each user system provides an interface with a mechanism for receiving messages from the auctioneer's system and for displaying those messages.

A mechanism is also provided for receiving flexible bid information from a user and for transmitting the flexible bid information to a user database.

The auctioneer's system generates and transmits messages to each user system, and generates queries for each user database and for receiving answers to the queries from each user database. A decision engine is responsive to the answers from the user database for determining if an auction should continue or not. The decision engine initiates the generation of another message to at least one user system in response to a determination to continue the auction. The decision engine also initiates the generation of a final message to at least one user system in response to a determination not to continue the action.

The auction system may also include a user database for each user system. The user database should receive and store the flexible bid information for a user system. The database would also receive queries from the auctioneer's system and for generating and passing answers which have information based on said flexible bid information to the auctioneer's system in response to queries from the auctioneer's system.

In respect of another aspect, the invention includes a dynamic flexible computer-implemented auction process implemented in an auction system which has at least two intelligent systems including an auctioneer's and at least one user system. The auctioneer's system is communicatively coupled to all the user systems. Each user system provides an interface for receiving messages from the auctioneer's system and for displaying those messages, for receiving flexible bid information and transmitting the flexible bid information to a user database. The auctioneer's system generates and transmits messages to each user system, generates queries for each user database and receives answers to the queries from each user database.

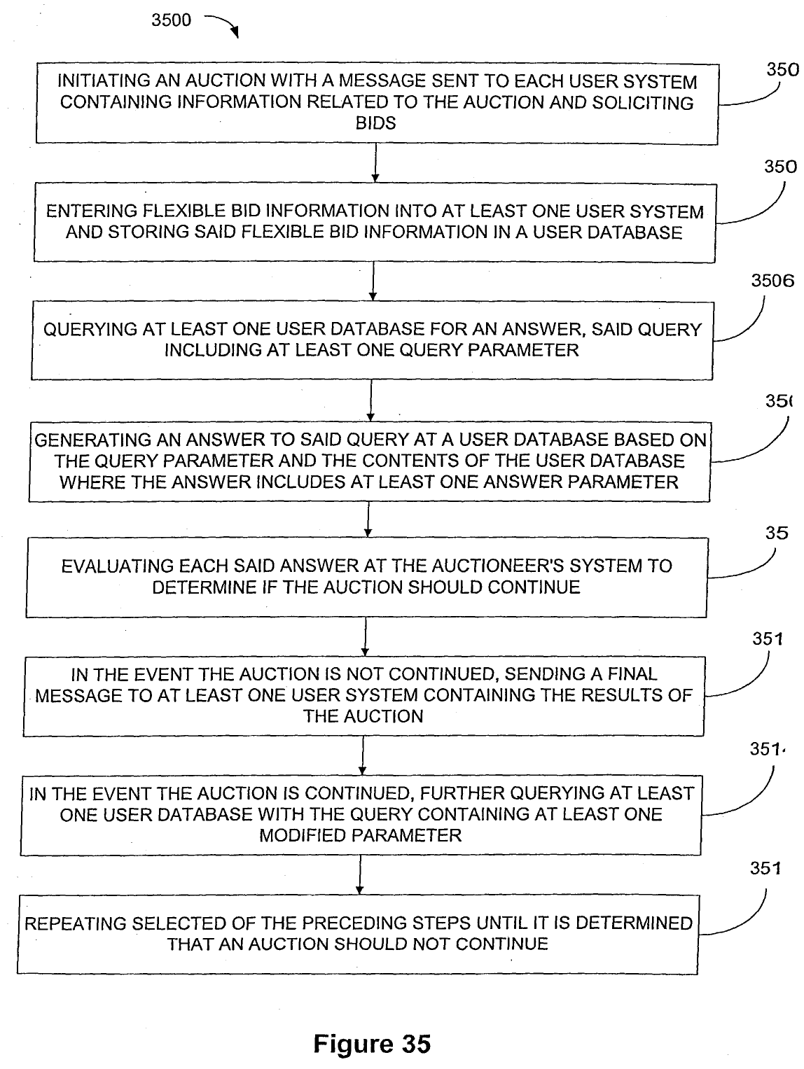

FIG. 35 is a flowchart that illustrates a process 3500 for the dynamic flexible computer-implemented auction process. In operation 3502, an auction is initiated with a message sent to each user system containing information related to the auction and soliciting bids. In operation 3504, flexible bid information is entered into at least one user system and storing said flexible bid information in a user database. At least one user database is queried for an answer in operation 3506. The query includes at least one query parameter. In operation 3508, an answer to the query is generated at a user database based on the query parameter and the contents of the user database where the answer includes at least one answer parameter. Each answer at the auctioneer's system is evaluated in operation 3510 to determine if the auction should continue. In the event the auction is not continued, in operation 3512, a final message is sent to at least one user system containing the results of the auction. In the event the auction is continued, at least one user database further queries in operation 3514 with the query containing at least one modified parameter. Some or all of these steps are repeated until it is determined that an auction should not continue.

In another aspect, the invention relates to an implementation of an efficient auction for multiple dissimilar objects and to an implementation of a generalized English auction for multiple dissimilar objects, such as two different types of utilities or a utility and alternate energy. These types of auctions are more difficult to implement in that, because the objects are dissimilar and hence must be treated individually, significantly more information is required to be input and processed than in an auction for similar objects.

One of the most compelling advantages of the English auction for a single object over the sealed-bid, second-price auction for a single object is that it protects the bidder possessing the highest value from needing to ever reveal her value to the seller and to other bidders (Rothkopf, Teisberg, and Kahn, 1990; Engelbrecht-Wiggans and Kahn, 1991; Rothkopf and Harstad, 1995). Suppose that a broadcast license were to be sold by second-price, sealed-bid auction. Say that Bidder A, who valued the license the most, placed a value of $200 million on the license, while Bidder B, the second-highest-valuation buyer, placed a value of only $50 million on the license. Assuming independent private values, observe that the dominant-strategy equilibrium in the sealed-bid, second-price auction requires each bidder to submit a sealed bid equaling her true value. However, bidders may fear the following scenario. The seller, knowing after the bidding that Bidder A actually values the license at $200 million, may attempt to renege on the sale, and renegotiate the price above the $50 million established by the auction. Alternatively, the seller, after receiving the $200 million sealed bid, may surreptitiously plant a bogus $199 million bid (or enlist a “shill” to insert a bid in his own name). If the seller is the Government, the seller may fear the public-relations disaster when it becomes generally known that it is selling a public asset which Bidder A values at $200 million for a price which is a mere quarter of that value. Finally, there are business reasons why Bidder A may wish to conceal the fact that her value is so high, for example if she is contemplating buying additional broadcast licenses, either from the Government, through subsequent auctions, or from private parties, through negotiations.

By contrast, an English auction avoids this problem. With the valuations described above, Bidder A is only required to reveal in the auction process that she values the license at greater than $50 million. The fact that her true threshold equals $200 million never needs to be elicited. Hence, the seller cannot make opportunistic use of Bidder A's true value to drive up the price, the seller is spared the public embarrassment of failing to capture the difference between the first- and second-highest values, and the highest buyer maintains the secrecy of her value for use in future transactions. Regrettably, the exact value of Bidder B—unlike that of Bidder A—is revealed to the seller in the course of the auction, but ascertaining the second-highest-bidder's valuation seems to be an inevitable part of placing the license in the hands who value it the most.

This aspect of the invention describes implementations of new ascending-bid auctions for selling multiple, dissimilar objects, which have the analogous advantage of conserving on the revelation of high-bidders' values. It begins with the Vickrey auction for multiple, dissimilar objects (often also known as the Groves mechanism or Groves-Clark mechanism), but transforms it into a progressive procedure which stops eliciting information the moment that no further information is needed to determine the efficient allocation.

In an example of a possible auctioning application for the present invention, suppose that a region's electric power pool sought to arrange for the production of electric power at various times of day via a dynamic auction. The power pool might announce that it will begin by posting a price of 10 cents per kilowatt-hour on each half-hour period of the day and indicate the quantity of power it desires at that price. It might then proceed by reducing the price by ½ cent per kilowatt-hour on one or more time periods which are heavily oversubscribed, also indicating the quantity of power desired at the new price. Bidders in this auction (electric power companies, users, distributors or other monitoring agents) might typically place bids with limitations of the form: “I am willing to supply x kilowatts of power during both the 9:00-to-9:30 am time slot and the 10:00-to-10:30 am time slot, but only if I can also supply the same amount during the 9:30-to-10:00 am time slot. Moreover, I am willing to supply a positive quantity of power only if I am able to supply a minimum of y kilowatts of power >the capacity of one of my power plants!”

The dynamic auction process could potentially require a very large number of iterations, and so would probably only be feasible if the turnaround time for each round was quite short. However, by utilizing the present invention, the auction system could incorporate the submission of bidding rules treating subsequent proposed pricing configurations, and so the turnaround time would not necessarily be restricted by the bidders' ability to prepare and submit new bids following each adjustment in the pricing configuration.

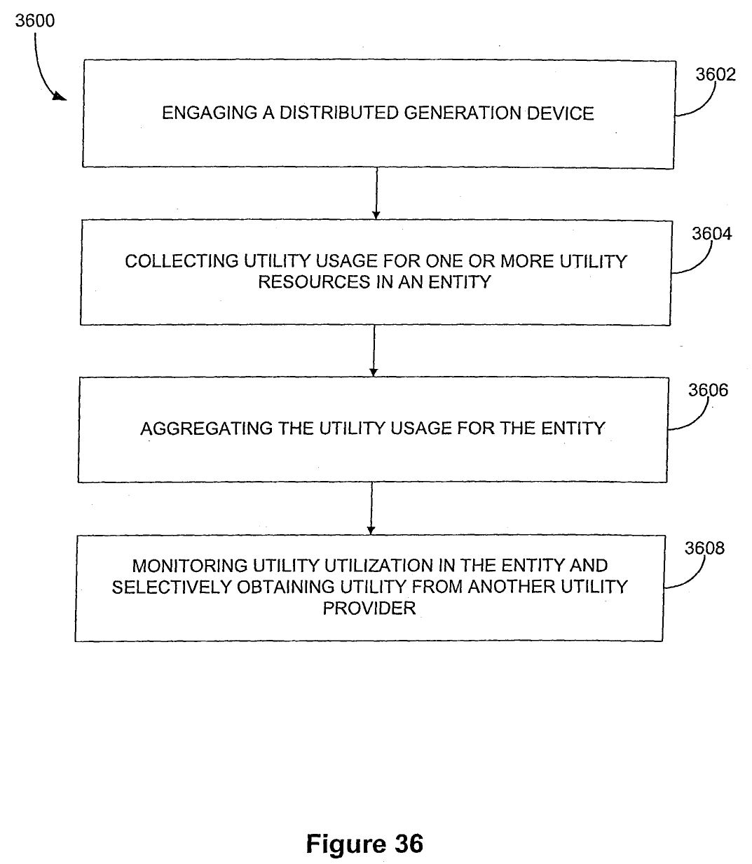

FIG. 36 is a flowchart depicting a process 3600 for monitoring and optimizing utility usage in an entity. A distributed generation device is engaged in operation 3602 and utility usage for one or more utility resources in an entity is collected in operation 3604. The utility usage for the entity is then aggregated in operation 3606.

The generation capacity of the distributed generation device would be matched against the consumption patterns/aggregate utility usage. In operation 3608 utility utilization in the entity is monitored and utility from another utility provider is selectively obtained.

In an embodiment of the present invention, an internet protocol network may be queried to select an optimal utility provider for the entity. In such an embodiment, information from the entity may also be provided to a utility service provider. Additionally, control of devices may also be provided from the internet protocol network.

In another embodiment of the present invention, devices may be prioritized. In a further embodiment of the present invention, interfacing to an entity security system may also occur.

In an embodiment of the present invention for managing distributed energy generation, communication is conducted with a plurality of consumers utilizing a wide area network for determining estimated energy requirements of each of the customers. An estimate of total energy requirements for all of the customers is determined based on the communication with the customers. An energy output is then ascertained for an energy generator supplying energy to the customers, and a calculation is performed to calculating an amount of energy required in addition to the energy output of the energy generator to meet the estimate of total energy requirements. Energy purchases are then made equal to the amount of energy required in addition to the energy output of an energy generator.

In an aspect of the present invention, the amount of energy required in addition to the energy output of an energy generator may be purchased on an energy market. Optionally, the energy market may be provided by receiving pricing information for energy from each of a plurality of energy providers and then transmitting the pricing information to a potential energy purchaser utilizing a wide area network. Upon receiving usage information from the customer which identifies the energy provider that provided the energy and a time and quantity of use of the energy, a cost of the energy used may then be calculated based on the usage information and the pricing information. A request for payment may then be transmitted utilizing the wide area network to the customer for the calculated cost of the energy.

In another aspect of the present invention, the communication with the plurality of customers may include transmitting and receiving data from at least one of a home network and an energy monitoring device. In an embodiment of the present invention, a cost of the source of energy used may also be calculated so that a payment may be electronically transmitted utilizing the wide area network to the provider of the source of energy. In at least one embodiment of the present invention, energy involved may be electricity.

Although only a few embodiments of the present invention have been described in detail herein, it should be understood that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope of the appended claims.

What is claimed is:

1. A method for monitoring and optimizing utility usage in an entity, comprising the steps of:
collecting utility usage for one or more utility resources in an entity;
aggregating the utility usage for the entity; and
monitoring utility utilization in the entity and selectively limiting utility usage of the one or more devices to optimize utility usage.

2. A method as recited in claim 1, and further comprising the step of querying an internet protocol network to select an optimal utility provider for the entity.

3. A method as recited in claim 2, and further comprising the step of providing information from the entity to a utility service provider.

4. A method as recited in claim 2, and further comprising the step of providing control of devices from the internet protocol network.

5. A method as recited in claim 1, and further comprising the step of prioritizing devices.

6. A method as recited in claim 1, and further comprising the step of interfacing to an entity security system.

7. A computer program embodied on a computer readable medium for monitoring and optimizing utility usage in an entity, comprising:
a code segment that collects utility usage for one or more utility resources in an entity;
a code segment that aggregates the utility usage for the entity; and
a code segment that monitors utility utilization in the entity and selectively limits utility usage of the one or more devices to optimize utility usage.

8. A computer program as recited in claim 7, and further comprising a code segment that queries an internet protocol network to select an optimal utility provider for the entity.

9. A computer program as recited in claim 8, and further comprising a code segment that provides information from the entity to a utility service provider.

10. A computer program as recited in claim 8, and further comprising a code segment that provides control of devices from the internet protocol network.

11. A computer program as recited in claim 7, and further comprising a code segment that prioritizes devices.

12. A computer program as recited in claim 7, and further comprising a code segment that interfaces to an entity security system.

13. A system for monitoring and optimizing utility usage in an entity, comprising:
logic that collects utility usage for one or more utility resources in an entity;
logic that aggregates the utility usage for the entity; and
logic that monitors utility utilization in the entity and selectively limits utility usage of the one or more devices to optimize utility usage.

14. A system as recited in claim 13, and further comprising logic that queries an internet protocol network to select an optimal utility provider for the entity.

15. A system as recited in claim 14, and further comprising logic that provides information from the entity to a utility service provider.

16. A system as recited in claim 14, and further comprising logic that provides control of devices from the internet protocol network.

17. A system as recited in claim 13, and further comprising logic that prioritizes devices.

18. A system as recited in claim 13, and further comprising logic that interfaces to an entity security system.

19. A method for monitoring use of utility resources to optimize utility resource distribution, comprising:
communicating with a utility device to automatically read actual utility usage data from a remote location by specifying a network address for the utility device and issuing continual requests for actual utility usage data from the utility device, wherein the actual utility usage data represents a time period of utility use and an amount of utility use for a customer;
determining optimal utility usage data representing utility pricing to be offered to the customer, wherein a customer's actual utility usage data is analyzed to determine a price for a unit of utility resources, and wherein the price for a unit of utility resources depends on a customer's time period of utility use and the amount of utility use for a particular time period;
assisting the customer to dynamically select an optimal utility resource provider, wherein the optimal utility resource provider may change depending on the customer's actual utility usage data;
distributing utility resources to the customer based upon the optimal utility usage data, wherein utility resources provided to the customer may be selectively limited based upon the optimal utility usage data; and
providing additional customer services based upon the actual utility usage data and the optimal utility usage data, wherein the additional customer services include automatic initiation and termination of utility resources, quality assurance of utility resources provided to the customer, and security assessment and monitoring for utility resources provided.

20. The method of claim 19, further comprising storing the actual utility usage data and the optimal utility usage data in a database.

21. The method of claim 19, wherein the assisting the customer to dynamically select an optimal service provider includes offering the customer a choice of different utility resource providers.

22. The method of claim 21, further comprising allowing the different utility resource providers to present bids for providing utility resources, wherein the different utility resource providers may be selected based on price, type of utility resource provided, and geographic location.

23. The method of claim 19, wherein actual utility usage data is automatically read from a plurality of utility devices.

24. The method of claim 23, further comprising prioritizing utility devices based on time of utility use and amount of utility use, wherein distribution of utility resources is determined by a priority assigned to the utility device.

25. The method of claim 19, further comprising determining utility resource needs for a plurality of customers and allocating utility resources for the plurality of customers based upon the optimal utility usage data.

26. A computer program embodied on a computer readable medium for monitoring use of utility resources to optimize utility resource distribution, comprising:
a code segment that communicates with a utility device to automatically read actual utility usage data from a remote location by specifying a network address for the utility device and issues continual requests for actual utility usage data from the utility device, wherein the actual utility usage data represents a time period of utility use and an amount of utility use for a customer;
a code segment that determines optimal utility usage data representing utility pricing to be offered to the customer, wherein a customer's actual utility usage data is analyzed to determine a price for a unit of utility resources, and wherein the price for a unit of utility resources depends on a customer's time period of utility use and the amount of utility use for a particular time period;
a code segment that assists the customer to dynamically select an optimal utility resource provider, wherein the optimal utility resource provider may change depending on the customer's actual utility usage data;
a code segment that distributes utility resources to the customer based upon the optimal utility usage data, wherein utility resources provided to the customer may be selectively limited based upon the optimal utility usage data; and
a code segment that provides additional customer services based upon the actual utility usage data and the optimal utility usage data, wherein the additional customer services include automatic initiation and termination of utility resources, quality assurance of utility resources provided to the customer, and security assessment and monitoring for utility resources provided.

27. A system for monitoring use of utility resources to optimize utility resource distribution, comprising:
logic that communicates with a utility device to automatically read actual utility usage data from a remote location by specifying a network address for the utility device and issues continual requests for actual utility usage data from the utility device, wherein the actual utility usage data represents a time period of utility use and an amount of utility use for a customer;
logic that determines optimal utility usage data representing utility pricing to be offered to the customer, wherein a customer's actual utility usage data is analyzed to determine a price for a unit of utility resources, and wherein the price for a unit of utility resources depends on a customer's time period of utility use and the amount of utility use for a particular time period;
logic that assists the customer to dynamically select an optimal utility resource provider, wherein the optimal utility resource provider may change depending on the customer's actual utility usage data;
logic that distributes utility resources to the customer based upon the optimal utility usage data, wherein utility resources provided to the customer may be selectively limited based upon the optimal utility usage data; and
logic that provides additional customer services based upon the actual utility usage data and the optimal utility usage data, wherein the additional customer services include automatic initiation and termination of utility resources, quality assurance of utility resources provided to the customer, and security assessment and monitoring for utility resources provided.
